(19) United States
(12) Patent Application Publication
(10) Pub. No.: US 2019/0303159 A1
(43) Pub. Date: Oct. 3, 2019

(54) INSTRUCTION SET ARCHITECTURE TO FACILITATE ENERGY-EFFICIENT COMPUTING FOR EXASCALE ARCHITECTURES

(71) Applicant: Intel Corporation, Santa Clara, CA (US)

(72) Inventors: Joshua B. FRYMAN, Portland, OR (US); Jason M. HOWARD, Portland, OR (US); Priyanka SURESH, Hillsboro, OR (US); Banu Meenakshi NAGASUNDARAM, Hillsboro, OR (US); Srikanth DAKSHINAMOORTHY, Portland, OR (US); Ankit MORE, San Francisco, CA (US); Robert PAWLOWSKI, Portland, OR (US); Samkit JAIN, Hillsboro, OR (US); Pranav YEOLEKAR, Bangalore (IN); Avinash M. SEEGEHALLI, Bangalore (IN); Surhud KHARE, Bangalore (IN); Dinesh SOMASEKHAR, Portland, OR (US); David S. DUNNING, Portland, OR (US); Romain E. Cledat, Hillsboro, OR (US); William Paul GRIFFIN, Portland, OR (US); Bhavitavya B. BHADVIYA, Folsom, CA (US); Ivan B. GANEV, Hillsboro, OR (US)

(21) Appl. No.: 15/940,768

(22) Filed: Mar. 29, 2018

(51) Int. Cl. G06F 9/38; G06F 9/30

(52) U.S. Cl. CPC G06F 9/3836; G06F 9/30145; G06F 9/30047; G06F 9/3005; G06F 9/3802

(57) ABSTRACT

Disclosed embodiments relate to an instruction set architecture to facilitate energy-efficient computing for exascale architectures. In one embodiment, a processor includes a plurality of accelerator cores, each having a corresponding instruction set architecture (ISA); a fetch circuit to fetch one or more instructions specifying one of the accelerator cores, a decode circuit to decode the one or more fetched instructions, and an issue circuit to translate the one or more decoded instructions into the ISA corresponding to the specified accelerator core, collate the one or more translated instructions into an instruction packet, and issue the instruction packet to the specified accelerator core; and, wherein the plurality of accelerator cores comprise a memory engine (MENG), a collective engine (CENG), a queue engine (QENG), and a chain management unit (CMU).

### STATEMENT OF GOVERNMENT INTEREST

This invention was made with Government support under contract numbers B608115 and B600747, awarded by the Department of Energy. The Government has certain rights in this invention.

### FIELD OF INVENTION

The field of invention relates generally to computer processor architecture, and, more specifically, to an instruction set architecture to facilitate energy-efficient computing for exascale architectures.

### BACKGROUND

Exascale computing refers to computing systems capable of at least one exaFLOPS, or a billion, billion calculations per second. Exascale systems pose a complex set of challenges: data movement energy may exceed that of computing, and enabling applications to fully exploit capabilities of exascale computing systems using a conventional instruction set architecture (ISA) is not straightforward.

### BRIEF DESCRIPTION OF THE DRAWINGS

The present invention is illustrated by way of example and not limitation in the figures of the accompanying drawings, in which like references indicate similar elements and in which:

FIG. 1 illustrates one example of an accelerator architecture for implementing an instruction set architecture to facilitate energy-efficient computing for exascale architectures;

FIG. 2 is a block diagram illustrating strategic integration of multiple accelerator engines into a computing system, according to some embodiments;

FIG. 3 is a block diagram illustrating integration of a collectives engine (CENG) into a core pipeline, according to some embodiments;

FIG. 4 illustrates behaviors of a few of the collective operations supported by the disclosed instruction set architecture, according to some embodiments;

FIG. 5 illustrates a state flow diagram for a reduction state machine, according to some embodiments;

FIG. 6 illustrates a state flow diagram for a multicast state machine, according to some embodiments;

FIG. 7 illustrates a state machine implemented by a memory engine (MENG) on a per thread basis, according to some embodiments;

FIG. 8 illustrates behavior of an exemplary copystride direct memory access (DMA) instruction, according to an embodiment;

FIG. 9 is a diagram illustrating the relation from stores to the target custom instruction format and collation by a translator-collator memory-mapped input/output (TMMIO) block before issue to the accelerators, according to an embodiment;

FIG. 10 is a block flow diagram illustrating execution of a memory access instruction by a translator-collator memory-mapped input/output (TCMMIO) block, according to some embodiments;

FIG. 11 is a block diagram illustrating implementation of a queue engine (QENG), according to some embodiments;

FIG. 12A is a state flow diagram illustrating the disclosed cache coherency protocol according to some embodiments;

FIG. 12B is a block diagram illustrating a cache control circuit, according to an embodiment;

FIG. 13 is a flow diagram illustrating a process performed by cache control circuitry according to some embodiments;

FIG. 14 is a diagram of a portion of a switched bus fabric for use with the disclosed instruction set architecture, according to an embodiment;

FIG. 15 is a block diagram showing a hijack unit, according to some embodiments;

FIG. 16 is a block diagram illustrating a hijack unit, according to some embodiments;

FIG. 17 is a block diagram illustrating a single execution block of a hijack unit, according to some embodiments;

FIGS. 18A-18B are block diagrams illustrating a generic vector friendly instruction format and instruction templates thereof according to embodiments of the invention;

FIG. 18A is a block diagram illustrating a generic vector friendly instruction format and class A instruction templates thereof according to embodiments of the invention;

FIG. 18B is a block diagram illustrating the generic vector friendly instruction format and class B instruction templates thereof according to embodiments of the invention;

FIG. 19A is a block diagram illustrating an exemplary specific vector friendly instruction format according to embodiments of the invention;

FIG. 19B is a block diagram illustrating the fields of the specific vector friendly instruction format that make up the full opcode field according to one embodiment of the invention;

FIG. 19C is a block diagram illustrating the fields of the specific vector friendly instruction format that make up the register index field according to one embodiment of the invention;

FIG. 19D is a block diagram illustrating the fields of the specific vector friendly instruction format that makes up an augmentation operation field according to one embodiment of the invention;

FIG. 20 is a block diagram of a register architecture according to one embodiment of the invention;

FIG. 21A is a block diagram illustrating both an exemplary in-order pipeline and an exemplary register renaming, out-of-order issue/execution pipeline according to embodiments of the invention;

FIG. 21B is a block diagram illustrating both an exemplary embodiment of an in-order architecture core and an exemplary register renaming, out-of-order issue/execution architecture core to be included in a processor according to embodiments of the invention;

FIGS. 22A-B illustrate a block diagram of a more specific exemplary in-order core architecture, which core would be one of several logic blocks (including other cores of the same type and/or different types) in a chip;

FIG. 22A is a block diagram of a single processor core, along with its connection to the on-die interconnect network and with its local subset of the Level 2 (L2) cache, according to embodiments of the invention;

FIG. 22B is an expanded view of part of the processor core in FIG. 22A according to embodiments of the invention;

FIG. 23 is a block diagram of a processor that may have more than one core, may have an integrated memory controller, and may have integrated graphics according to embodiments of the invention;

FIGS. 24-27 are block diagrams of exemplary computer architectures;

FIG. 24 shown a block diagram of a system in accordance with one embodiment of the present invention;

FIG. 25 is a block diagram of a first more specific exemplary system in accordance with an embodiment of the present invention;

FIG. 26 is a block diagram of a second more specific exemplary system in accordance with an embodiment of the present invention;

FIG. 27 is a block diagram of a System-on-a-Chip (SoC) in accordance with an embodiment of the present invention; and

FIG. 28 is a block diagram contrasting the use of a software instruction converter to convert binary instructions in a source instruction set to binary instructions in a target instruction set according to embodiments of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

References in the specification to “one embodiment,” “an embodiment,” “an example embodiment,” etc., indicate that the embodiment described may include a feature, structure, or characteristic, but every embodiment may not necessarily include the feature, structure, or characteristic. Moreover, such phrases are not necessarily referring to the same embodiment. Further, when a feature, structure, or characteristic is described about an embodiment, it is submitted that it is within the knowledge of one skilled in the art to affect such feature, structure, or characteristic about other embodiments if explicitly described.

An improved instruction set architecture (ISA) as disclosed herein is expected to allow new programming models with reduced code size and overall system energy efficiency. The disclosed ISA addresses some of the unique challenges of exascale architectures. Exascale systems pose a complex set of challenges: (1) data movement energy cost will exceed that of computing; (2) existing architectures do not have instruction semantics to specify energy efficient data movement; and (3) maintaining coherency will be a challenge.

The ISA disclosed herein attempts to resolve these issues with specific instructions for efficient data movement, software (SW) managed coherency, hardware (HW) assisted queue management, and collective operations. The disclosed ISA includes several types of collective operations, including, but not limited to reductions, all-reductions (reduce-2-all), multicasts, broadcasts, barriers, and parallel prefix operations. The disclosed ISA includes several classes of instructions that are expected to support programming models with reduced overall system energy consumption. These several types of computing operations are described below, including in sections having the following headings:
Collectives System Architecture;
Simplified Asynchronous Collective Engine (CENG) with Low Overhead;
An ISA Facilitated Micro-DMA Engine and Memory Engine (MENG);
Dual-memory ISA Operations;
Memory Mapped Input/Output (I/O) Based ISA Extension and Translation;
Simplified Hardware-Assisted Queue Engine (QENG);
Instruction Chaining for Strict Ordering;
Cache Coherency Protocol with Forward/Owned State for Memory Access Reduction in Multicore CPU;
Switched Bus Fabric for Interconnecting Multiple Communicating Units; and
Line-Speed Packet Hijack Mechanism for in-situ Analysis, Modification, and/or Rejection.

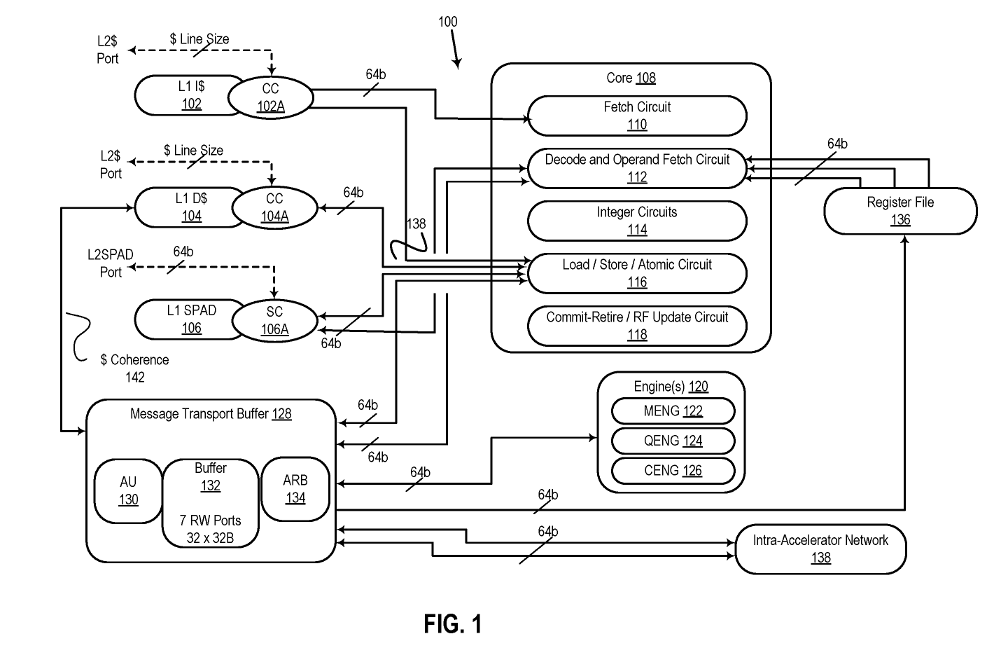

FIG. 1 illustrates one example of an accelerator architecture for implementing an instruction set architecture to facilitate energy-efficient computing for Exascale architectures (i.e., computing systems capable of at least one exaflop, or a billion, billion calculations per second). As shown, system 100 includes first-level data and instruction caches, first-level instruction cache (L1 I$ 102) with cache control circuit (CC 102A), and first level data cache (L1 D$ 104) with cache control circuit (CC 104A), and L1 scratchpad (SPAD) 106 and SPAD control circuit (SC 106A). Each of the first level memories, L1 I$ 102, L1 D$ 104, and L1 scratchpad (SPAD 106) can have a cache-line-sized interface to a corresponding second level memory.

System 100 also includes core 108, which includes fetch circuit 110 (which is connected to first-level instruction cache (L1 I$ 102) through cache controller (CC 102A)), decode and operand fetch circuit 112 (which is connected to message transport buffer 128, register file 136, and first-level scratchpad (SPAD 106) through SPAD controller (SC 106A)) and register file 136), integer circuit 114 (to perform integer operations), load/store/atomic circuit 116 (which is connected with L1 I$ 102 through CC 102A, L1 D$ 104 through CC 104A, L1 SPAD 106 through 106A, and message transport buffer 128), and commit-retire/register file (RF) update circuit 118. As shown decode and operand fetch circuit 112 is coupled to register file 136 by three 64-bit ports, allowing multiple registers to be accessed concurrently. (It should be noted that several connecting lines or busses in FIG. 1 include a bit-width indicator, like “/64b” to indicate the width of the line. Control and address lines are not shown. It should also be noted that the selected bit-widths and port sizes are just implementation choices of the embodiment, and should not limit the invention.) Message transport buffer 128, includes atomic unit (AU 130), buffer 132 (which includes thirty-two 32B buffer entries, and seven read/write ports), and arbiter (ARB) 134. Message transport buffer 128 is coupled, via 64-bit lines, to intra-accelerator network 138, and, via 64-bit lines, to decode and operand fetch circuit 112, load/store/atomic circuit 116, register file 136, and accelerator engines 120, which include a memory engine (MENG 122), a queue engine (QENG 124), and a collectives engine (CENG 126).

In operation, core 108 is to generate and send DMA instructions to the memory engine (MENG 122, as further described in the section herein entitled “ISA Facilitated Micro-DMA Engine”), add and remove instructions to the queue engine (QENG 124, as further described in the section herein entitled “Simplified Hardware Assisted Queue”), and perform collective operation instructions using the collectives engine (CENG 126, as further described in the section herein entitled “Collectives System Architecture”).

In some embodiments, CENG 126 is used to group core 108 with other cores (not shown) via the intra-accelerator network 138. In particular, CENG 126 and each CENG in the other cores may include a set of three “input” registers, one “output” register, as well as status and control registers, with one input register being reserved to the local core and the other two input registers being programmed by software to point to either NULL (no input expected) or the address of another core's output register. The pairing of “output register address at Core J” corresponding to “input register address at Core K” in effect creates a doubly-linked list under software control. This allows for traversal in either direction within the defined graph that these outputs and inputs define.

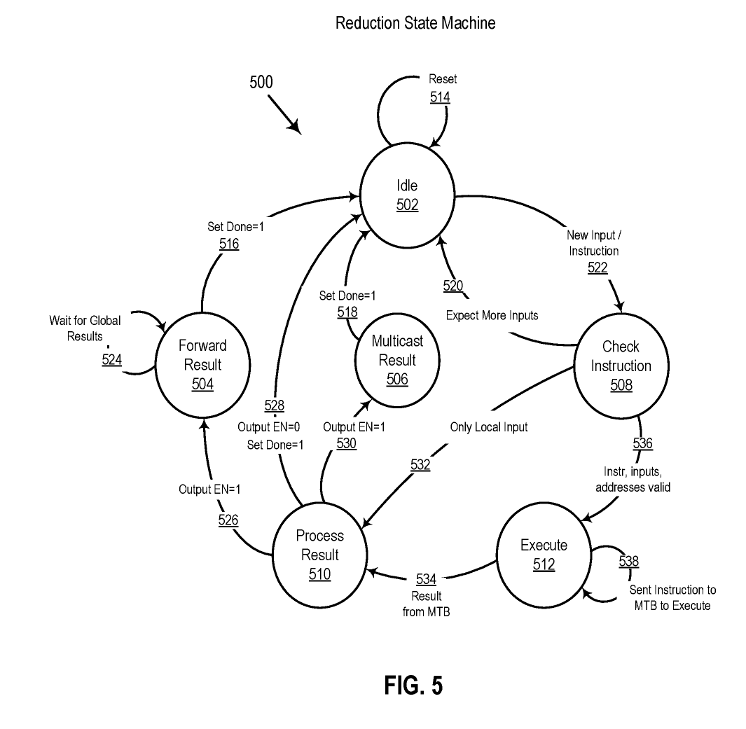

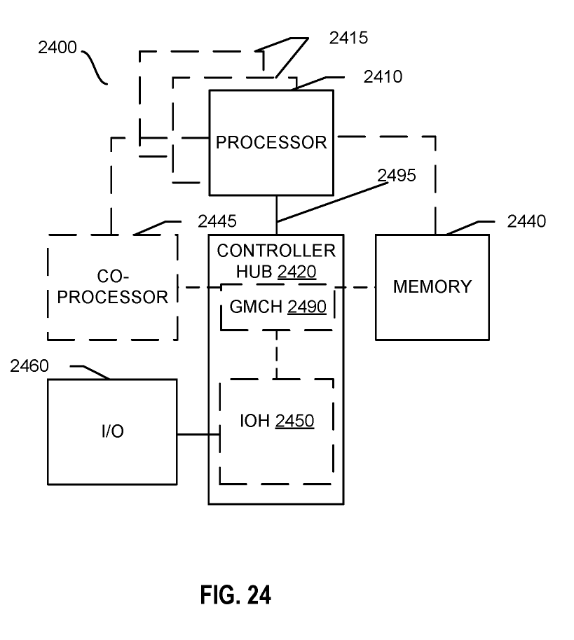

As shown, CENG 126 communicates with its neighbor nodes programmed in its three “input” registers and one “output” register using the intra-accelerator network 138 via message transport buffer 128. Each agent included in the resulting graph is considered a vertex. In this manner, a pseudo-3-ary tree is constructed by software to represent the pattern of communications—including any necessary ordering—for mathematical properties (such as floating point (FP) associativity)—which can run in either forward or reverse directions. An “output” register with a NULL value defines the root vertex of a tree, since there is no further communication beyond that agent. The core and execution circuitry of disclosed embodiments is further described and illustrated at least with respect to FIGS. 5-7, 10, and 20-23. The architecture of computing system 100 is further described and illustrated below, at least with respect to FIGS. 24-28.

Multiple instances of the CENG and state can be present per core, allowing multiple concurrent and optionally overlapping trees to be defined and used with no penalty.

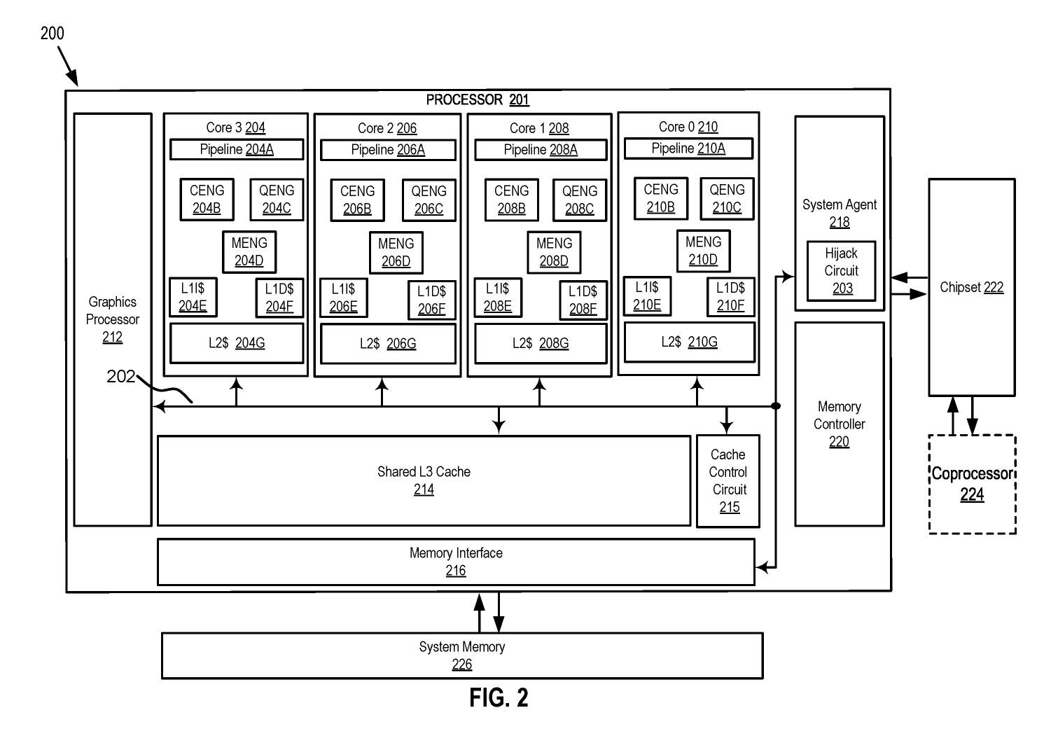

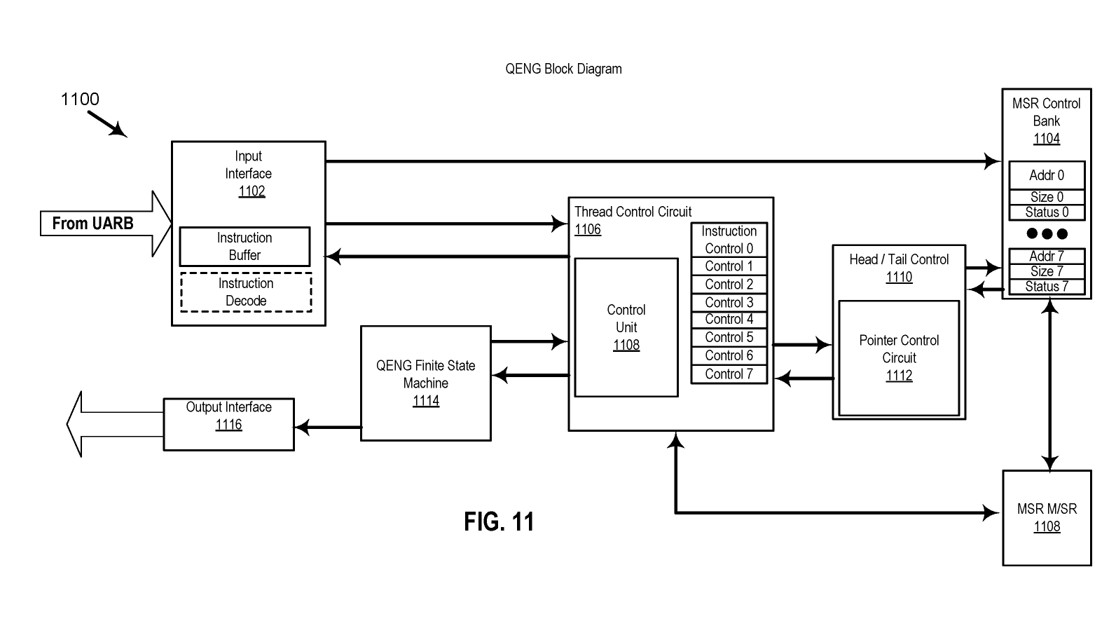

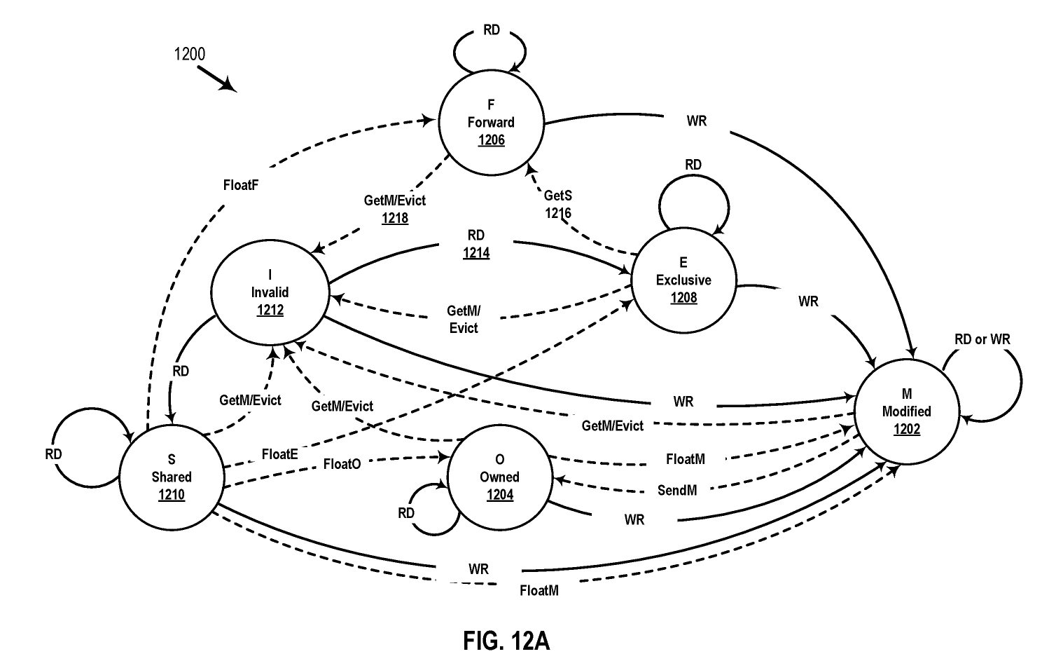

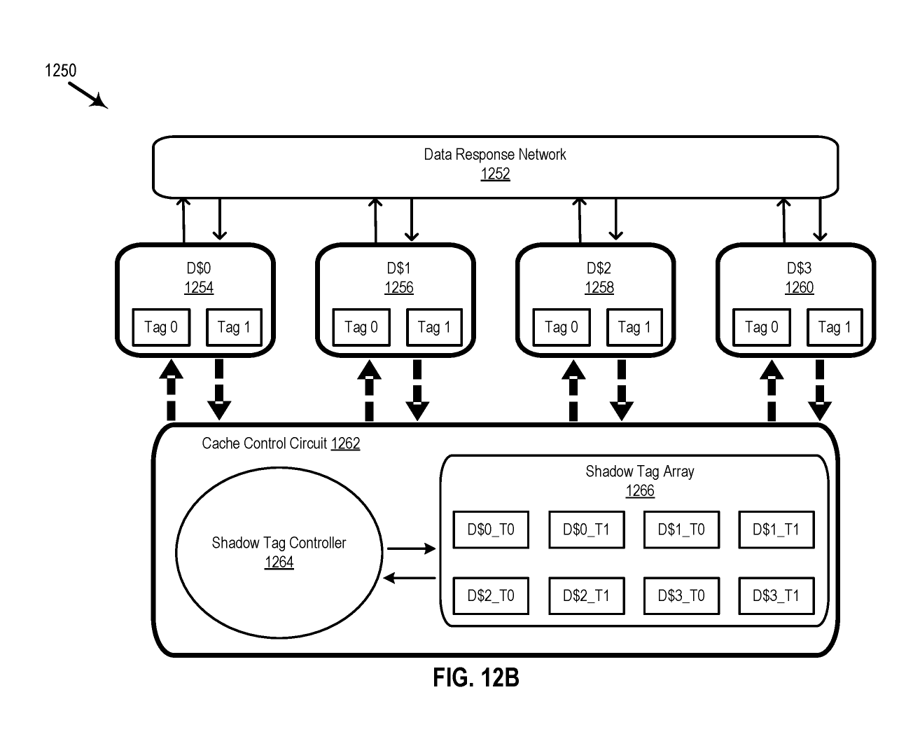

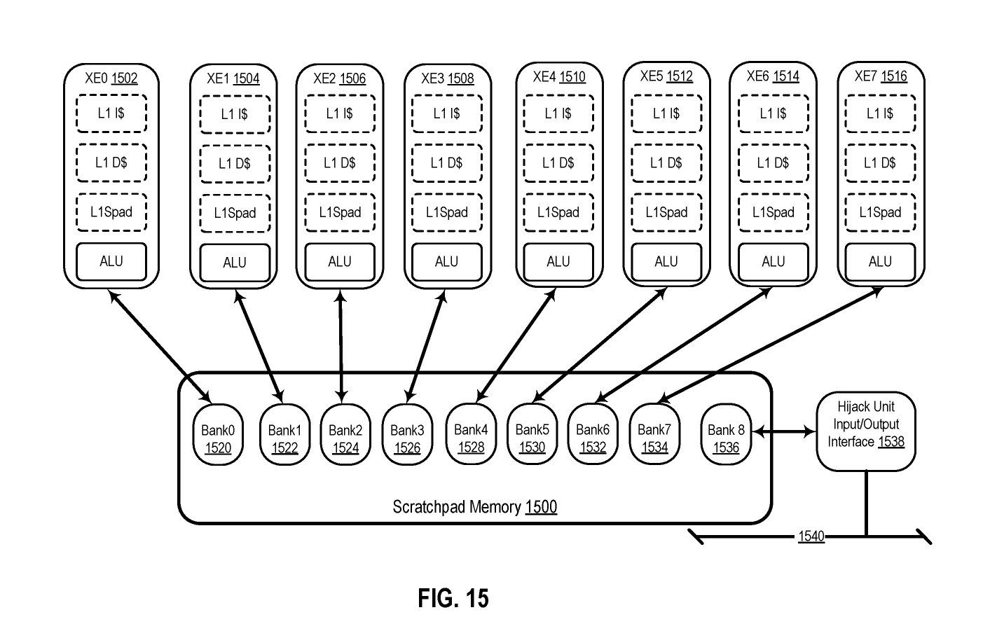

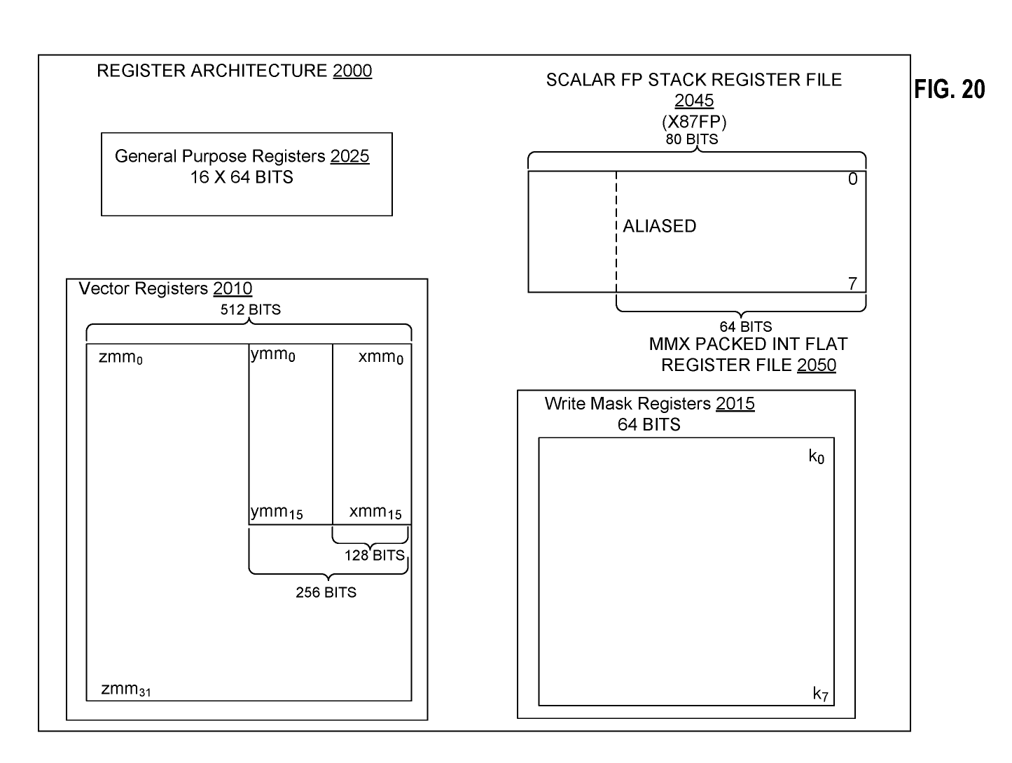

FIG. 2 is a block diagram illustrating strategic integration of multiple accelerator engines into a computing system, according to some embodiments. As shown, computing system 200 includes processor 201, chipset 222, optional coprocessor 224, and system memory 226. Processor 201 includes multiple cores, 204, 206, 208, and 210, as well as graphics processor 212, shared third-level (L3) cache 214, cache control circuit 215, memory interface 216 (coupled to system memory 226), system agent 218 (coupled to chipset 222), and memory controller 220. Interconnect 202 communicatively couples all of the components, 204, 206, 208, 210, 212, 214, 216, 218, and 220 of processor 201. In some embodiments, as shown, hijack circuit 203 is incorporated in system agent 218. It should be noted that the specific placement of the engines with respect to the pipeline and other features can vary, without limitation; engines may be moved or interconnected in different ways based on cost, area, and performance considerations. The cache control circuit 215 and the cache coherency protocol applied by disclosed embodiments is further described and illustrated below, at least with respect to FIGS. 12A-12B. The hijack circuits are further described and illustrated below, at least with respect to FIGS. 15-17. The architecture of processor 201 is further described and illustrated with respect to FIGS. 20-23. The architectures of computing system 200 and processor 201 are further described and illustrated below, at least with respect to FIGS. 24-28.

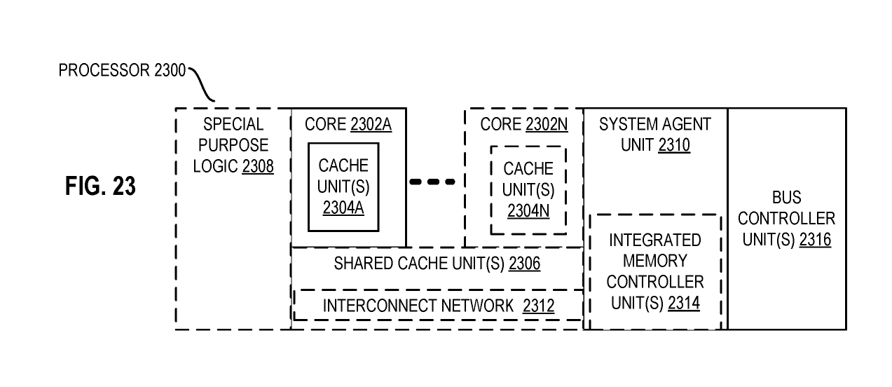

Core 204 includes pipeline 204A, CENG 204B, QENG 204C, MENG 204D, first-level instruction cache (L1I$ 204E), first-level data cache (L1D$ 204F), and a unified second-level cache (L2$ 204G). Similarly, core 206 includes pipeline 206A, CENG 206B, QENG 206C, MENG 206D, first-level instruction cache (L1I$ 206E), first-level data cache (L1D$ 206F), and a unified second-level cache (L2$ 206G). Likewise, core 208 includes pipeline 208A, CENG 208B, QENG 208C, MENG 208D, first-level instruction cache (L1I$ 208E), first-level data cache (L1D$ 208F), and a unified second-level cache (L2$ 208G). Also, core 210 includes pipeline 210A, CENG 210B, QENG 210C, MENG 210D, first-level instruction cache (L1I$ 210E), first-level data cache (L1D$ 210F), and a unified second-level cache (L2$ 210G). The components and layout of the processors and computing systems of disclosed embodiments is further described and illustrated, at least with respect to FIGS. 23-28.

It should be noted that, as shown, each of the engines, MENG, CENG, and QENG has been strategically incorporated into its associated core, with a strategy selected to maximize performance and minimize cost and power consumption. For example, in core 204, the MENG 204D has been placed right next to the first and second level caches.

### Collective Operations

In “collective reductions,” where each core is potentially contributing to find a value (such as “global maximum”), the tree runs from leaf nodes to the vertex; once the final value (“global maximum”) is found at the root vertex, the tree runs backward to broadcast the resulting value back to each participating core.

In a similar vein, the tree can also do broadcast/multicast operations by directly propagating the “to be multicast value” straight to the root vertex, at which point the root vertex propagates the message back down to the leaf nodes, following the graph in reverse.

Similar modifications can be used to support barriers, which are a blend of reduction and multicast behaviors.

The disclosed ISA supports at least the collective operation instructions listed in Table 1 and Table 2. The listed instructions are capable of being invoked at the ISA level.

To enable the CENG to perform collective operations, software configures the CENG by programming some model-specific registers (MSRs) within each of the participating CENGs. Multiple concurrent sequences (up to N operations) would naturally define N copies of the appropriate MSRs. Software configures the collective system as follows. Before starting any CENG operation, software is first to configure some MSRs within the CENG. Barrier configuration is done at block level, while reduction and multicast configuration are done at execution unit (XE) level. Software then programs “input” and “output” address MSRs for reduction and multicast. Software then sets the corresponding enable bits in the REDUCE_CFG/MCAST_CFG register. Software then sets the enable bit to configure the CENG FSM to wait for the correct number of inputs before performing reduction/multicast operation.

### Collectives System Architecture

Simplified Asynchronous Collective Engine (CENG) with Low Overhead

Collective operations are a common and critical operation in parallel applications. Examples of collective operations include, but are not limited to: reductions, all-reductions (reduce-2-all), broadcasts, barriers, and parallel prefix operations. The disclosed instruction set architecture includes specific instructions to facilitate execution of collective operations.

The disclosed instruction set architecture defines a collectives engine (CENG), which includes circuitry to maintain one or more state machines to manage execution of collective operations. In some embodiments, the CENG includes hardware state machines that manage execution of collective operations, whether in the form of barriers, reductions, broadcast, or multicast. In some embodiments, the CENG is a simplified, asynchronous, off-load engine that can support an arbitrary architecture platform and ISA. It presents a uniform interface that allows for broadcast, multicast, reductions, and barriers across user (software) defined collections of cores. Without the disclosed CENG and specific collective operation instructions, software would need to issue multiple stores to configure a memory-mapped input/output (MMIO) block to start the transfer.

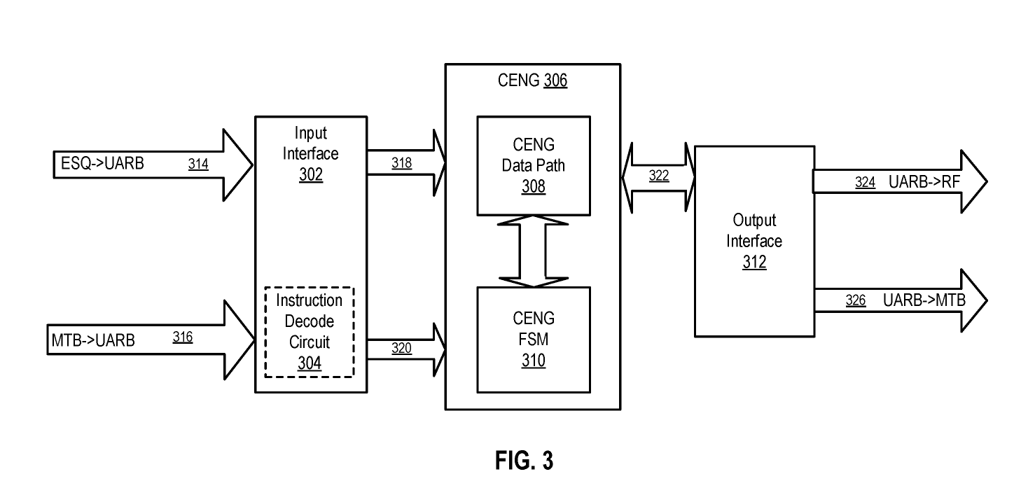

FIG. 3 is a block diagram illustrating integration of a collectives engine (CENG) into a core pipeline, according to some embodiments. As shown, input interface 302 is coupled to receive instructions from the engine sequencing queue (ESQ) and universal arbiter (UARB) via path ESQ→UARB 314, or from universal arbiter (UARB 316, sometimes referred to as a “ubiquitous” arbiter). Input interface 302 includes buffers (not shown) to store received instructions. In some embodiments, input interface 302 includes instruction decode circuit 304 to decode received instructions. Input interface 302 is coupled to CENG data path 308 through path 318, and to CENG finite state machine (CENG FSM 310) through path 320. CENG 306 is coupled to output interface 312 through path 322. In some embodiments, output interface 312 is coupled to the core pipeline, for example to send results to a decode stage, or to a commit/retire stage.

In operation, in the case of a collective operation instruction being generated by a core pipeline in the same core as CENG 306, input interface 302 receives a collective operation instruction from the engine sequencing queue (ESQ) and universal arbiter (UARB) via path ESQ→UARB 314. For collective operation instructions that originate from a different CENG in a different core, input interface 302 receives the collective operation instruction from message transport buffer (MTB) and universal arbiter (UARB) via path MTB→UARB 316.

Input interface 302 buffers the received collective operation instructions in buffers until they have been executed or forwarded back to the core pipeline. In some embodiments, input interface 302 buffers incoming collective operation instructions in a first-in, first-out (FIFO) buffer (not shown). In some embodiments, input interface 302 buffers incoming collective operation instructions in a static random access memory (SRAM) (Not shown). In some embodiments, input interface 302 buffers incoming collective operation instructions in a bank of registers (Not shown).

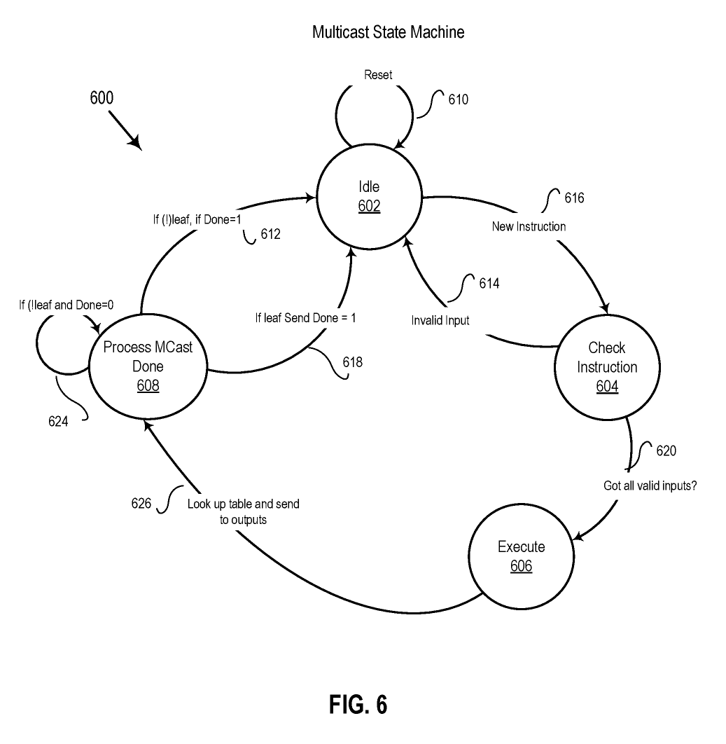

CENG 306 processes the received collective operation instructions using CENG data path 308 in conjunction with CENG finite state machine (CENG FSM 310). An illustrative example of CENG FSM 310 is illustrated and discussed, at least with respect to FIG. 6, below. Upon completion, CENG 306 communicates the message to output interface 312 via path 322. Output interface 312 then communicates with universal or ubiquitous arbiter (UARB)- and register file (RF) via path UARB→RF 324 and with UARB→MTB via path UARB→MTB 326. Collective operations may require many small messages and often require barriers after setting up participating cores and before the first operation can take place.

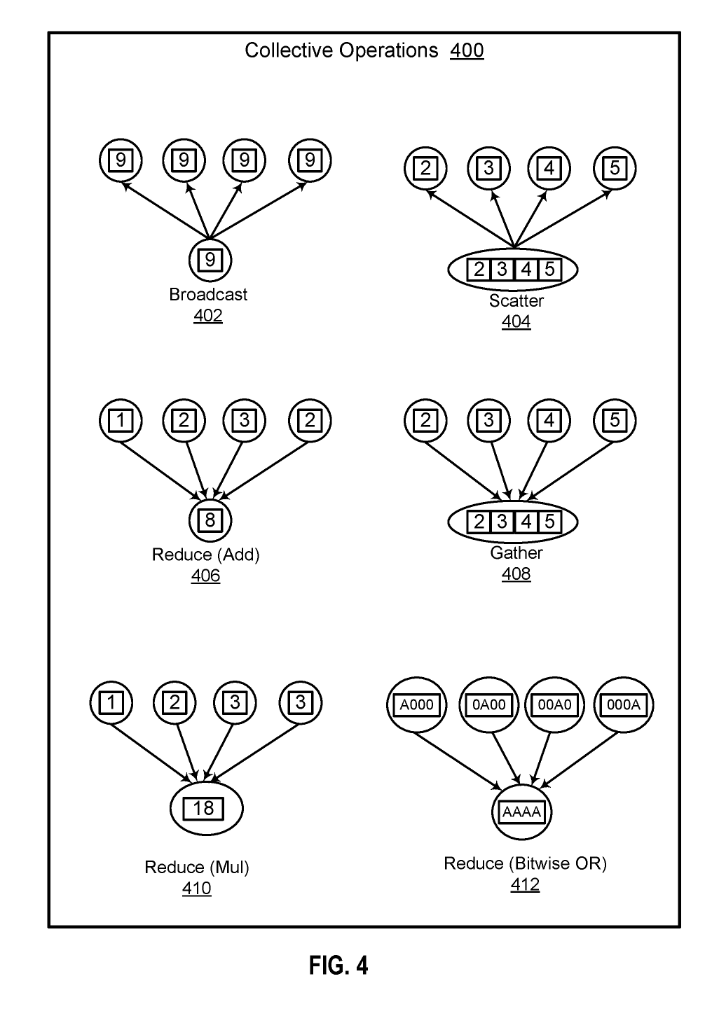

FIG. 4 illustrates behaviors of a few of the collective operations supported by the disclosed instruction set architecture, according to some embodiments. As shown, multiple (here, five) nodes of a parallel processing system participate in exemplary collective operations. Illustrated collective operations 400 include broadcast 402, by which a root value of ‘9’ is broadcasted from a root to the participating nodes; scatter 404, by which each element of an array of four values is scattered from a root node to four participating nodes; reduce (Add) 406, by which a sum ‘8’ of the values of the other nodes is compiled at the root node; gather 408, by which four values are gathered from four nodes and stored into an array on the root node; reduce (Mul) 410, by which a product ‘18’ of the values of the other nodes is compiled at the root node; and reduce (Bitwise OR) 412, by which bitwise OR is compiled at a root node from the four other nodes. In operation, the various participating nodes may take differing amounts of time to provide their results, such that the rood mode may have to await arrival of multiple such elements. In some embodiments, the final value or incremental values generated by a node participating in a collective operation may be back-propagated to those nodes that participated prior to this one.

By providing instructions to support collective operations, the disclosed ISA represents an improvement to a processor architecture, at least insofar as it is natural to the programmer and that can provide an efficient means to communicate amongst a pool of processors. Table 1, below, lists some of the collective operations supported by the disclosed ISA, and Table 2 lists some calling formats, including the number of operands, for collective operations produce the disclosed ISA.

TABLE 1

| Instruction | Description |
|---|---|
| All-to-All | Every node scatters and gathers an array |
| AllGather | A gather followed by a broadcast |
| AllReduce | A reduce followed by a broadcast |
| Barrier | Wait for every node to reach a same barrier |
| Broadcast | Send an item to all participating nodes |
| Gather | Gather an item from all participating node |
| Multicast | Send an item to multiple nodes |
| Prefix | A reduce, but keeping the partial results |
| Reduce | Collect an item from all participating nodes |
| | and perform an operation (e.g. min, max, |
| | sum, product, logical) to generate a result |
| Scatter | Distribute an array of values, giving a |
| | different value to each participating node |

TABLE 2

| Instruction | Ops | Details |
|---|---|---|
| barrier.init | | Initialize a barrier |
| barrier.wait | | Wait until barrier is met |
| barrier.poll | r1 | r1 = Status of barrier (non-blocking) |
| mcast.reg | r1, r2 | r1 = dst reg at participating XE, r2 = SRC |
| | | reg to mcast from |
| mcast.mem | r1, r2 | r1 = dst reg at participating XE, r2 = Mem |
| | | address to mcast from |
| reduce.wait | | Wait (Stall the XE pipeline) until |
| | | reduction is complete |
| reduce.poll | r1 | r1 = Status of reduction (non-blocking) |
| reduce.maxF | r1, r2 | r1 = dst reg, r2 = src reg to reduce max |
| | | from (also dst address) |
| reduce.maxU | r1, r2 | r1 = dst reg, r2 = src reg to reduce max |
| | | from (also dst address) |
| reduce.maxS | r1, r2 | r1 = dst reg, r2 = src reg to reduce max |
| | | from (also dst address) |
| reduce.minF | r1, r2 | r1 = dst reg, r2 = src reg to reduce min |
| | | from (also dst address) |
| reduce.minU | r1, r2 | r1 = dst reg, r2 = src reg to reduce min |
| | | from (also dst address) |
| reduce.minS | r1, r2 | r1 = dst reg, r2 = src reg to reduce min |
| | | from (also dst address) |
| reduce.addF | r1, r2 | r1 = dst reg, r2 = src reg to add |
| reduce.addI | r1, r2 | r1 = dst reg, r2 = src reg to add |
| reduce.mulF | r1, r2 | r1 = dst reg, r2 = src reg to multiply |
| reduce.mulI | r1, r2 | r1 = dst reg, r2 = src reg to multiply |
| reduce.bitop1 | r1, r2 | r1 = dst reg, r2 = src reg to perform bit |
| | | operation on (and, or, xor, . . . ) |

The disclosed instruction set architecture integrates specific instructions into the ISA for performing collectives. Software can build and manage barrier/reduction/multicast networks and perform these operations in either blocking or non-blocking manner (i.e. offloaded from the core pipeline). In some embodiments, a “poll” feature is included and enables a non-blocking operation when more work can be done and the resource has not yet been resolved in the collective. The disclosed ISA provides three groups of collective operations—initialize, poll, and wait. Initialize starts the collective operation. Wait stalls a core until the collective operation is complete. Poll returns the status of the collective operation.

The disclosed ISA also describes circuitry that can be used to execute the specific collective instructions. For barrier operations, according to the disclosed ISA, a block-level single bit AND/OR tree barrier network with software-managed configuration select execution units (XEs) to participate in each barrier. In some embodiments, one CENG instance exists in each accelerator core with address-based a Reduction/Multicast network configurable by software.

FIG. 5 illustrates a state flow diagram for a reduction state machine implemented by a collectives engine (CENG), according to some embodiments. Reductions are one of several types of collective operations provided by the disclosed ISA and implemented by the CENG. At least a few of the collective operations supported by the disclosed ISA are listed and described with respect to Table 1 and Table 2.

As shown in FIG. 5, reduction finite state machine 500 includes six states: (idle 502), (forward result 504), (multicast result 506), (check instruction 508), (execute 512), and (process result 510).

In operation, the CENG implementing the reduction state machine starts, for example, after a reset 514 or a power-on, in (Idle 502) state, where it awaits an instruction. When a new input (e.g., a value from a node participating in the reduction operation) or instruction (e.g., a reduction instruction) arrives, the state machine transitions, via arc 522, to (Check Instruction 508) state, where it determines whether any more inputs are expected (e.g., from other nodes participating in the reduction operation), or if the instruction is ready to be processed. If more inputs are expected, the state machine transitions, via arc 520, back to (Idle 502) state to await more inputs.

Otherwise, if no more inputs are expected and only local (i.e., from this node) inputs are involved, the CENG state machine transitions, via arc 532, to (Process Result 510) state, where the reduction operation (e.g., add, multiply, logical) will be performed. In some scenarios, the CENG determines, in the (Check Instruction 508) state, that an input is required from another node, in which case the state machine transitions, via arc 536, to (Execute 512) state, at which time the CENG sends the instruction, via arc 538, to the message transfer buffer (MTB) to be processed by another node, and awaits a result from the other node. Once a result is received, the CENG transitions, via arc 534, to (Process Result 510) state, where the reduction operation (e.g., add, multiply, or logical) will be performed.

At (Process Result 510) state, the CENG processes the instruction and generates a result, for example by executing the specified operation on the received inputs. The operation to be performed may be to generate a minimum, a maximum, a sum, a product, and a bitwise logical, to name a few, non-limiting examples.

After generating a result, the CENG determines, at (Process Result 510) state, whether the result is to be sent to another participating node. If the result is to be sent to one other node, the CENG transitions, via arc 526, to (Forward Result 504) state, forwards the result to another participating node, waits, via arc 524, for global results to be completed, and sets a Done flag. If the result is to be sent to multiple other nodes (e.g., in response to an AllReduce instruction), the CENG transitions, via arc 530, to (Multicast Result 506) state, multicasts the result to multiple other participating nodes, and sets the Done flag. If, on the other hand, the collective operation is only local and need not be forwarded to another node, the CENG sets the Done flag. Finally, once the Done flag has been set, the CENG transitions, via arcs 516, 518, or 528, back to (Idle 502) state, where the CENG resets the Done flag and awaits a next instruction.

It should be noted that the CENG reduction state machine 500 provides an advantage of supporting multiple different types of reduction operations, including a reduction-to-all, a reduction-to-broadcast, and a simple reduction, using portions of the same states and state transitions, at least with respect to the (Idle 502), (Check Instruction 508), (Execute 512), and (Process Result 510) states. Incorporating the CENG reduction state machine 500 improves the computing system by providing a simple circuit with a low cost and power utilization.

FIG. 6 illustrates a state flow diagram for a multicast state machine implemented by a collectives engine (CENG), according to some embodiments. Multicasts are one of several types of collective operations provided by the disclosed ISA and implemented by the CENG. Broadcasts are similar. At least a few of the collective operations supported by the disclosed ISA are listed and described with respect to Table 1 and Table 2.

As shown in FIG. 6, multicast state machine 600 includes (Idle 602), (Check Instruction 604), (Execute 606), and (Process MCast Done 608) states.

In operation, the CENG implementing the multicast state machine starts, for example, after a reset or a power-on, in (Idle 602) state, where it awaits an instruction. When a new instruction arrives, for example from the engine sequencing queue (ESQ) and universal arbiter (UARB) (See FIG. 2), the state machine transitions, via arc 616, to (Check Instruction 604) state, where the instruction inputs, such as the address and operand(s), are valid. If not, the state machine transitions, via arc 614, back to (Idle 602) state. But if the inputs are valid, the state machine transitions, via arc 620, to (Execute 606) state, during which the CENG determines which nodes are to receive the multicast. In some embodiments, such determination may be made by accessing a table that lists the multicast recipients.

The CENG multicast state machine then transitions, via arc 626, to (Process MCast Done 608) state, where it waits until the multicast operation is done. If the node in which the CENG is incorporated is a leaf node in a binary tree of participants, the CENG waits, via arc 624, in (Process MCast done 608) until all participating nodes are done, at which time the CENG transitions, via arc 618, to (Idle 602) state. If the CENG, on the other hand, is not part of a leaf node, it transitions, via arc 612, back to (Idle 602).

The disclosed CENG implementations are expected to be simpler and have lower cost and power expenditure compared to other solutions.

### Dual Memory ISA Operations

The disclosed instruction set architecture includes a class of instructions for performing various dual-memory operations, which are common in parallel, multi-threaded, and multi-processor applications. The disclosed “dual memory” instructions use two addresses in load/store/atomic operations. These are presented in a form of (D)ual memory operation consisting of (R)ead, (W)rite, or (X)atomic operations, such as: DRR, DRW, DWW, DRX, DWX. These operations are all “atomic” in the sense that both memory addresses involved are updated without any intervening operations being allowed during the dual address update.

In one embodiment, the dual memory instruction uses a naming convention of “dual_op1_op2”, where “dual” represents that two memory locations are in use, “op1” represents the type of operation to the first memory location, and “op1” represents the type of operation to the second memory location. Disclosed embodiments include at least the dual memory instructions listed in Table 3:

TABLE 3

Dual_read_read
Dual_read_write
Dual_writea_write
Dual_xchg_read
Dual_xchg_write
Dual_cmpxchg_read
Dual_cmpxchg_write
Dual_compare&read_read
Dual_compare&read_write

As described above, the dual-memory operations are primarily a set of instruction extensions that touch two memory locations in an atomic manner. Some embodiments capitalize on the structure of physical layout used by existing hardware to advantageously simplify the complexity of the operation by requiring the dual memory locations being manipulated by one instruction to live within the same physical structure—the same cache, the same bank of a large SRAM, or behind the same memory controller.

### Full/Empty (F/E) Instructions

Among many possible applications of the disclosed dual memory operations is the ability to perform fine-grained synchronization among many concurrent processes, such as those in an exascale architecture.

One approach to fine-grained synchronization uses Full/Empty (F/E) bits, where each datum in memory has an associated F/E bit. Operations can synchronize their execution by conditioning reads and writes to the datum based on the value of the F/E bit. Operations can also set or clear the F/E bit.

For example, an application can use the F/E bit to process a computer science graph having many nodes, each node being represented in memory by a data value having an associated F/E bit. When a plurality of processes are accessing the computer science graph in a shared memory, the F/E bit can be set when a process accesses a node of the graph. That way, fine-grained synchronization among the plurality of processes can be achieved using the F/E bit to indicate, when set, that a graph node has already been “visited.” Use of F/E bits may also improve performance and reduce a memory footprint by simplifying critical sections. Use of F/E bits may also facilitate parallelization of multiple concurrently-operating threads.

Use of a F/E bit, however, may cause some memory overhead, such as adding an additional bit per byte (12.5% overhead) dedicated to this purpose, or a bit per “word” (3% overhead). In every application that does not need or cannot use such bits, this additional burden on the hardware, memory subsystem, etc. amounts to a significant tax that cannot be avoided without further hardware complexity. These overheads also impact the powers-of-2 organization of machines and/or DRAM, which is not economically realistic.

Disclosed dual-memory instructions, however, can be used to emulate an F/E bit and avoid requiring an F/E bit to be stored with every datum in memory.

The key property of F/E bit support can be understood with two (of many) F/E instructions as used by Cray programmers. The two representative instructions are summarized below:
Write_If_Empty (address, value): if the F/E bit corresponding to “address” is not set, then write the datum “value” into address and set the F/E bit. The writes to both the F/E bit and the address location are “atomic” in observability properties, and either jointly succeed or jointly fail as with transactional memory semantics.
Read_And_Clear_If_Full (address, &value, &result): if the F/E Bit corresponding to “address” is set, then read the datum from that address and return it in the “value” field, while clearing the F/E bit to be not set, and returning in the “result” field a code for success; if the F/E bit is not set, then the “result” code is set to indicate failure. As with the “Write_If_Empty” case, the read from the address location and the clearing of the F/E bit is both atomic and transactional.

Fundamentally, both operations (and similar F/E instructions) work by manipulating two distinct memory locations in an atomic and transactional manner. In the Cray implementations, the two memory locations are embedded together into one “machine datum unit”, such as turning every byte into 9 bits rather than 8, or every 32-bit datum into a physical 33-bit unit. The F/E instruction then manipulates the extra bit of state according to a well-defined set of rules and properties.

The drawback of this scheme is as previously described—the significant overhead tax of additional storage in the memory subsystems when not all applications will use these constructs, and even for applications that do use them, not every memory location needs to be protected by such devices.

Emulation of the F/E bit operations are trivially supported by the disclosed dual-memory operations, where software allocates only additional F/E bit storage where required—if at all. For example, “read-and-clear” becomes “dual_read_write( )” with the “read” targeting the datum to be read, and the write pushing a zero-value into the F/E emulation space. Similarly, “write-if-empty” becomes “dual_cmpxchg_write”—comparing the F/E emulation storage with the desired value (empty). The disclosed dual-memory instructions also remove the limitation of an F/E bit that only has one value. Instead, disclosed dual-memory instructions provide a general purpose algorithm for having two different addresses that are modified as an atomic unit. The general purpose algorithm may be used to implement F/E bit, classic atomics, point of protection bits, and other software algorithms. One advantage of the disclosed dual-memory instructions is avoiding requiring the hardware to have an extra bit for every datum. Instead, software, as needed, creates and uses a metadata field and a structure.

By not requiring every datum to be associated with a stored F/E bit, however, the disclosed dual-memory operations address the underlying design goals of F/E bit support without mandating such hardware overhead except for those applications that use them.

One drawback to explicitly naming each memory location within a unified structure is the growth of operands—the “dual_cmpxchg_write” would potentially require two source addresses, two data values, and one comparison value. It is assumed the return values replace the data values. In some embodiments, to reduce the argument count to 4, hardware binds the “dual” operations that take more than 4 arguments to always use some known offset relative to the first term, or consecutive addresses for the second datum—that is, hardware requires that the two values be contiguous or otherwise be offset by a known, fixed offset in memory.

The specified dual memory locations are arbitrary, but some embodiments improve efficiency by requiring the memory locations to be accessed by a same memory controller.

The disclosed instruction set architecture also allows other, more advanced uses, such as tagging memory for garbage collection, tagging memory for valid pointers, or other “mark” or “associate” desires in software use for adding semantic information to values placed in memory on data or code. It also could enable a new class of lock-free software constructs, such as ultra-efficient queues, stacks, and similar mechanisms.

Other uses of these instructions generalize to typical data structure needs to update two fields behind a critical section, such as in linked list management, advanced lock structures such as MCS locks, etc. The dual-memory operations allow removal of some critical sections in these usage cases, but are not sufficient in this form to remove all such critical sections.

Similar uses of interest can be found in garbage collection algorithms, which rely on a mark-and-sweep characteristic like the nature of F/E bits. Marking of stack or heap locations for tracking free/use information, or to mark for buffer overflows (debugging or security attack monitoring) are also candidate areas for such ISA extensions.

### An ACK-Less Mechanism for Visibility of Store Instructions

The disclosed instruction set architecture includes stores with acknowledgement and stores without acknowledgement. The disclosed instruction set also includes blocking stores and non-blocking stores. By offering different types of stores, the disclosed instruction set architecture improves the exascale system or other processor in which it is implemented by offering flexibility to software.

An advantage of stores with an acknowledgement is the ability to gain visibility into the coherency state of the hardware. In some embodiments, when such a store encounters a fault, it returns an error code describing the fault.

An advantage of the stores without an acknowledgement is the ability for software to “fire and forget.” In other words, the instruction can be fetched, decoded, and scheduled for execution by a processor, without any further required management by the code.

The disclosed instruction set architecture includes a flush instruction. This instruction ensures that all outstanding stores without acknowledgement have been resolved before allowing the processor to proceed. When needed, this provides visibility into the coherency state when store without acknowledgement are used.

### An ISA Facilitated Micro-DMA Engine and Memory Engine (MENG)

The disclosed instruction set architecture includes a memory engine (MENG, for example, MENG 122 of FIG. 1) that allows memory accesses to be decoupled from an execution core pipeline, and, in the case of some non-blocking memory accesses, allowing the pipeline to continue doing useful work without awaiting completion of the memory access. The disclosed instruction set architecture includes instructions that cause a direct memory access (DMA) to send or receive blocks of data from memory, as managed by the MENG. Without the disclosed DMA instructions and MENG capabilities, software would need to issue multiple, such as 3 or 4, stores to configure a memory-mapped input/output (MMIO) block to start the transfer. Instead, the disclosed DMA instructions as part of the core ISA, removing the MMIO dependency, and adding additional data movement features.

The MENG is an accelerator engine available to a core for background memory movement. Its primary task is DMA-style copying for both contiguous and strided memory, with optional in-flight transformations. The MENG supports up to N (e.g., 8) different instructions, or threads, at any given time and allows for all N threads to be operated on in parallel.

By design, individual operations have no ordering properties with respect to each other. Software, however, can designate operations to be executed serially when stricter ordering is needed.

In some embodiments, the disclosed DMA instruction provides a return value, which indicates whether the DMA transfer completed or if any faults were encountered. Without the disclosed DMA instruction, software would need to repeatedly access the MMIO block to know whether and when the DMA transfer completed. By eliminating the reliance on MMIO transactions, the disclosed MENG improves performance and power utilization by avoiding these repeated MMIO accesses.

In some embodiments, a system strategically incorporates one or more instances of CENG, MENG, and QENG engines, with a strategy selected to optimize one or more of performance, cost, and power consumptions. For example, a MENG engine may be placed close to a memory. For example, a CENG engine or a QENG engine may be strategically placed close to a pipeline and to a register file. In some embodiments, a system includes multiple MENGs, some disposed near each of the memories, to perform the data transfer. In some embodiments, the MENG provides the ability to perform an operation on the data, such as, for example, incrementing, transposing, reformatting, and packing and unpacking the data. When multiple MENGs are included in a system, the MENG selected to perform the operation may be one that is closest to the memory block containing the addressed destination cache line. In some embodiments, a micro-DMA engine receives a DMA instruction and begins executing it immediately. In other embodiments, the micro-DMA engine relays the DMA instruction as a Remote DMA (RDMA) instruction to a different micro-DMA core at a different location to perform the decode. The optimal micro-DMA engine to execute the RDMA is determined based on locality to a physical memory location involved in the DMA operation, such that remote memory reads and writes over the network are minimized. For example, the micro-DMA engine located near the source memory of a bulk DMA copy will perform the full operation. The micro-DMA engine which sent the RDMA will maintain instruction information to provide status feedback to the requesting pipeline.

In some embodiments, the MENG implements a set of model-specific registers (MSRs) for software control and visibility. MSRs are control registers used for debugging, program execution tracing, computer performance monitoring, and toggling certain CPU features. Present at each instruction slot is a set of MSRs to provide the current instructions status, as well as a specific MSR for the current MENG design. Table 4 shows some of the MSRs and descriptions:

TABLE 4

| Register | Description |
|---|---|
| DSPEC | Read-only register for software that defines: |
| | Version, # of Buffers, Max # of instructions, etc. |
| DBUF0 | Read-only register that corresponds to the |
| | instruction PC that is currently using buffer_0 |
| DSTATUS0 | Status bitfield of buffer_0 |
| DADD0 | Read-only register that sets the latest memory |
| | address used by buffer_0 |
| . . . | . . . |
| QBUFn | Read-only register that corresponds to the |
| | instruction PC that is currently using this buffer_n |
| QSTATUSn | Status bitfield of buffer_n |
| DADDn | Read-only register that sets the latest memory |
| | address used by buffer_n |

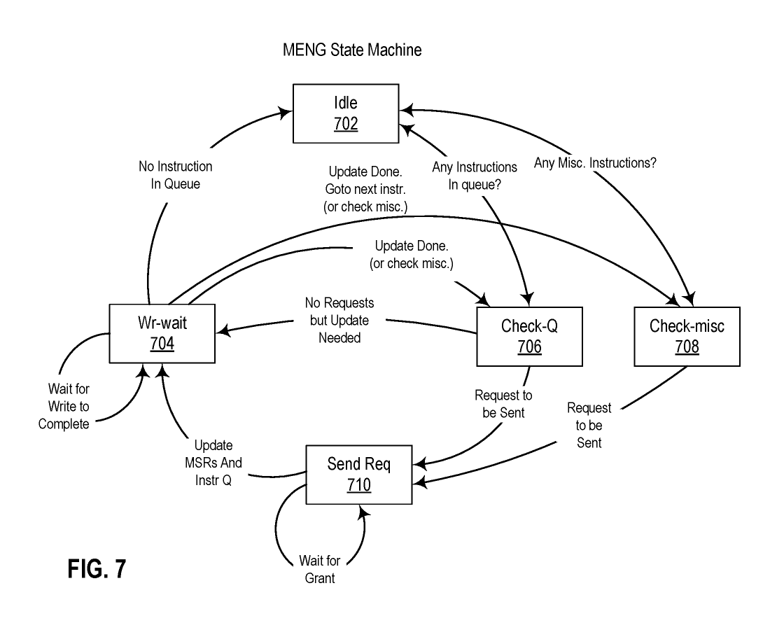

FIG. 7 illustrates a state machine implemented by a memory engine (MENG) on a per thread basis, according to some embodiments. As shown, the state machine starts in (Idle 702) during which it periodically checks whether any instructions are queued via (Check-Q 706) state or whether any miscellaneous instructions are pending via (Check-Misc 708) state. Note that the arcs to (Check-Q 706) and (Check-Misc 708) state are shown with arrows on both ends because the state machine returns to (Idle 702) state if no instructions are pending. From (Check-Q 706) state, the state machine transitions to (Send-Req 710) state if an instruction is enqueued, or to (Wr-Wait 704) state if no requests are enqueued but an update is needed. Similarly, from (Check-Misc 708) state, the state machine transitions to Send-Req 710) state if a miscellaneous instruction is waiting to be sent. At (Send-Req 710) state, the MENG state machine causes a request to be sent, and awaits a grant, after which the state machine transitions to (Wr-Wait 704) state to update model specific registers (MSRs) and the instruction queue. For example, a software-accessible MSR is updated to provide status of the instruction. The state machine stays in (Wr-Wait 704) state while it waits for a write to complete.

When multiple threads are being executed in a core, each thread maintains a MENG state machine that is responsible for tracking the state of the current operation and issuing any loads/stores to memory address being operated on.

Table 5 lists some of the MENG instructions, with behaviors defined as:

copy: directly copy memory contents, much like the C call to memcpy( )

copystride: copy memory contents when “striding” through either the source or destination, corresponding to a pack/unpack functionality

gather: collect from several discrete addresses in memory, copying the contents to a dense location elsewhere

scatter: disperse a dense set of data into several discrete addresses in memory, copying the contents.

TABLE 5
DMA Instructions

| Mnemonic | ASM Form & Args |
|---|---|
| dma.copy | r1, rfgh, r3, DMAType, SIZE |
| dma.copystride.1 | r1, r2, r3, SIZE |
| dma.copystride.2 | r4, r5, r6, DMAType |
| dma.gather.1 | r1, r2, r3, SIZE |
| dma.gather.2 | r4, r5, DMAType |
| dma.scatter.1 | r1, r2, r3, SIZE |
| dma.scatter.2 | r4, r5, DMAType |

As shown in the table, most MENG operations take an additional argument, called DMAtype. This immediate-encoded field is a table that governs additional functionality of the MENG operation. Table 6 specifies the DMAtype structure, a 12-bit field that includes several fields, as defined in the table:

It should be noted that not all fields of this DMAtype modifier will be applicable to all operations, and some fields, as described in the table, have behaviors that depend on the nature of the underlying DMA operation. Specific cases of what is and is not allowed are described on a per-instruction basis.

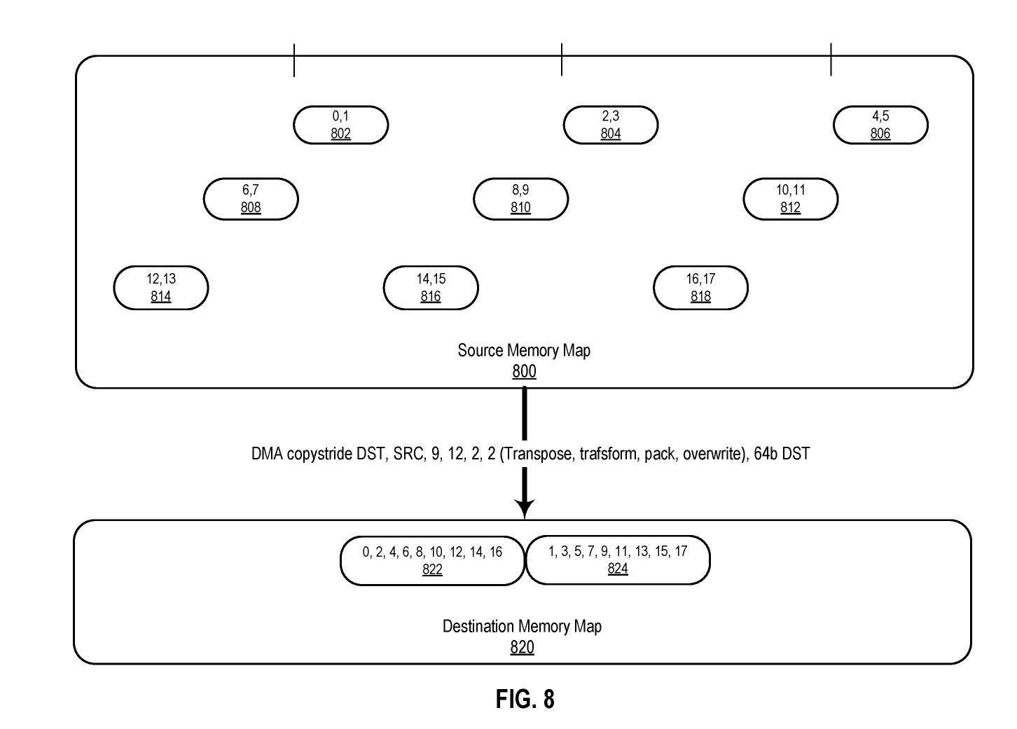

FIG. 8 illustrates behavior of an exemplary copystride DMA instruction, according to an embodiment. As shown, source memory map 800 includes data pairs 0,1 at 802, 2,3 at 804, 4,5 at 806, 6,7 at 808, 8,9 at 810, 10,11 at 812, 12,13 at 814, 14,15 at 816, and 16,17 at 818. After executing the instruction DMA copystride DST, SRC, 9, 12, 2, 2 (Transpose, transform, pack, overwrite), 64b DST, the destination memory map 820 includes the even elements packed at 822 and the odd elements packed at 824. After executing a DMA copystride instruction according to one embodiment, destination register 822 holds the even data values from the source memory map and destination register 824 holds the odd values.

### Memory Mapped I/O (MMIO) Based ISA Extension and Translation

In conjunction with and in support of the disclosed instruction set architecture, an instruction translator-collator memory-mapped input/output (TCMMIO) is to translate, collate, and relay requests from a main processor to one or more instances of one or more types of accelerator cores or engines. To the main processor, accesses to the accelerator cores or engines appear to be simple memory-mapped input/output (I/O) accesses to loads and stores. To the accelerator core, the TCMMIO behaves as an instruction issue/queue handler and accepts the resulting write-back, if any, from the accelerator core. Unlike a traditional memory-mapped I/O (MMIO) interface, where the master and slave exchange several writes/reads for I/O drivers/receivers, the TCMMIO disclosed herein collates several loads/stores from the main processor and translates the requests according to the custom ISA of the accelerator core, which can then be issued as-is to the accelerator cores.

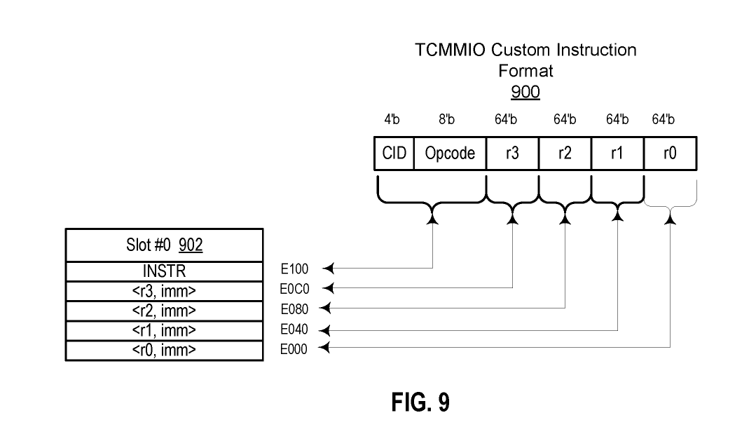

FIG. 9 is a diagram illustrating the relation from stores to the target custom instruction format and collation by the translator-collator memory-mapped input/output (TMMIO) block before issue to the accelerators, according to an embodiment. As shown, custom instruction format 900 includes a 4-bit command identifier (CID), an 8-bit opcode, and four 64-bit source operands. In some embodiments, the disclosed TCMMIO block contains multiple, such as six, memory-mapped register slots 902, each providing five 64-bit registers, to buffer multiple instances of the disclosed extended ISA. As shown, the five entries of memory-mapped register slot #0 902 include a 64-bit register to store an instruction, and four 64-bit registers to store operand. The disclosed TCMMIO provides a generalized interface, and can accept requests from any of the accelerators described herein, including a collectives engine (CENG), a queue engine (QENG), and a chain management unit (CMU).

By allowing the main processor to communicate with a variety of custom accelerator cores, including with future versions of accelerator cores, the disclosed TCMMIO can save tremendous amounts of software and driver team man hours, be it for prototyping or for a new product.

The disclosed TCMMIO transforms an existing memory-mapped I/O concept and extends the disclosed instruction set architecture to communicate with the accelerator cores or engines. As disclosed herein, any of the multiple accelerators, such as a memory engine (MENG), a queue engine (QENG), and a collectives engine (CENG) can avail themselves of the TCMMIO. In other words, any of the disclosed accelerators can use the TCMMIO custom instruction format 900 to convey a command to the TCMMIO, with the command including an opcode and up to four 64-bit operands. The extended ISA enables the main processor to directly communicate with the other accelerator cores without any design changes to either. This concept is generic enough to be implemented for any cross-ISA translation and extension. This enables the primary core to be very versatile and gives the compiler more options to schedule custom ISA instructions more effectively and create workloads for the best use of the accelerator cores.

In some embodiments, custom accelerator cores have specific predefined functions and instructions, and the disclosed ISA simply appends the accelerator identifier (4 bits) for the TCMMIO block's internal processing. In some embodiments, simply extending existing instructions to include the 4-bit identifier has the benefit of obviating the need for any instruction decoding and results in a single cycle instruction issue. This 4-bit extension is completely internal to the TCMMIO.

Unlike a traditional MMIO having a memory map that is huge and specific to an I/O type, implementing the disclosed TCMMIO according to one embodiment only requires six universal instruction slots. Each slot in turn has five 64-bit memory storage locations associated with it. Having only six instruction slots optimizes the area and power consumed by the TCMMIO, but keeps the performance benefits and generic nature of the design. Making the slots universal (i.e., not specific to any engines/instruction type) reduces the burden on software to keep track of a specific address map. Since most accelerator core instructions use up to 4 operands and some extra control bits, five 64-bit is expected to suffice.

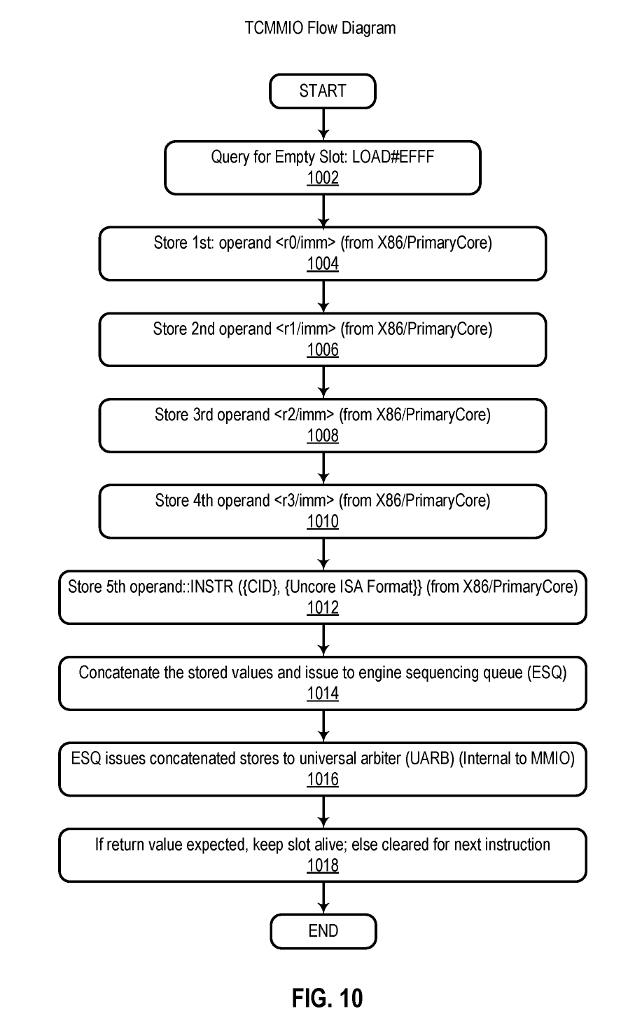

FIG. 10 is a block flow diagram illustrating execution of a memory access instruction by a translator-collator memory-mapped input/output (TCMMIO), according to some embodiments. As shown, after starting, the TCMMIO at 1002 receives a query for an empty slot, and if so, loads to index #EFFO. At 1004, the TCMMIO stores a 1st operand <r0/imm> (from X86/PrimaryCore)/. At 1006, the TCMMIO stores a 2nd operand <r1/imm> (from X86/PrimaryCore). At 1008, the TCMMIO stores a 3rd operand <r2/imm> (from X86/PrimaryCore). At 1010, the TCMMIO stores a 4th operand <r3/imm> (from X86/PrimaryCore). At 1012, the TCMMIO stores a 5th operand::INSTR ({CID}, {Uncore ISA Format}} (from X86/PrimaryCore). At 1014, the TCMMIO concatenates the stored values and issues to engine sequencing queue (ESQ). At 1016, the ESQ issues concatenated stores to universal arbiter (UARB) (Internal to MMIO). At 1018, the TCMMIO, if a return value expected, keeps the slot alive; otherwise, clears the slot for the next instruction.

### ISA Facilitated Micro-DMA Engine

The disclosed instruction set architecture includes instructions to directly cause a direct memory access (DMA) to send or receive blocks of data from memory. Without the disclosed DMA instructions, software would need to issue multiple, such as 3 or 4, stores to configure a memory-mapped input/output (MMIO) block to start the transfer.

Instead, the disclosed instruction set architecture includes a memory engine (MENG) accelerator that improves on this by including DMA instructions as part of the core ISA, removing the MMIO dependency, and adding additional data movement features. The MENG may be decoupled from an execution core pipeline, allowing, in the case of a non-blocking DMA instruction, the pipeline to do useful work without awaiting completion of the non-blocking DMA instruction. The MENG improves the system by facilitating background memory movement functionality that is decoupled from the core pipeline while directly integrated with the ISA to avoid the overhead and complexity of MMIO interfaces.

The MENG is an accelerator engine available to a core for background memory movement. Its primary task is DMA-style copying for both contiguous and strided operations, with optional in-flight transformations.

The MENG supports up to N (e.g., 8) different instructions, or threads, at any given time and allows for all N threads to be operated on in parallel. By design, individual operations have no ordering properties with respect to each other. Software can designate operations to be executed serially when stricter ordering is needed.

In some embodiments, the disclosed DMA instruction provides a return value, which indicates whether the DMA transfer completed, or if any faults were encountered. Without the disclosed DMA instruction, software would need to repeatedly access the MMIO block to know whether and when the DMA transfer completed.

By eliminating the reliance on MMIO transactions, the disclosed MENG avoids relying largely on MMIO transactions to initiate operations, and avoids using units that are sub-optimally far away, yielding lower bandwidth and consuming more energy.

In some embodiments, a system includes multiple MENGs, some disposed near each of multiple memories, to perform the data transfers. In some embodiments, the MENG provides the ability to perform an operation on the data, such as, for example, incrementing, transposing, reformatting, and packing and unpacking the data. The MENG selected to perform the operation may be one that is closest to the memory block containing the addressed destination cache line. In some embodiments, a micro-DMA engine receives a DMA instruction and begins executing it immediately. In other embodiments, the micro-DMA engine relays the DMA instruction to a different micro-DMA engine to attempt to improve one or more of power and performance.

### Simplified Hardware Assisted Queue Engine (QENG)

The disclosed instruction set architecture includes instructions and a queue engine (QENG) to provide simplified hardware-assisted queue management. The QENG facilitates low-overhead inter-processor communication with short messages of up to 4-8 data values, each up to 64 bits, without loss of information and with optional features for enhanced software usage models. It should also be noted that the selected bit-widths are just implementation choices of the embodiment, and should not limit the invention.

The QENG provides a hardware-managed queue that operates on “queue events” with background atomic properties with respect to insertion/removal of data values at software-selectable per-instruction head or tail of the queue. Queue instruction implementation is sufficiently generic that multiple software usage models are encompassed in a concise manner, from doorbell-like functionality to small MPI-like send/receive handshakes.

FIG. 11 is a block diagram illustrating implementation of a queue engine (QENG), according to some embodiments. As shown, QENG 1100 includes input interface 1102, model specific register (MSR) control bank 1104, thread control circuit 1106, which includes control unit 1108, head/tail control circuit 1110, which includes pointer control circuit 1112, QENG finite state machine 1114, and output interface 1116.

In operation, according to some embodiments, input interface 1102 receives an instruction from universal arbiter (UARB) (sometimes referred to as ubiquitous arbiter), and stores the instruction in an instruction buffer. In some embodiments, input interface 1102 also includes an instruction decode circuit used to decode the instruction and derive its opcode and operands. When the instruction is a request to access an MSR, the instruction is forwarded to MSR control bank 1104, where it accesses a memory-mapped MSR. Otherwise, the instruction is forwarded to thread control circuit 1106, which determines which of eight supported threads the instruction belongs to, and accesses the corresponding instruction control register, which is used by head/tail control 1110 circuit to use pointer control circuit 1112 to update the pointers for the thread. QENG finite state machine (FSM) 1114 governs QENG behavior and passes resulting information out to the UARB.

By avoiding placing a burden on software to manage queue buffers, which is often a time consuming process as the software is restricted by memory bandwidth and latencies, the QENG puts the queue management in the background under hardware control. Software only needs to configure a queue buffer and issue background instruction to the hardware. This improves the power and performance of a processor implementing the disclosed ISA.

### QENG Queue Management Instructions

Table 7 lists and describes some queue-management instructions provided by the disclosed ISA, and lists the expected number of operands for each. To execute a QENG operation, a core issues any of the following instructions—where (h/t) indicates whether the operation is acting on the Head or Tail of the queue, and (w/n) indicates waiting (blocking) or non-waiting (non-blocking) behavior.

Queue-management instructions added to the ISA and supported by the QENG include an instruction to enqueue a data value at a location, and an instruction to dequeue a data value from a location. In some embodiments, the managed queue resides in a memory near the QENG. QENG queue management instructions allow for creation of arbitrary queue types (FIFO, FILO, LIFO, etc.). Queue instructions also come in both blocking and non-blocking variants to ensure ordering when required by software.

### QENG Enqueue

In some embodiments, new queue entries are added at the current pointer location, i.e. to add ‘n’ data items:

1. Add data at the current pointer

2. Increment the pointer address

3. Repeat ‘n’ times

### QENG Dequeue

In some embodiments, dequeues are executed by decrementing the pointer by data size, and then removing data at the pointer, i.e. to remove ‘n’ items:

1. Decrement the pointer address

2. Fetch data from the pointer

3. Repeat ‘n’ times

A single dequeue can span over data which has been added in using multiple add instructions to either head OR tail.

TABLE 7

| Instr | Ops | Description |
|---|---|---|
| qma.add1.w | r1, r2 | r1 - address of QBUF MSR, r2 - datum to add |
| (h/t) | | to queue |
| qma.add1.n | r1, r2, r3 | r1 - register to receive status, r2 - address of |
| (h/t) | | QBUF MSR, r3 - datum to add to queue |
| qma.add2.w | r1, r2, r3 | r1 - address of QBUF MSR, r2 - datum 1 to |
| (h/t) | | add to queue, r3 - datum 2 to add to queue |
| qma.add2.n | r1, r2, | r1 - register to receive status, r2 - address of |
| (h/t) | r3, r4 | QBUF MSR, r3 - datum 1 to add to queue, r4 - |
| | | datum 2 to add to queue |
| qma.addx.w | r1, r2, r3 | r1 - address of QBUF MSR, r2 - first memory |
| (h/t) | | address for data to add to the queue, r3 - |
| | | number of datum values |
| qma.addx.n | r1, r2, | r1 - register to receive status, r2 - address of |
| (h/t) | r3, r4 | QBUF MSR, r3 - first memory address for data |
| | | to add to the queue, r4 - number of datum |
| | | values |
| qma.rem1.w | r1, r2 | r1 - register to receive datum from queue, r2 - |
| (h/t) | | address of QBUF MSR |
| qma.rem1.n | r1, r2, r3 | r1 - register to receive status, r2 - register to |
| (h/t) | | receive datum from queue, r3 - address of |
| | | QBUF MSR |
| qma.rem2.w | r1, r2, r3 | r1 - register to 1st datum, r2 - register to |
| (h/t) | | receive 2nd datum from queue, r3 - address of |
| | | QBUF MSR |
| qma.rem2.n | r1, r2, | r1 - register to receive status, r2 - register to |
| (h/t) | r3, r4 | receive first datum from queue, r3 - register to |
| | | receive 2nd datum from queue, r4 - address of |
| | | QBUF MSR |
| qma.remx.w | r1, r2, r3 | r1 - first memory address to receive data from |
| (h/t) | | queue, r2 - number of data values, r3 - address |
| | | of QBUF MSR |
| qma.remx.n | r1, r2, | r1 - register to receive status, r2 - first memory |
| (h/t) | r3, r4 | address to receive data from queue, r3 - number |
| | | of datum values, |
| | | r4 - address of QBUF MSR |

### QENG Initialization and Configuration

In some embodiments, each core of a multi-core system has an accompanying QENG that is the hardware for queue management. In some embodiments, each QENG has 8 independent threads that can be executed in parallel. However, threads can be designated for serial execution for synchronization purposes.

Software incurs a one-time programming penalty of initializing a queue by programming model-specific registers (MSRs) in the QENG to store, for example, a buffer size and a buffer address. The QENG then takes care of the overhead of keeping track of the number of valid queue entries, the head of the queue from which to pop a data entry, and the tail of the queue to which to add new data entries. In other words, once software initializes a queue, the ENG facilitates the book keeping associated with the queue.

Table 8 lists some software-accessible model-specific registers (MSRs) provided by the disclosed ISA to allow software to initialize and configure the QENG. In some embodiments, before starting any QENG operation, software must initialize a queue buffer by configuring MSRs within the QENG, including: programming QBUF with desired queue address, programming QSIZE with required queue size, and setting the enable bit (0th bit of QSTATUS). Setting of enable bit will configure head and tail pointers of the queue to point to the address in QBUF register. Any QBuffer is reset with writes to QBUF, QSIZE or enable bit. Current instructions for that queue will be drained without execution. Instructions that operate on a common QBuffer are processed in FIFO order with respect to the core issuing those instructions.

TABLE 8

| Name | Description |
|---|---|
| QSPEC | Read-only register for software that defines: version; |
| | available slots, max number of instructions, etc. |
| QBUF | Address field that sets a pointer to any valid memory |
| | region for buffer_0 |
| QSIZE | Data field which specifies the size in bytes of buffer_0 |
| QSTATUS | Status bitfield of buffer_0 |
| PC0 | Read-only register that sets the PC of the latest instruction |
| | tail; operates on buffer_0 |
| ADD0 | Read-only register that sets the latest memory address used |
| | by buffer_0 |
| QBUFn | Address field that sets a pointer to any valid memory |
| | region for buffer_n |
| QSIZEn | Data field which specifies the size in bytes of buffer_n |
| QSTATUSn | Status bitfield of buffer_n |
| PCn | Read-only register that sets the PC of the latest |
| | instruction to operate on buffer_n |
| ADDn | Read-only register that sets the latest memory address |
| | used by buffer_n |

### QENG Interrupts

The QENG supports interrupts for several QENG events. These include: detection of hardware failures, empty to non-empty QBuffer transitions, and non-empty to empty QBuffer transitions. These interrupts conditions can be enabled and dis-abled through stores to the MSR registers.

Since the QENG owns management of the software-provided memory region for queue data, and all QENG instructions operating on that buffer are sent to one specific QENG, the property of atomicity with queue add/remove operations is provided to software without requiring actual locks or other heavyweight operations on memory.

Additionally, in blocking operations, the QENG operations of add/remove will retry until there is sufficient free space or sufficient datums in the queue for success.

### Instruction Chaining for Strict Ordering

The disclosed instruction set architecture includes facilities to chain instructions when necessary to preserve strict ordering. In some disclosed embodiments, instructions included in the ISA are meant to be evicted from the main core pipeline, and to execute in the background. In operation, some instructions included and described herein are evicted from the main core pipeline and are executed by engines, such as the MENG, CENG, and QENG engines described throughout and with respect to FIG. 1. The MENG, CENG, and QENG engines thus execute disclosed functions in the background, allowing the core to continue doing useful work, and indicate where they are done, for example, by generating an interrupt or setting a status register that is polled by software.

In some embodiments, one or more of the MENG, CENG, and QENG engines are replicated and distributes in multiple locations in a processor core or system, and are to execute ISA instructions in the background, and concurrently. By design, asynchronous background operations have no ordering properties with respect to each other. Since there is no ordering within the system of message delivery for background operations, a newer operation may be visible before an older operation. This presents a problem to strict memory ordering.

To work around the limitation of ordering in a software-controlled device, “chains” for background operations are implemented and used by software where stricter ordering is needed. Each chain is internally serviced by hardware in strict FIFO order for all entries within that chain. A chain will be considered complete when the last operation in the chain is finished.

The disclosed ISA therefore includes a chain management unit (CMU), a software controlled process whereby asynchronous background operations can be serialized when needed. This amounts to hardware support for micro-thread instruction sequences, somewhat like user-level threads of restricted capabilities.

Rather than “locking a bus” or stalling a core, the concept of chains allows for software control over asynchronous background operations. Multiple chains may be serviced in parallel while internal elements of any chain are executed in FIFO order. This improves performance by allowing software to have the necessary control for correct program execution while allowing for background ops to execute without staling the core. One common use case would be an MPI message send, which is a series of DMA operations followed by a short notification event to the recipient, described as one chain. Multiple chains concurrently executing could represent multiple MPI events in flight.

Chains and the chain management unit (CMU) act as a sequence queue for all asynchronous background instructions, i.e., they keep track of all asynchronous operations and enforces ordering when needed. The CMU basically consists of a table which logs all background instructions which are to be executed and determines when they can be executed. When chain instructions are moved from the core front-end to the CMU, all register dependencies are resolved and the actual operand values are migrated, allowing for the core to continue primary processing while the chain is an off-load task for the CMU to manage directly.

According to disclosed embodiments, chained instructions are executed in the sequential order in which they get decoded. Before any chained instruction is executed, the instruction is stalled by the CMU until previous instructions in the same chain are done. Different chains can operate in parallel. A refinement to the chains-concept is that when background instructions are outside of a chain, they are automatically considered to be independent chains of length one and can be processed in parallel.

An advantage of these tools at the ISA level is enabling a programmer to create software that can reason about the visibility of when data can be observed by other agents in the system, whether for performance, correctness, resiliency, debugging, or other uses. As a non-limiting example, consider three cores, A, B, and Z, with A and B being in the same rack (different boards) while Z is in in a different rack, and both A and B operating on data housed at Z. When there is congestion between A and Z, but not A and B or B and Z, taking advantage of disclosed ISA extensions that explicitly provide or broadcast status that a store has “posted” to the final destination, which carries with it the implicit knowledge that no error occurred, allows software to reason about the visibility of data in the system as a whole—when it matters to software properties, for example by sending more stores to the same address or address range, expecting that those more stores will succeed. Enabling software to reason about the visibility of data may allow refinement of software assumptions on data consistency in relation to properties such as correctness, performance tuning, debugging, resiliency (knowing when to take a snapshot that is safe), etc.

There are five instructions, listed and described in Table 9, which have been implemented as part of the core ISA for the CMU.

TABLE 9

| Instruction(s) | Notes |
|---|---|
| chain.init r1, r2, | This begins a new chain. |
| decr_when_done, | R1 acts the retire address, and receives the |
| intrpt_when_done | CMU unique chain_id. |
| | R2 is memory address that gets atomically |
| | decremented by one if decr_when_done is high, |
| | else it is unchanged. |
| | The core is interrupted when the chain |
| | completes if instrpt_when_done is high. |
| chain.end | Closes the current chain and increments the |
| | chain_id |
| chain.poll r1, r2 | Polls the status of a chain. |
| | R1 is updated with the chain status. |
| | R2 has the chain_id to be polled. |
| chain.wait r1 | Stalls the core until a chain completes all its |
| | instructions R1 has the chain_id to be |
| | completed |
| chain.kill | Kills a chain. |
| | R1 has the chain_id to be killed. |

### Typical Behavior:

A chain is begun when a chain.init instruction is executed. Subsequently, all new background instructions are assumed to be part of the new chain. The chain is considered closed when a chain, end is executed. If a chain.init is executed before a chain.end, the current chain is closed and a new chain is started, as though a chain.end was issued just before the new chain.init.

To give software visibility into the status of a chain, chain.poll can be executed. This instruction will return a compound bitfield with the following fields and values: Bits 7:0=the status of the chain operation, defined as 0=not done, 1=done and 2=error encountered. Bits 15:8 are the count of current chains. Software can exert additional control over chains through chain.wait and chain.kill.

Cache Coherency Protocol with Forward/Owned State for Memory Access Reduction in Multicore CPU

For shared memory spaces within a shared coherency domain, when multiple cores are manipulating the same data set in their local caches, coherency protocols are used to manage the reading and writing of data. These protocols define states which determine a cache's response to a request either from its own associated core, or from other caches in the coherency domain. While useful for low-latency local storage, caches have a limitation in that read misses and line evictions require long-latency read/writes to higher level memory. Read/write accesses to higher level memory can incur a latency penalty that is orders of magnitude larger than the accesses time of the local cache. The occurrence of these events can hamper the performance of the cache. Instead, disclosed embodiments limit spurious memory accesses and maximize utilization of data passing between caches.

The disclosed cache coherency protocol implements a combination of the following states to ensure coherency, while attempting to minimize memory reads and writes: Modified (M—dirty, own core may read or write, no sharers), Owned (O—dirty, read-only, sharers exist), Forward (F—clean, read-only, sharers exist), Exclusive (E—clean, read-only, no sharers), Shared (S—may be clean or dirty, read-only, sharers exist), and Invalid (I).

The disclosed cache coherency protocol governs cache coherency is a coherency domain. For example, a coherency domain may include all four cores of a processor, such as cores 0-3 of processor 201, as illustrated in FIG. 2.

Disclosed embodiments enable cache-to-cache data sharing, which can yield significantly lower latency compared to accessing higher level memory. In some embodiments, a memory read miss to a first cache is serviced, instead of issuing a memory read, by any other cache in the coherency domain that has a copy of the data. The disclosed cache coherency protocol minimizes memory reads and writes in multiple ways. The benefits of servicing data requests from neighboring caches within a coherency domain can be achieved regardless of the topology or organization of caches and cores with in a system.

First, in some embodiments, memory writes are reduced because a write-back of dirty data is only required when a cache line is evicted from the M state to I state due to a local cache line replacement policy. In some embodiments, when a cache line moves from M state to 0 state, no writeback occurs. Rather, a write back in such a scenario would occur later. After no sharers of the dirty cache line exist, causing the cache line with 0 state ownership to revert to M state, the cache line will be written back once evicted from the cache with M state ownership.

Second, memory reads are reduced because existence of the F state allows there to be a single responder for read requests to a shared line. So, once a datum is read for the first time from memory, all subsequent read requests to that cache line will be serviced by data in one or more of several caches. Without the F state, in some scenarios, all caches having the cache line in S state invalidate the cache line and the requesting cache then reads the line from memory. Instead, in some embodiments, with the addition of the F state, only a single cache responds to remote read requests: providing the cache line from the F state if clean or from the 0 or M state if dirty. Additionally, the existence of the F state allows the caches in S state to ignore miss requests, saving energy and coherency network bandwidth.

Properly following this protocol results in at least the following improvements to cache performance and applied cache coherency protocols in the disclosed embodiments:
1. Exactly one cache responds to any given request. Improving the feasibility of using this protocol for any implementation (snoop bus, directory, etc.).
2. A minimum number (2) of memory access cases exist: (1) A read-miss when the cache line does not currently exist in the coherency domain, and (2) a write-back on eviction of a dirty cache-line in M state (See FIG. 12A). This results in a performance improvement over existing protocols.

FIG. 12A illustrates a state flow diagram for the disclosed cache coherency protocol, according to one embodiment. As shown, state flow diagram 1200 is for a (M.O.E.S.I+F). state machine, and includes Modified 1202, Owned 1204, Forward 1206, Exclusive 1208, Shared 1210, and Invalid 1212 states. Table 10 provides a legend describing the meaning of each of the arc labels of FIG. 12A.

As illustrated, solid arcs represent state changes that occur in response to a core associated with the cache, i.e., the cache's own core, for example, arc 1214 represents a core requesting an exclusive copy of a cache line, in response, perhaps, to a Read for Ownership request.

Dashed arcs, on the other hand, represent state changes that occur in response to external events, such as a coherency request (i.e., a request for an addressed cache line received from a remote cache or remote core within the coherency domain). For example, arc 1216 represents a remote core requesting a copy of a clean cache line in an exclusive state, whereby the cache line data is provided, and the cache line transitions from Exclusive to Forward state. In some embodiments, a coherency domain includes a subset of the caches in a computing system. Dashed arcs are also used to indicate a cache line being evicted (due, for example, to a cache line replacement policy) and transitioning from any cache state to the Invalid state, such as arc 1218.

TABLE 10

| Label | Meaning |
|---|---|
| GetM | A remote write request has been |
| | made for the cache line. |
| GetS | A remote read request has been |
| | made for the cache line. |
| Evict | Cache line will be evicted due to |
| | local cache line replacement. |
| WR | Local core has made a write |
| | request. |
| RD | Local core has made a RD request. |
| FloatM | Cache is the last to own a |
| | previously shared dirty line, |
| | transition to M state. |
| FloatE | Cache is the last to own a |
| | previously shared clean line, |
| | transition to E state. |
| FloatO | Sharing cache gets passed the O |
| | state. |
| FloatF | Sharing cache gets passed the F |
| | state. |
| SendM | A remote read request for cache in |
| | M state; send data, transition to O- |
| | state. |

### Cache State Transitions and Cache Line Data Movement

In operation, as illustrated by FIG. 12A, cache line data is shared among the caches, and the cache states transition, as follows:

From the Modified state 1202, when a cache receives a GetS, send the cache line data and transition to Owned. When the cache receives a GetM, send the cache line data and transition to Invalid. In some embodiments, when the cache line gets evicted, write back the cache line data and transition to Invalid. In some embodiments, when the cache line in M state gets evicted, the cache control circuit defers a memory write access by, rather than causing the modified data to be written back, copying the dirty cache line to an available M cache slot somewhere in the coherency domain.

From the Owned State 1204, when a cache receives a GetS, send the cache line data and remain in Owned state. When the cache receives a GetM, send the cache line data and transition to Invalid. When the cache line gets evicted with multiple sharers still existing, transfer ownership to one of the sharers, and cache line transitions to Invalid. When there is only one sharer, and that sharer gets evicted, leaving this cache line as the only instance of the dirty data in the coherency domain, transition cache line to Modified state (i.e. cache now has the only copy of modified cache line in coherency domain).

From the Forward State 1206, when a cache receives a GetS, send the cache line data, and state remains unchanged. When the cache receives a GetM, send the cache line data and transition to Invalid. When the cache line gets evicted and multiple sharers remain, cache control circuitry designates one of the multiple sharers as the new Forwarder, and cache line transitions to Invalid. But When the cache line gets evicted and only one sharer exists, cache control circuitry causes that sharer to transition cache line to Exclusive (i.e. sharer has only copy of clean data in the coherency domain), and cache line transitions to Invalid.

From the Exclusive State 1208, when a cache receives a GetS, send the cache line data and transition to Forward. When the cache receives a GetM, send the cache line data and transition to Invalid. When the cache line is evicted, transition to Invalid.

From the Shared State 1210, when a cache receives a WR from its own core, transition to Modified 1202 state. In some scenarios, a cache line in S state is valid and remains valid in the cache, but transitions to a different state.

For example, in some scenarios, e.g. a cache was a sharer of a dirty cache line that was in Owned state by another cache, but the cache line was evicted in that cache so cache line transitions to Owned if multiple sharers remain, or to Modified, if this is the only remaining sharer, cache control circuitry causes the cache to retain the dirty cache line, and transition to Owned state or to Modified state. Causing a cache to assume a role of Forwarder when the prior Forwarder is evicted is an example of “passing” state to the cache that becomes the new forwarder.

Similarly, in some scenarios, e.g. cache was a sharer of a clean cache line that was in Forward state in another cache, but the cache line was evicted in that cache so the cache line transitions to Forward if multiple sharers remain, and to Exclusive if no sharers remain), cache control circuitry causes the cache to retain the clean cache line, and transition to Owned state or Exclusive state.

From the Invalid State 1220, when an invalid cache receives a WR from its own core, transition to Modified 1202 state. When an invalid cache line receives a RD request from its own core, receive the cache line data and transition to Exclusive if the core requested ownership of the cache line, or to Exclusive if the RD requested ownership.

It should be noted that if a cache receives a RD from its own core to a valid cache line, that cache will provide the read data and remain in the same state, regardless of whether it is in M, O, E, or S.

It can be observed that in embodiments of the disclosed cache coherency protocol, as illustrated in FIG. 12A, the 0 state serves as the F state for dirty cache lines. All responses to remote read requests for shared data (GetS), will be handled by the 0 state (dirty) or the F state (clean).

### Controlling Cache State Transitions and Data Movement

In some embodiments, the cache state transitions illustrated in FIG. 12A and the data movements listed above are implemented and managed by a cache control circuit. Cache control circuit 215 in FIG. 2 is an example. FIG. 12B, however, illustrates a more detailed embodiment of a cache control circuit for implementing a cache coherency protocol as illustrated in FIG. 12A and as described above.

FIG. 12B illustrates an embodiment of a cache control circuit for implementing a cache coherency protocol as described herein. As shown, multicore computing system 1250 includes a data response network 1252, data caches D$0 1254, D$1 1256, D$2 1258, and D$3 1260, which, together, define a coherency domain. Each of the data caches has two sets of tags: tag 0 and tag 1, also referred to as ping and pong tags. Having two sets of tags allows each core to use one set of tags while the other set is being updated. Cache control circuit 1262 determines which of the sets of cache tags is valid at any given time.

As shown, cache control circuit 1262, includes shadow tag controller 1264 and shadow tag array 1266. In some embodiments, the shadow tag array contains duplicates of both sets, the ping and the pong, of cache tags inside each core. The shadow tag controller 1264 thus provides a central location to model and track all of the cache lines and their states. The cache control circuit, via shadow tag controller 1264, uses the shadow tag array 1266 to determine, for example, in the event of a cache line in Forward state getting evicted, which core should become the new Forwarder.

In operation, the shadow tag acts as a quasi-oracle in the sense that it knows more than local cores do, such as in a combination of MESI and GOLS (Globally Owned Locally Shared). De-duplication, compression, and encryption are all enabled by this approach in a straightforward way given the shadow tag system. The shadow tag will store extra state information that will not need to be held in the main arrays, saving area, power and latency. Since knowledge of the DRAM writeback is known within the shadow tag, it may also apply extra steps (de-duplicate, compress, encrypt) needing to be taken when the eventual writeback happens. Local cores operate on uncompressed/encrypted/duped data and are ignorant of all of this. This could be used to support a full-empty bit or meta-data marking, which includes pointer tracking transactional memory characteristics and poison bits.

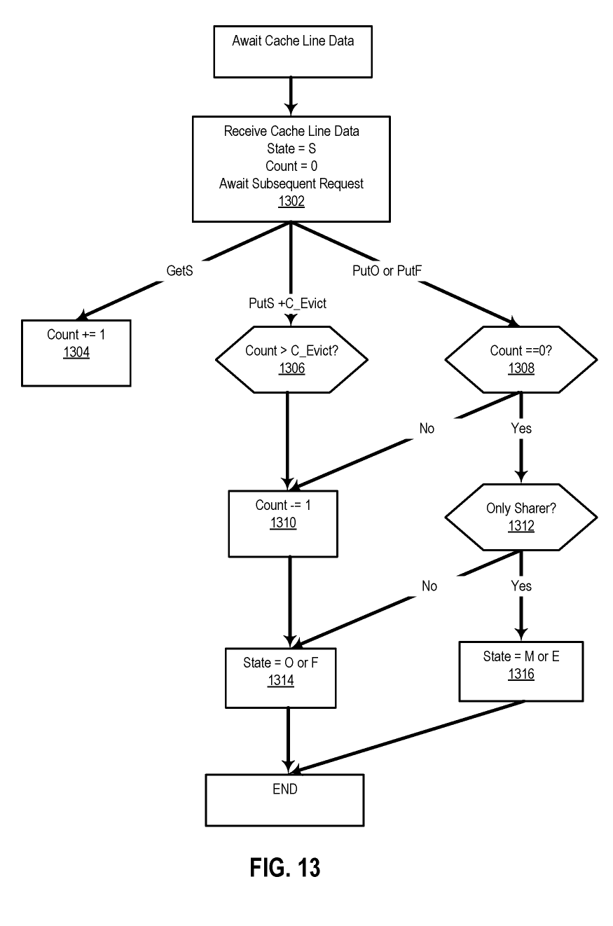

FIG. 13 is a flow diagram illustrating a process performed by cache control circuitry according to some embodiments. The cache control circuitry in some embodiments is part of a processor core. In some embodiments, one or more cache control circuits are disposed near and control one or more cache memories. The flow tracks which cache most recently entered the shared domain. By keeping a count for each cache line using n bits, where 2n is the total number of caches in the coherency domain, each cache control circuit can monitor when a cache line joined the shared coherency group for a cache line address.

As shown, cache control circuitry starts the flow by awaiting cache lie data. At 1302, a cache controlled by the cache control circuit receives cache line data, at which point the cache control circuitry sets the coherency state of that cache line to S, sets a count of requests for that cache line to 0, and awaits a subsequent request to the addressed cache line. At 1304, in response to receiving a GetS request to the addressed cache line, the cache control circuitry increments the count. At 1306, in response to receiving a PutS (S evict) in addition to the sender's order count (C_Evict) the cache control circuitry checks whether its count is greater than the sender's count (C_Evict), and, if so, decrements is count. Otherwise, it does nothing. At 1308, the cache control circuitry, in response to receiving a PutP (O evict) or PutF (Fevict) checks whether its count is zero when receiving the request, and, if so, at 1312 changes its state to O/F at 1314 or M/E at 1316E, depending on whether other S caches exist. And, if not, at 1310, the cache control circuitry decrements the count.

When a PutS (S evict) is sent, that cache's order count (C_Evict) is sent with it. All shared caches compare their count to the count received with the request, for example at 1306, and, if their count is higher, they decrement by 1, for example, at 1310. If lower, no change.

Different methods for monitoring the total number of S caches are possible, depending on the implementation choice. For a Snoop bus, when a cache receives a PutO or PutF req, it can respond on the bus (regardless of its count) signaling if it is S or not. Once the transitioning cache receives responses from all other caches, it will know which state to transition to. If a directory is used, a count of total S caches can be stored in the directory, with that count being checked each time a PutO/PutF is received.

### Switched Bus Fabric for Interconnecting Multiple Communicating Units

The disclosed instruction set architecture describes a switched bus fabric for interconnecting multiple communicating cores in the system. Implementing a system according to the disclosed instruction set architecture is made easier with a disclosed fabric to connect multiple cores together.

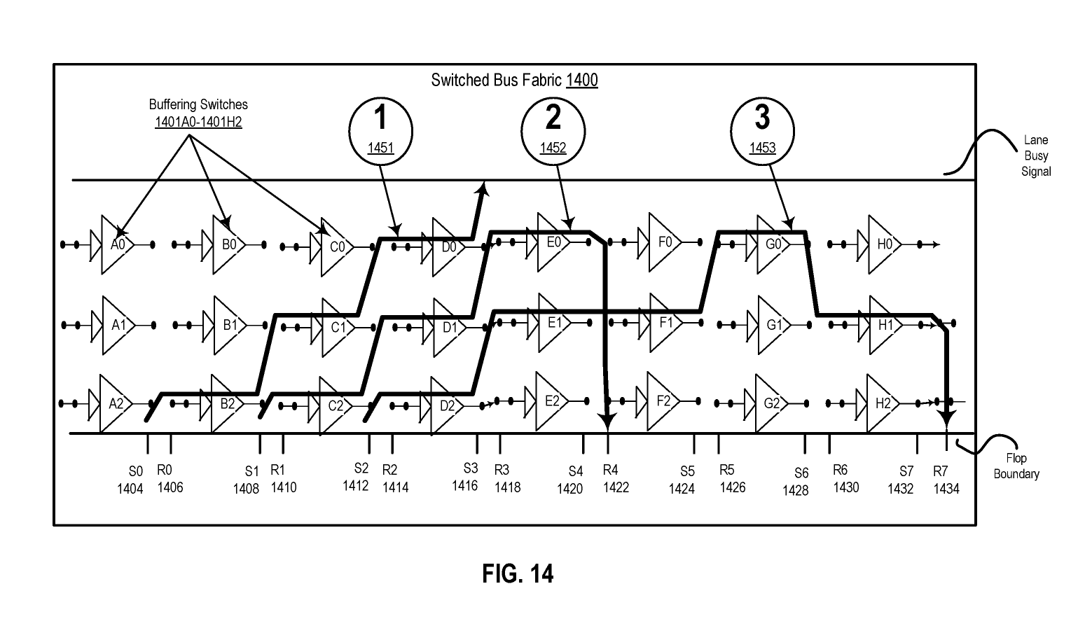

FIG. 14 is a diagram of a portion of a switched bus fabric for use with the disclosed instruction set architecture, according to an embodiment. As shown, switched bus fabric 1400 provides four parallel routes common to and to be used by eight sender ports, S0-S7. Switched bus fabric 1400 also provides multiple lanes and allows network traffic to switch lanes to improve performance, for example to avoid heavily congested routes. As shown, switched bus fabric 1400 includes buffering switches 1401A-1401H6, each of which is to monitor or measure the performance of the switch. Accordingly, switched bus fabric 1400 provides mechanisms to not only control the flow of packet traffic through it, but also to monitor route congestion, and to switch lanes to avoid congested routes.

As shown, switched bus fabric 1400 connects multiple communicating send and receive ports, with hardware units, cores, circuits, and engines intended to be connected via the ports. Switched bus fabric 1400 includes multiple buses—built out of repeatered interconnect buffering switches 1401A0-1401H3—used to span all communicating units. Here, a repeatered bus is shown with 4 lanes for illustration, though different embodiments may include different numbers of lanes. Integrated into switched bus fabric 1400 are eight send ports, S0-S7, and eight receive ports R0-R7. The eight send ports are shown as S0 1404, S1 1408, S2 1412, S3 1416, S4 1420, S5 1424, S6 1428, and S7 1432. The eight receive ports are shown as R0 1406, R1 1410, R2 1414, R3 1418, R4 1422, R5 1426, R6 1430, and R7 1434. In some embodiments, ports can consume outputs from any of the lanes. In some embodiments, the multiple communicating ports are on a same die.

### Clocks and Timing

All ports—included here by (Si, Ri)—are synchronized on a common clock. In on-die circuits this is the case. In the above example, without loss of generality, it is assumed that a clock boundary is no longer than crossing 5 elements. In other words, for a communicating pair Si to Rj, j has to be no greater than i+5.

All flop timing elements are below the line called “flop-boundary”. Note, the length of the repeatered bus is longer than one clock cycle.

### Informed Routing Selections

In operation, network traffic can switch lanes based on congestion, or in an attempt to minimize the number of hops between the source and the destination, or in an attempt to utilize network segments that provide a higher data rage. In some embodiments, each lane includes a back propagating signal (not shown which indicates whether a lane could connect to a valid output). If it is determined that a route is saturated, the route switches lanes. Or, when selecting a route in the first place, if the path to be traversed is congested, or has too many hops, or is too long, a different path is selected.

In operation, to decide what path to use when going from A to D, a path of A→B→D may be selected instead of a path of A→B→C→D, allowing a faster path with fewer hops. In some embodiments, the selected path depends on the length of the trip, not on contention.

Switched bus fabric 1400, according to some embodiments, has advantageous network properties. For example, in some embodiment, the switched bus fabric 1400 supports asynchronous messaging among the multiple cores in the network. Also, for example, switched bus fabric 1400 provides a common bus for use by not only the cores of a system, but also the CENG, MENG, and QENG engines, instances of which may be placed at various locations.

### On-Die Paths

The repeatered lanes have no flip-flops state elements. Only the forward path is shown.

### Multi-Cycle Paths

Signals traveling from a source to a destination within a single die take one clock cycle to complete. Disclosed switched fabrics implement a circuit switched network. In such embodiments, any two units can communicate at full data rate (one data element per clock) as long as they are within one clock separation of each other.

In some embodiments, multi-cycle paths exist for signals traversing from one die to another, where signals take longer than one clock cycle to reach their destinations. In such embodiments, the skew between the clocks on the two die is measured, and adjustments are made so that multiple transactions can exist on the wire at the same time. In such embodiments, output-side switches are configured to switch down anytime an output is consumed, preventing any further inputs to reach the output. A combinatorial kill signal send along with the main data ensures that false toggles do not propagate beyond the receive point.

### Exemplary Paths

FIG. 14 shows a set of exemplary paths, labeled as path 1 1451, path 2 1452, and path 3 1453, to illustrate operation of the switched fabric. At the beginning of clock (1), S0, S1, S2 all notice the top lane is free and start sending. The configuration shown causes S0 (path 1 1451) to run out of lanes. Back propagating signal on the path causes S0 to know at the next clock (clock (2)) that the send was swapped out so it continues sending prior data, i.e., it is blocked. A send from a port causes all input switches SWI to configure for a lanes switch. Path 2 1452 from S1 to R4 succeeds and will carry on transfers till data is completely sent. Note that S4 cannot start on clock(i) unless the S1 to R4 path indicates that it is the last send on clock(i−1) by exerting a tail bit. Path 3 1453 is the longest path and extends from S2 to R7. S3 and S5 both try to send to R6. Only one is serviced at a time (here S3 can be assumed blocked). The network does not block if the number of lanes is greater than the max single clock separation of number of units. With a maximum of 3 unit separation the network does not block if there are at least 3 lanes.

### Line-Speed Packet Hijack Mechanism for In-Situ Analysis, Modification, Rejection

The disclosed instruction set architecture includes a hijack unit, sometimes operating at line-speed, to allow live, real-time, in-situ analysis, modification, and rejection of packets. The basic premise is to install a fast, small priority address range check (PARC) circuit that monitors packets passing through a network interface, for example an ingress or an egress circuit, and determines whether to hijack a packet or sequence of packets for processing, or to not hijack and allow the packet to pass. In some embodiments, that determination is made by comparing packet addresses to a table listing address ranges to be hijacked. In some embodiments, the PARC circuit is placed proximal to a network egress or ingress point, so as to monitor packets passing by at line speed. In some embodiments, the PARC circuit includes a scratchpad memory to store hijacked packets to be processed. In some embodiments, the PARC circuit includes hijack execution circuitry to perform hijack processing. In some embodiments, the PARC circuit generates an interrupt to be serviced by a hijack interrupt service routine. The amount of processing performed by the hijack execution circuit is bounded by the line rate at which the circuit must operate, by latency requirements (i.e., the amount of hijack processing latency that can be tolerated), and by the depth of the scratchpad memory (the deeper the scratchpad memory, the more packets can be hijacked and processed). Upon completing the hijack processing, the hijack places the packet back onto the network, sometimes with a modified packet header.

In operation, once the hijack unit hijacks a packet, it enqueues the packet in a memory housing pending packets to be updated. In some embodiments, the hijack unit provides a trigger to hijack execution circuitry to indicate the presence of hijacked packets to be processed. In some embodiments, the hijack unit increments a count of packets to be processed, and the hijack execution circuitry decrements the count upon processing the packets.

In some embodiments, the hijack unit attempts to operate at line-speed, hijacking one or more packets, routing the one or more packets to a memory, for example a small, nearby, scratchpad memory, processes the one or more packets with an execution circuit, and optionally reinserts the packets, with or without modification, into the traffic flow. In some embodiments, the memory is a multi-banked memory with a separate execution circuit to process each of the banks in parallel. In some embodiments, a hijack circuit monitors packets passing through a network interface, such as a PCIe interface, and dynamically “hijacks” packets by pulling them off the ingress/egress line, routing them to a memory for processing, and then optionally re-injects the packets—with or without modification—to the original line.

### Exemplary Hijack Processing

The amount of processing that the hijack execution unit or software can accomplish is bounded only by the line rate of the data stream being hijacked, by required latency specifications, and how much scratchpad memory is available to hold hijacked packets for processing. Some examples of processing that can be accomplished by the hijack unit includes, without limitation, one or more of the following:

Software-Defined Networking (SDN): In some embodiments, the hijack unit can be used to implement and support a software-defined network. For example, packets associated with a particular network may be hijacked and rerouted to appropriate network clients.

Redirecting Packets: In some embodiments, when circuitry on a first die is passing packet(s) to a second die, the hijack unit hijacks the packet(s) and sends them to a different die. In some embodiments, when circuitry is passing packet(s) to a scratchpad (Spad), the hijack unit hijacks the packet(s) and sends them to a different Spad, for example in response to the first Spad being broken or deactivated or too busy. To do so, the hijack unit adjusts the address in flight and then allows it to proceed with access to the new Spad. In some embodiments, the hijack unit generates a fault or exception when a security function is triggered. In some embodiments, the hijack unit performs the security access control independently of an operating system.

Security Access Controls: In some embodiments, the hijack unit performs security features, such as preventing a packet from reaching a forbidden memory range. In some embodiments, the hijack unit accesses a table or other data structure that triggers desired security functionality for an address or range of addresses. In some embodiments, the hijack unit generates a fault or exception when a security function is triggered. In some embodiments, the hijack unit performs the security access control independently of an operating system. In some embodiments, the hijack unit hijacks and processes a packet unbeknownst to a sender of the packet(s).

Inject Information: In some embodiments, the hijack unit injects information into packets, with or without a sender's knowledge. In some embodiments, the hijack unit injects security information into a flow of packets, such as a sender ID, an access key, and/or an encrypted password.

Address manipulation: In some embodiments, the hijack unit controls access to give an appearance that multiple, disparate memories, are contiguous. For example, multiple, disparate scratchpad memories can be mapped to a contiguous range of logical addresses.

FIG. 15 is a block diagram showing a hijack unit, according to some embodiments. As shown, scratchpad memory 1500 contains eight banks of memory within scratchpad memory 1500: bank0 1520, bank1 1522, bank2 1524, bank3 1526, bank4 1528, bank5 1530, bank6 1532, and bank7 1534. Bank9 1536 is also included and communicates with hijack unit input/output interface 1536. In some embodiments, scratchpad memory 1500 is in a SRAM memory. In some embodiments, scratchpad memory 1500 has its own dedicated, SRAM memory. In some embodiments, scratchpad memory 1500 has a different number of banks, without limitation, such as 1, 2, 4, 16, or more.

Also included are eight execution engines, XE0 1502, XE1 1504, XE2 1506, XE3 1508, XE4 1510, XE5 1512, XE6 1514, and XE7 1516. Each of the execution engines includes an arithmetic-logic unit (ALU) or similar circuitry to execute an operation on a hijacked packet(s). Each execution engine further optionally has access to an L1 instruction cache (L1I$), an L1 data cache (L1D$), and an L1 scratchpad memory (L1Spad). In some embodiments a hijack execution engine uses portions of a shared memory for its L1D$, L1I$, and L1Spad. Optional components are indicated with dashed borders. As shown, each of the eight execution engines processes packets in a different bank of scratchpad memory 1500.

Also included, according to some embodiments, is hijack unit input/output (I/O) interface 1538, which monitors packets passing on network 1540. In some embodiments, hijack unit I/O interface 1538 analyzes each network packet by using a target hijack address, a target address mask, and a hijack valid bit to determine whether to hijack or to not hijack a monitored packet. In some embodiments, hijack unit I/O interface 1538, upon determining that one or more packets is to be processed by hijack execution circuitry, passes the one or more packets to one of hijack execution engine corresponding to the bank of memory in which the hijacked packet resides.

In some embodiments, each of the execution engines 1502-1516 processes packets stored in corresponding banks of scratchpad memory 1500. In some embodiments, each of the execution engines 1502-1516 fetches, decodes, and executes machine-readable instructions store in an instruction storage, such as the L1I$ associated with the execution unit.

In some embodiments, one of the eight execution units is responsible for monitoring traffic, determining packets to hijack, hijacking the packets, storing the packets to memory, then kicking the hijack execution circuits to process hijacked packets concurrently. By using seven of the eight hijack execution units, the circuit may be able to perform the necessary hijack processing on the hijacked packets, and performs the processing within a predefined latency maximum.

The disclosed hijack unit, as described above, selects and hijacks packets live and at line speed from the traffic flow, buffers those packets into a hijacked packet buffer, performs hijack processing on those packets, then reinserts them into the traffic flow, possibly with an updated header or routing information. For the hijack unit to keep up with the line rate, it must perform its processing within the amount of time allowed by a latency budget of the traffic flow. The higher latency that can be tolerated, the more processing the can be performed. The amount of packets that can be hijacked for processing is also limited by the depth of the hijacked packet buffer. In some embodiments, the hijack unit monitors and measures the latency introduced by its hijack processing, and accordingly adjusts the rate at which it hijacks packets to process.

It should be noted that in some embodiments, the fact that one or more packets were hijacked from a traffic flow, processed, and re-inserted into the flow occurs without involvement by the operating system, and not visible to an operator of the computing system. In some embodiments, the hijack unit injects a nominal amount of latency into one, or more, or all packets that are not hijacked, to prevent detection of the hijacking by measuring the slight latency injected by the hijack processing. In some embodiments, the hijack unit monitors and measures the amount of latency introduced by the hijack processing, and inserts that amount of latency into packets that are not hijacked. In some embodiments, the hijack unit does not attempt to conceal its hijacking, and updates one or more packet headers to reflect the fact that they were hijacked, before reinserting them into the traffic flow.

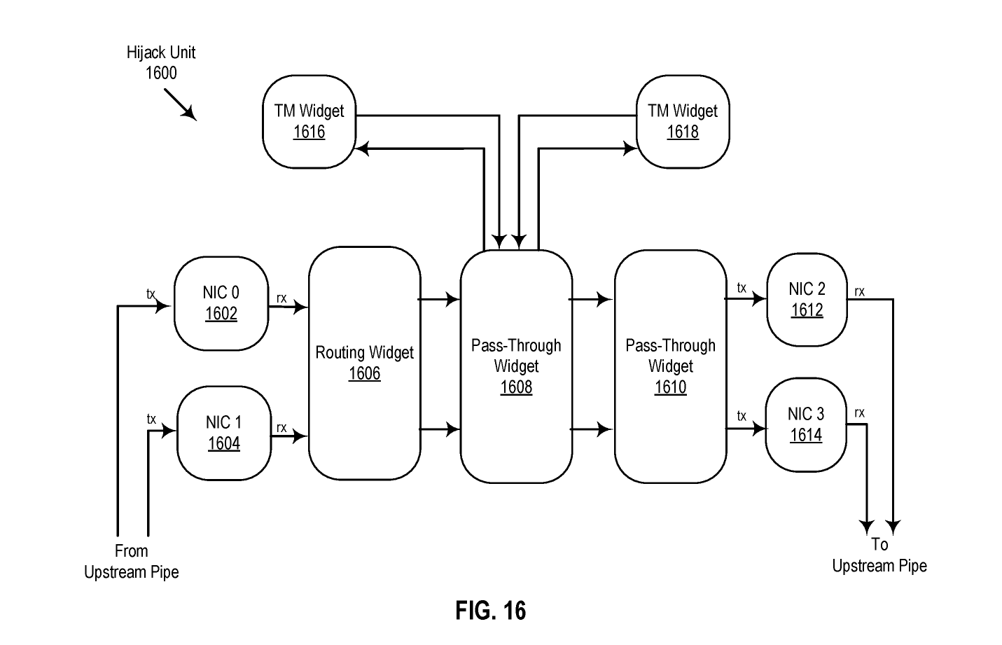

FIG. 16 is a block diagram illustrating a hijack unit, according to some embodiments. As shown, hijack unit 1600 includes two network interfaces, NIC0 1602 and NIC1 1604, to receive packets from an upstream pipe, and two network interfaces, NIC2 1612 and NIC3 1614, to transmit packets to the upstream pipe. Hijack unit 1600 also includes routing widget 1606, pass-through widget 1608 and pass-through widget 1610. Pass through widget 1608 is also coupled to send and receive packets to TM widget 1616 and TM widget 1618. In some embodiments, network interfaces NIC0 1602, NIC1 1405, NIC2 1612, and NIC3 1413 are incorporated within a processor.

In operation, TM widgets 1616 and 1618 monitor traffic passing by through pass-through widget 1608. In some embodiments, the ingress and egress are the interface to the core. In some embodiments, TM widgets 1616 and 1618 reference a hijack table listing address ranges of hijacking interest, and compare the source and destination addresses of packets passing by to the table. In some embodiments, TM widgets 1616 and 1618 conduct deep packet inspection to inspect the data portion as well as the header information of packets passing by to determine whether to hijack a packet, sometimes based on a comparison to the hijack table. When a packet to be hijacked is found, it is enqueued in a scratchpad memory structure at line speed. Hijack execution circuitry or software then processes the enqueued instructions.

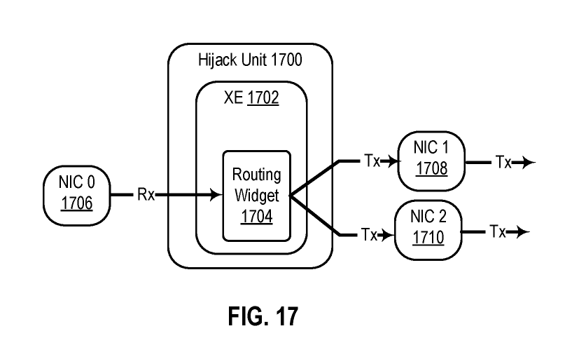

FIG. 17 is a block diagram illustrating a single execution block of a hijack unit, according to some embodiments. As shown, hijack unit 1700 includes execution engine (XE 1702) and routing widget 1704. Hijack unit 1700 is also shown coupled to an ingress network interface, NIC 0 1706, over which data packets are received, and two egress networks, NIC 1 1708 and NIC 2 1710, over which data packets are transmitted.

In operation, hijack unit 1700 monitors packets received from NIC 0 1706, selects packets to hijack. The selection in some embodiments results from a deep packet inspection of packet data and headers, and comparison to a hijack table specifying criteria for hijacking a packet. Execution engine XE 1702 then processes the buffered, hijacked packets. Finally, routing widget 1704 places the hijacked packets back into the flow of traffic using one of the egress network interfaces, NIC 1 1708 and NIC 2 1710.

### Instruction Sets

An instruction set may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or subformats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. A set of SIMD extensions referred to as the Advanced Vector Extensions (AVX) (AVX1 and AVX2) and using the Vector Extensions (VEX) coding scheme has been released and/or published (e.g., see Intel® 64 and IA-32 Architectures Software Developer's Manual, September 2014; and see Intel® Advanced Vector Extensions Programming Reference, October 2014).

### Exemplary Instruction Formats

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

### Generic Vector Friendly Instruction Format

A vector friendly instruction format is an instruction format that is suited for vector instructions (e.g., there are certain fields specific to vector operations). While embodiments are described in which both vector and scalar operations are supported through the vector friendly instruction format, alternative embodiments use only vector operations the vector friendly instruction format.

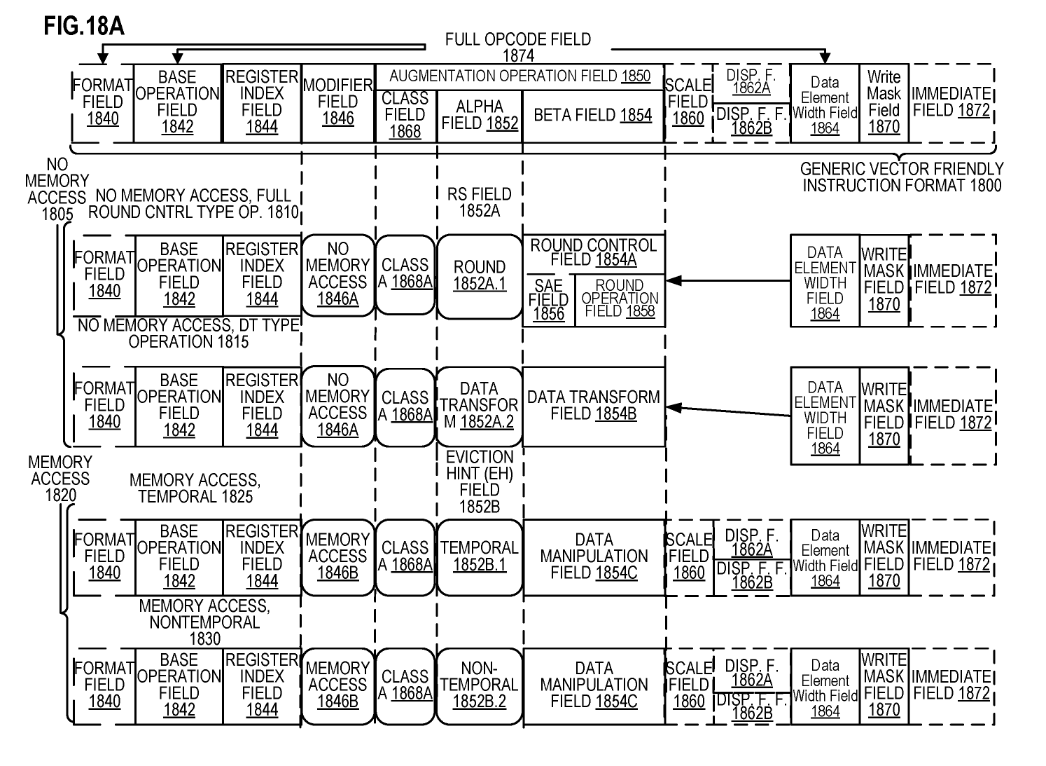

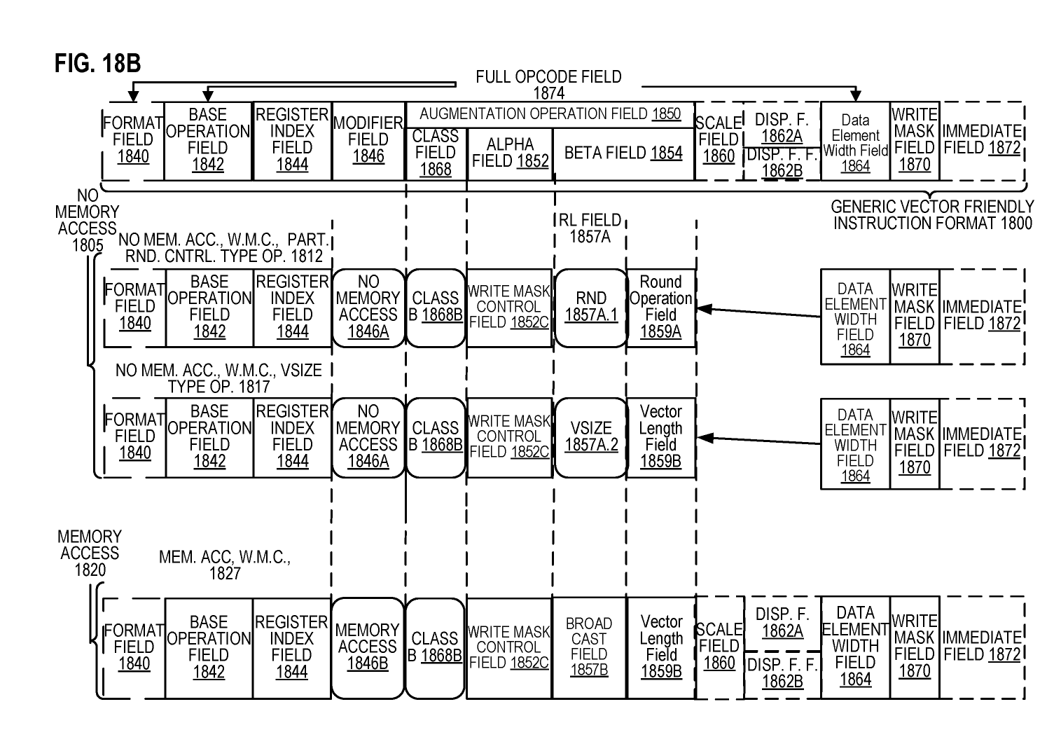

FIGS. 18A-18B are block diagrams illustrating a generic vector friendly instruction format and instruction templates thereof according to embodiments of the invention. FIG. 18A is a block diagram illustrating a generic vector friendly instruction format and class A instruction templates thereof according to embodiments of the invention; while FIG. 18B is a block diagram illustrating the generic vector friendly instruction format and class B instruction templates thereof according to embodiments of the invention. Specifically, a generic vector friendly instruction format 1800 for which are defined class A and class B instruction templates, both of which include no memory access 1805 instruction templates and memory access 1820 instruction templates. The term generic in the context of the vector friendly instruction format refers to the instruction format not being tied to any specific instruction set.

While embodiments of the invention will be described in which the vector friendly instruction format supports the following: a 64 byte vector operand length (or size) with 32 bit (4 byte) or 64 bit (8 byte) data element widths (or sizes) (and thus, a 64 byte vector consists of either 16 doubleword-size elements or alternatively, 8 quadword-size elements); a 64 byte vector operand length (or size) with 16 bit (2 byte) or 8 bit (1 byte) data element widths (or sizes); a 32 byte vector operand length (or size) with 32 bit (4 byte), 64 bit (8 byte), 16 bit (2 byte), or 8 bit (1 byte) data element widths (or sizes); and a 16 byte vector operand length (or size) with 32 bit (4 byte), 64 bit (8 byte), 16 bit (2 byte), or 8 bit (1 byte) data element widths (or sizes); alternative embodiments may support more, less and/or different vector operand sizes (e.g., 256 byte vector operands) with more, less, or different data element widths (e.g., 128 bit (16 byte) data element widths).

The class A instruction templates in FIG. 18A include: 1) within the no memory access 1805 instruction templates there is shown a no memory access, full round control type operation 1810 instruction template and a no memory access, data transform type operation 1815 instruction template; and 2) within the memory access 1820 instruction templates there is shown a memory access, temporal 1825 instruction template and a memory access, non-temporal 1830 instruction template. The class B instruction templates in FIG. 18B include: 1) within the no memory access 1805 instruction templates there is shown a no memory access, write mask control, partial round control type operation 1812 instruction template and a no memory access, write mask control, vsize type operation 1817 instruction template; and 2) within the memory access 1820 instruction templates there is shown a memory access, write mask control 1827 instruction template.

The generic vector friendly instruction format 1800 includes the following fields listed below in the order illustrated in FIGS. 18A-18B.

Format field 1840—a specific value (an instruction format identifier value) in this field uniquely identifies the vector friendly instruction format, and thus occurrences of instructions in the vector friendly instruction format in instruction streams. As such, this field is optional in the sense that it is not needed for an instruction set that has only the generic vector friendly instruction format.

Base operation field 1842—its content distinguishes different base operations.

Register index field 1844—its content, directly or through address generation, specifies the locations of the source and destination operands, be they in registers or in memory. These include a sufficient number of bits to select N registers from a PxQ (e.g. 32×512, 16×128, 32×1024, 64×1024) register file. While in one embodiment N may be up to three sources and one destination register, alternative embodiments may support more or less sources and destination registers (e.g., may support up to two sources where one of these sources also acts as the destination, may support up to three sources where one of these sources also acts as the destination, may support up to two sources and one destination).

Modifier field 1846—its content distinguishes occurrences of instructions in the generic vector instruction format that specify memory access from those that do not; that is, between no memory access 1805 instruction templates and memory access 1820 instruction templates. Memory access operations read and/or write to the memory hierarchy (in some cases specifying the source and/or destination addresses using values in registers), while non-memory access operations do not (e.g., the source and destinations are registers). While in one embodiment this field also selects between three different ways to perform memory address calculations, alternative embodiments may support more, less, or different ways to perform memory address calculations. Augmentation operation field 1850—its content distinguishes which one of a variety of different operations to be performed in addition to the base operation. This field is context specific. In one embodiment of the invention, this field is divided into a class field 1868, an alpha field 1852, and a beta field 1854. The augmentation operation field 1850 allows common groups of operations to be performed in a single instruction rather than 2, 3, or 4 instructions.

Scale field 1860—its content allows for the scaling of the index field's content for memory address generation (e.g., for address generation that uses 2^{scale}*index+base).

Displacement Field 1862A—its content is used as part of memory address generation (e.g., for address generation that uses 2^{scale}*index+base+displacement).

Displacement Factor Field 1862B (note that the juxtaposition of displacement field 1862A directly over displacement factor field 1862B indicates one or the other is used)—its content is used as part of address generation; it specifies a displacement factor that is to be scaled by the size of a memory access (N)—where N is the number of bytes in the memory access (e.g., for address generation that uses 2^{scale}*index+base+scaled displacement). Redundant low-order bits are ignored and hence, the displacement factor field's content is multiplied by the memory operands total size (N) in order to generate the final displacement to be used in calculating an effective address. The value of N is determined by the processor hardware at runtime based on the full opcode field 1874 (described later herein) and the data manipulation field 1854C. The displacement field 1862A and the displacement factor field 1862B are optional in the sense that they are not used for the no memory access 1805 instruction templates and/or different embodiments may implement only one or none of the two.

Data element width field 1864—its content distinguishes which one of a number of data element widths is to be used (in some embodiments for all instructions; in other embodiments for only some of the instructions). This field is optional in the sense that it is not needed if only one data element width is supported and/or data element widths are supported using some aspect of the opcodes.

Write mask field 1870—its content controls, on a per data element position basis, whether that data element position in the destination vector operand reflects the result of the base operation and augmentation operation. Class A instruction templates support merging-writemasking, while class B instruction templates support both merging- and zeroing-writemasking. When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the write mask field 1870 allows for partial vector operations, including loads, stores, arithmetic, logical, etc. While embodiments of the invention are described in which the write mask field's 1870 content selects one of a number of write mask registers that contains the write mask to be used (and thus the write mask field's 1870 content indirectly identifies that masking to be performed), alternative embodiments instead or additional allow the mask write field's 1870 content to directly specify the masking to be performed.

Immediate field 1872—its content allows for the specification of an immediate. This field is optional in the sense that is it not present in an implementation of the generic vector friendly format that does not support immediate and it is not present in instructions that do not use an immediate.

Class field 1868—its content distinguishes between different classes of instructions. With reference to FIGS. 18A-B, the contents of this field select between class A and class B instructions. In FIGS. 18A-B, rounded corner squares are used to indicate a specific value is present in a field (e.g., class A 1868A and class B 1868B for the class field 1868 respectively in FIGS. 18A-B).

### Instruction Templates of Class A

In the case of the non-memory access 1805 instruction templates of class A, the alpha field 1852 is interpreted as an RS field 1852A, whose content distinguishes which one of the different augmentation operation types are to be performed (e.g., round 1852A.1 and data transform 1852A.2 are respectively specified for the no memory access, round type operation 1810 and the no memory access, data transform type operation 1815 instruction templates), while the beta field 1854 distinguishes which of the operations of the specified type is to be performed. In the no memory access 1805 instruction templates, the scale field 1860, the displacement field 1862A, and the displacement scale filed 1862B are not present.

### No-Memory Access Instruction Templates—Full Round Control Type Operation

In the no memory access full round control type operation 1810 instruction template, the beta field 1854 is interpreted as a round control field 1854A, whose content(s) provide static rounding. While in the described embodiments of the invention the round control field 1854A includes a suppress all floating point exceptions (SAE) field 1856 and a round operation control field 1858, alternative embodiments may support may encode both these concepts into the same field or only have one or the other of these concepts/fields (e.g., may have only the round operation control field 1858).

SAE field 1856—its content distinguishes whether or not to disable the exception event reporting; when the SAE field's 1856 content indicates suppression is enabled, a given instruction does not report any kind of floating-point exception flag and does not raise any floating point exception handler.

Round operation control field 1858—its content distinguishes which one of a group of rounding operations to perform (e.g., Round-up, Round-down, Round-towards-zero and Round-to-nearest). Thus, the round operation control field 1858 allows for the changing of the rounding mode on a per instruction basis. In one embodiment of the invention where a processor includes a control register for specifying rounding modes, the round operation control field's 1850 content overrides that register value.

### No Memory Access Instruction Templates—Data Transform Type Operation

In the no memory access data transform type operation 1815 instruction template, the beta field 1854 is interpreted as a data transform field 1854B, whose content distinguishes which one of a number of data transforms is to be performed (e.g., no data transform, swizzle, broadcast).

In the case of a memory access 1820 instruction template of class A, the alpha field 1852 is interpreted as an eviction hint field 1852B, whose content distinguishes which one of the eviction hints is to be used (in FIG. 18A, temporal 1852B.1 and non-temporal 1852B.2 are respectively specified for the memory access, temporal 1825 instruction template and the memory access, non-temporal 1830 instruction template), while the beta field 1854 is interpreted as a data manipulation field 1854C, whose content distinguishes which one of a number of data manipulation operations (also known as primitives) is to be performed (e.g., no manipulation; broadcast; up conversion of a source; and down conversion of a destination). The memory access 1820 instruction templates include the scale field 1860, and optionally the displacement field 1862A or the displacement scale field 1862B.

Vector memory instructions perform vector loads from and vector stores to memory, with conversion support. As with regular vector instructions, vector memory instructions transfer data from/to memory in a data element-wise fashion, with the elements that are actually transferred is dictated by the contents of the vector mask that is selected as the write mask.

### Memory Access Instruction Templates—Temporal

Temporal data is data likely to be reused soon enough to benefit from caching. This is, however, a hint, and different processors may implement it in different ways, including ignoring the hint entirely.

### Memory Access Instruction Templates—Non-Temporal

Non-temporal data is data unlikely to be reused soon enough to benefit from caching in the 1st-level cache and should be given priority for eviction. This is, however, a hint, and different processors may implement it in different ways, including ignoring the hint entirely.

### Instruction Templates of Class B

In the case of the instruction templates of class B, the alpha field 1852 is interpreted as a write mask control (Z) field 1852C, whose content distinguishes whether the write masking controlled by the write mask field 1870 should be a merging or a zeroing.

In the case of the non-memory access 1805 instruction templates of class B, part of the beta field 1854 is interpreted as an RL field 1857A, whose content distinguishes which one of the different augmentation operation types are to be performed (e.g., round 1857A.1 and vector length (VSIZE) 1857A.2 are respectively specified for the no memory access, write mask control, partial round control type operation 1812 instruction template and the no memory access, write mask control, VSIZE type operation 1817 instruction template), while the rest of the beta field 1854 distinguishes which of the operations of the specified type is to be performed. In the no memory access 1805 instruction templates, the scale field 1860, the displacement field 1862A, and the displacement scale filed 1862B are not present.

In the no memory access, write mask control, partial round control type operation 1810 instruction template, the rest of the beta field 1854 is interpreted as a round operation field 1859A and exception event reporting is disabled (a given instruction does not report any kind of floating-point exception flag and does not raise any floating point exception handler).

Round operation control field 1859A—just as round operation control field 1858, its content distinguishes which one of a group of rounding operations to perform (e.g., Round-up, Round-down, Round-towards-zero and Round-to-nearest). Thus, the round operation control field 1859A allows for the changing of the rounding mode on a per instruction basis. In one embodiment of the invention where a processor includes a control register for specifying rounding modes, the round operation control field's 1850 content overrides that register value.

In the no memory access, write mask control, VSIZE type operation 1817 instruction template, the rest of the beta field 1854 is interpreted as a vector length field 1859B, whose content distinguishes which one of a number of data vector lengths is to be performed on (e.g., 128, 256, or 512 byte).

In the case of a memory access 1820 instruction template of class B, part of the beta field 1854 is interpreted as a broadcast field 1857B, whose content distinguishes whether or not the broadcast type data manipulation operation is to be performed, while the rest of the beta field 1854 is interpreted the vector length field 1859B. The memory access 1820 instruction templates include the scale field 1860, and optionally the displacement field 1862A or the displacement scale field 1862B.

With regard to the generic vector friendly instruction format 1800, a full opcode field 1874 is shown including the format field 1840, the base operation field 1842, and the data element width field 1864. While one embodiment is shown where the full opcode field 1874 includes all of these fields, the full opcode field 1874 includes less than all of these fields in embodiments that do not support all of them. The full opcode field 1874 provides the operation code (opcode).

The augmentation operation field 1850, the data element width field 1864, and the write mask field 1870 allow these features to be specified on a per instruction basis in the generic vector friendly instruction format.

The combination of write mask field and data element width field create typed instructions in that they allow the mask to be applied based on different data element widths.

The various instruction templates found within class A and class B are beneficial in different situations. In some embodiments of the invention, different processors or different cores within a processor may support only class A, only class B, or both classes. For instance, a high performance general purpose out-of-order core intended for general-purpose computing may support only class B, a core intended primarily for graphics and/or scientific (throughput) computing may support only class A, and a core intended for both may support both (of course, a core that has some mix of templates and instructions from both classes but not all templates and instructions from both classes is within the purview of the invention). Also, a single processor may include multiple cores, all of which support the same class or in which different cores support different class. For instance, in a processor with separate graphics and general purpose cores, one of the graphics cores intended primarily for graphics and/or scientific computing may support only class A, while one or more of the general purpose cores may be high performance general purpose cores with out of order execution and register renaming intended for general-purpose computing that support only class B. Another processor that does not have a separate graphics core, may include one more general purpose in-order or out-of-order cores that support both class A and class B. Of course, features from one class may also be implement in the other class in different embodiments of the invention. Programs written in a high level language would be put (e.g., just in time compiled or statically compiled) into an variety of different executable forms, including: 1) a form having only instructions of the class(es) supported by the target processor for execution; or 2) a form having alternative routines written using different combinations of the instructions of all classes and having control flow code that selects the routines to execute based on the instructions supported by the processor which is currently executing the code.

### Exemplary Specific Vector Friendly Instruction Format

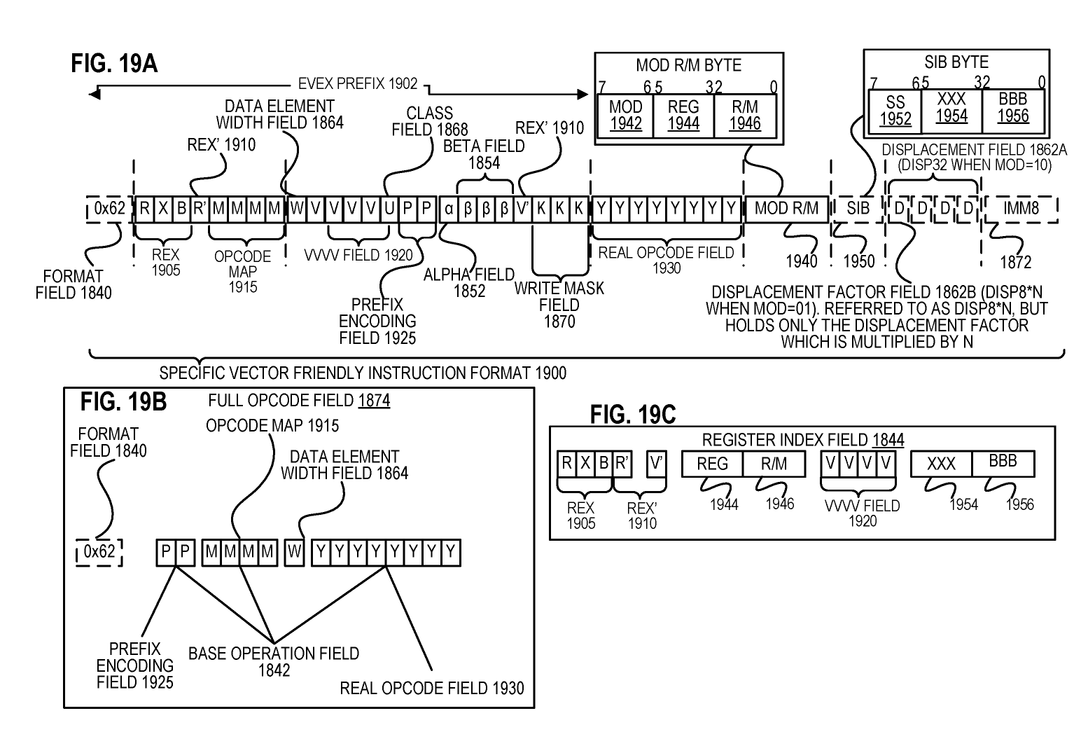

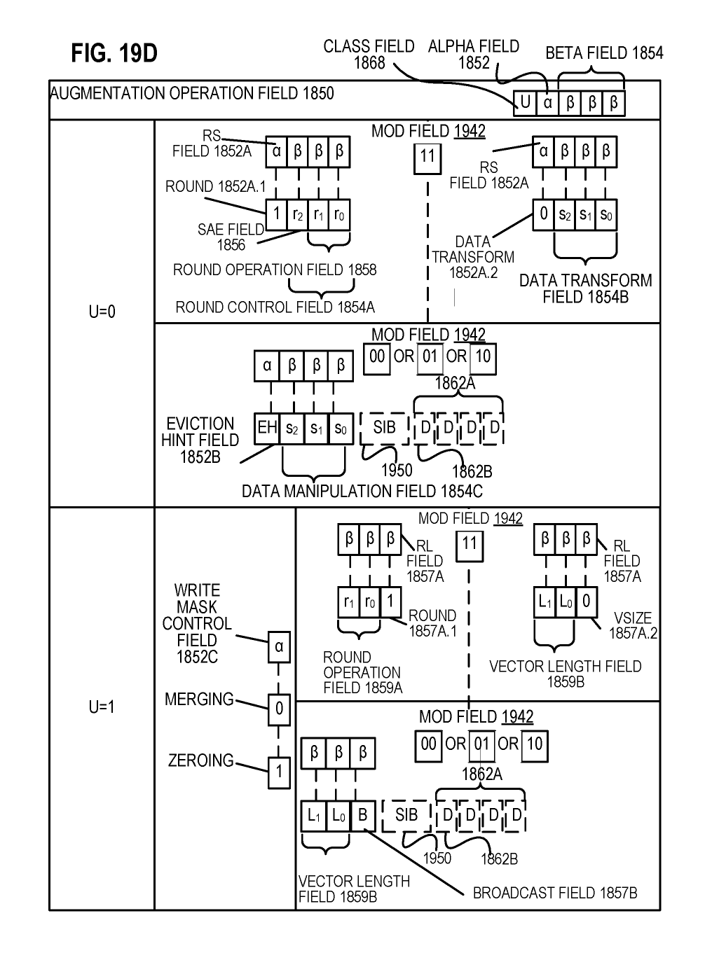

FIG. 19A is a block diagram illustrating an exemplary specific vector friendly instruction format according to embodiments of the invention. FIG. 19A shows a specific vector friendly instruction format 1900 that is specific in the sense that it specifies the location, size, interpretation, and order of the fields, as well as values for some of those fields. The specific vector friendly instruction format 1900 may be used to extend the x86 instruction set, and thus some of the fields are similar or the same as those used in the existing x86 instruction set and extension thereof (e.g., AVX). This format remains consistent with the prefix encoding field, real opcode byte field, MOD RIM field, SIB field, displacement field, and immediate fields of the existing x86 instruction set with extensions. The fields from FIGS. 18A-B into which the fields from FIG. 19A map are illustrated.

It should be understood that, although embodiments of the invention are described with reference to the specific vector friendly instruction format 1900 in the context of the generic vector friendly instruction format 1800 for illustrative purposes, the invention is not limited to the specific vector friendly instruction format 1900 except where claimed. For example, the generic vector friendly instruction format 1800 contemplates a variety of possible sizes for the various fields, while the specific vector friendly instruction format 1900 is shown as having fields of specific sizes. By way of specific example, while the data element width field 1864 is illustrated as a one bit field in the specific vector friendly instruction format 1900, the invention is not so limited (that is, the generic vector friendly instruction format 1800 contemplates other sizes of the data element width field 1864).

The generic vector friendly instruction format 1800 includes the following fields listed below in the order illustrated in FIG. 19A.

EVEX Prefix (Bytes 0-3) 1902—is encoded in a four-byte form.

Format Field 1840 (EVEX Byte 0, bits [7:0])—the first byte (EVEX Byte 0) is the format field 1840 and it contains 0x62 (the unique value used for distinguishing the vector friendly instruction format in one embodiment of the invention).

The second-fourth bytes (EVEX Bytes 1-3) include a number of bit fields providing specific capability.

REX field 1905 (EVEX Byte 1, bits [7-5])—consists of a EVEX.R bit field (EVEX Byte 1, bit [7]—R), EVEX.X bit field (EVEX byte 1, bit [6]—X), and 1857BEX byte 1, bit[5]—B). The EVEX.R, EVEX.X, and EVEX.B bit fields provide the same functionality as the corresponding VEX bit fields, and are encoded using 1s complement form, i.e. ZMM0 is encoded as 1111B, ZMM15 is encoded as 0000B. Other fields of the instructions encode the lower three bits of the register indexes as is known in the art (rrr, xxx, and bbb), so that Rrrr, Xxxx, and Bbbb may be formed by adding EVEX.R, EVEX.X, and EVEX.B.

REX′ field 1810—this is the first part of the REX′ field 1810 and is the EVEX.R′ bit field (EVEX Byte 1, bit [4]—R′) that is used to encode either the upper 16 or lower 16 of the extended 32 register set. In one embodiment of the invention, this bit, along with others as indicated below, is stored in bit inverted format to distinguish (in the well-known x86 32-bit mode) from the BOUND instruction, whose real opcode byte is 62, but does not accept in the MOD R/M field (described below) the value of 11 in the MOD field; alternative embodiments of the invention do not store this and the other indicated bits below in the inverted format. A value of 1 is used to encode the lower 16 registers. In other words, R′Rrrr is formed by combining EVEX.R′, EVEX.R, and the other RRR from other fields.

Opcode map field 1915 (EVEX byte 1, bits [3:0]—mmmm)—its content encodes an implied leading opcode byte (0F, 0F 38, or 0F 3).

Data element width field 1864 (EVEX byte 2, bit [7]—W)—is represented by the notation EVEX.W. EVEX.W is used to define the granularity (size) of the datatype (either 32-bit data elements or 64-bit data elements).

EVEX.vvvv 1920 (EVEX Byte 2, bits [6:3]-vvvv)—the role of EVEX.vvvv may include the following: 1) EVEX.vvvv encodes the first source register operand, specified in inverted (1s complement) form and is valid for instructions with 2 or more source operands; 2) EVEX.vvvv encodes the destination register operand, specified in 1s complement form for certain vector shifts; or 3) EVEX.vvvv does not encode any operand, the field is reserved and should contain 1111b. Thus, EVEX.vvvv field 1920 encodes the 4 low-order bits of the first source register specifier stored in inverted (1s complement) form. Depending on the instruction, an extra different EVEX bit field is used to extend the specifier size to 32 registers.

EVEX.0 1868 Class field (EVEX byte 2, bit [2]-U)—If EVEX.0=0, it indicates class A or EVEX.U0; if EVEX.0=1, it indicates class B or EVEX.U1.

Prefix encoding field 1925 (EVEX byte 2, bits [1:0]-pp)—provides additional bits for the base operation field. In addition to providing support for the legacy SSE instructions in the EVEX prefix format, this also has the benefit of compacting the SIMD prefix (rather than requiring a byte to express the SIMD prefix, the EVEX prefix requires only 2 bits). In one embodiment, to support legacy SSE instructions that use a SIMD prefix (66H, F2H, F3H) in both the legacy format and in the EVEX prefix format, these legacy SIMD prefixes are encoded into the SIMD prefix encoding field; and at runtime are expanded into the legacy SIMD prefix prior to being provided to the decoder's PLA (so the PLA can execute both the legacy and EVEX format of these legacy instructions without modification). Although newer instructions could use the EVEX prefix encoding field's content directly as an opcode extension, certain embodiments expand in a similar fashion for consistency but allow for different meanings to be specified by these legacy SIMD prefixes. An alternative embodiment may redesign the PLA to support the 2 bit SIMD prefix encodings, and thus not require the expansion.

Alpha field 1852 (EVEX byte 3, bit [7]—EH; also known as EVEX.EH, EVEX.rs, EVEX.RL, EVEX.write mask control, and EVEX.N; also illustrated with α)—as previously described, this field is context specific.

Beta field 1854 (EVEX byte 3, bits [6:4]-SSS, also known as EVEX.s₂₋₀, EVEX.r₂₋₀, EVEX.rr1, EVEX.LL0, EVEX.LLB; also illustrated with βββ)—as previously described, this field is context specific.

REX′ field 1810—this is the remainder of the REX′ field and is the EVEX.V′ bit field (EVEX Byte 3, bit [3]—V′) that may be used to encode either the upper 16 or lower 16 of the extended 32 register set. This bit is stored in bit inverted format. A value of 1 is used to encode the lower 16 registers. In other words, V′VVVV is formed by combining EVEX.V′, EVEX.vvvv.

Write mask field 1870 (EVEX byte 3, bits [2:0]-kkk)—its content specifies the index of a register in the write mask registers as previously described. In one embodiment of the invention, the specific value EVEX.kkk=000 has a special behavior implying no write mask is used for the particular instruction (this may be implemented in a variety of ways including the use of a write mask hardwired to all ones or hardware that bypasses the masking hardware).

Real Opcode Field 1930 (Byte 4) is also known as the opcode byte. Part of the opcode is specified in this field.

MOD R/M Field 1940 (Byte 5) includes MOD field 1942, Reg field 1944, and R/M field 1946. As previously described, the MOD field's 1942 content distinguishes between memory access and non-memory access operations. The role of Reg field 1944 can be summarized to two situations: encoding either the destination register operand or a source register operand, or be treated as an opcode extension and not used to encode any instruction operand. The role of R/M field 1946 may include the following: encoding the instruction operand that references a memory address, or encoding either the destination register operand or a source register operand.

Scale, Index, Base (SIB) Byte (Byte 6)—As previously described, the scale field's 1850 content is used for memory address generation. SIB.xxx 1954 and SIB.bbb 1956—the contents of these fields have been previously referred to with regard to the register indexes Xxxx and Bbbb.

Displacement field 1862A (Bytes 7-10)—when MOD field 1942 contains 10, bytes 7-10 are the displacement field 1862A, and it works the same as the legacy 32-bit displacement (disp32) and works at byte granularity.

Displacement factor field 1862B (Byte 7)—when MOD field 1942 contains 01, byte 7 is the displacement factor field 1862B. The location of this field is that same as that of the legacy x86 instruction set 8-bit displacement (disp8), which works at byte granularity. Since disp8 is sign extended, it can only address between −128 and 127 bytes offsets; in terms of 64 byte cache lines, disp8 uses 8 bits that can be set to only four really useful values −128, −64, 0, and 64; since a greater range is often needed, disp32 is used; however, disp32 requires 4 bytes. In contrast to disp8 and disp32, the displacement factor field 1862B is a reinterpretation of disp8; when using displacement factor field 1862B, the actual displacement is determined by the content of the displacement factor field multiplied by the size of the memory operand access (N). This type of displacement is referred to as disp8*N. This reduces the average instruction length (a single byte of used for the displacement but with a much greater range). Such compressed displacement is based on the assumption that the effective displacement is multiple of the granularity of the memory access, and hence, the redundant low-order bits of the address offset do not need to be encoded. In other words, the displacement factor field 1862B substitutes the legacy x86 instruction set 8-bit displacement. Thus, the displacement factor field 1862B is encoded the same way as an x86 instruction set 8-bit displacement (so no changes in the ModRM/SIB encoding rules) with the only exception that disp8 is overloaded to disp8*N. In other words, there are no changes in the encoding rules or encoding lengths but only in the interpretation of the displacement value by hardware (which needs to scale the displacement by the size of the memory operand to obtain a byte-wise address offset). Immediate field 1872 operates as previously described.

### Full Opcode Field

FIG. 19B is a block diagram illustrating the fields of the specific vector friendly instruction format 1900 that make up the full opcode field 1874 according to one embodiment of the invention. Specifically, the full opcode field 1874 includes the format field 1840, the base operation field 1842, and the data element width (W) field 1864. The base operation field 1842 includes the prefix encoding field 1925, the opcode map field 1915, and the real opcode field 1930.

### Register Index Field

FIG. 19C is a block diagram illustrating the fields of the specific vector friendly instruction format 1900 that make up the register index field 1844 according to one embodiment of the invention. Specifically, the register index field 1844 includes the REX field 1905, the REX′ field 1910, the MODR/M.reg field 1944, the MODR/M.r/m field 1946, the VVVV field 1920, xxx field 1954, and the bbb field 1956.

### Augmentation Operation Field

FIG. 19D is a block diagram illustrating the fields of the specific vector friendly instruction format that makes up the augmentation operation field 1850 according to one embodiment of the invention. When the class (U) field 1868 contains 0, it signifies EVEX.U0 (class A 1868A); when it contains 1, it signifies EVEX.U1 (class B 1868B). When U=0 and the MOD field 1942 contains 11 (signifying a no memory access operation), the alpha field 1852 (EVEX byte 3, bit [7]—EH) is interpreted as the rs field 1852A. When the rs field 1852A contains a 1 (round 1852A.1), the beta field 1854 (EVEX byte 3, bits [6:4]—SSS) is interpreted as the round control field 1854A. The round control field 1854A includes a one bit SAE field 1856 and a two bit round operation field 1858. When the rs field 1852A contains a 0 (data transform 1852A.2), the beta field 1854 (EVEX byte 3, bits [6:4]—SSS) is interpreted as a three bit data transform field 1854B. When U=0 and the MOD field 1942 contains 00, 01, or 10 (signifying a memory access operation), the alpha field 1852 (EVEX byte 3, bit [7]—EH) is interpreted as the eviction hint (EH) field 1852B and the beta field 1854 (EVEX byte 3, bits [6:4]—SSS) is interpreted as a three bit data manipulation field 1854C.

When U=1, the alpha field 1852 (EVEX byte 3, bit [7]—EH) is interpreted as the write mask control (Z) field 1852C. When U=1 and the MOD field 1942 contains 11 (signifying a no memory access operation), part of the beta field 1854 (EVEX byte 3, bit [4]—S₀) is interpreted as the RL field 1857A; when it contains a 1 (round 1857A.1) the rest of the beta field 1854 (EVEX byte 3, bit [6-5]—S₂₋₁) is interpreted as the round operation field 1859A, while when the RL field 1857A contains a 0 (VSIZE 1857.A2) the rest of the beta field 1854 (EVEX byte 3, bit [6-5]—S₂₋₁) is interpreted as the vector length field 1859B (EVEX byte 3, bit [6-5]—L₁₋₀). When U=1 and the MOD field 1942 contains 00, 01, or 10 (signifying a memory access operation), the beta field 1854 (EVEX byte 3, bits [6:4]—SSS) is interpreted as the vector length field 1859B (EVEX byte 3, bit [6-5]—L₁₋₀) and the broadcast field 1857B (EVEX byte 3, bit [4]—B).

### Exemplary Register Architecture

FIG. 20 is a block diagram of a register architecture 2000 according to one embodiment of the invention. In the embodiment illustrated, there are 32 vector registers 2010 that are 512 bits wide; these registers are referenced as zmm0 through zmm31. The lower order 256 bits of the lower 16 zmm registers are overlaid on registers ymm0-16. The lower order 128 bits of the lower 16 zmm registers (the lower order 128 bits of the ymm registers) are overlaid on registers xmm0-15. The specific vector friendly instruction format 1900 operates on these overlaid register file as illustrated in the below tables.

| Adjustable Vector Length | Class | Operations | Registers |
|---|---|---|---|
| Instruction Templates | A (FIG. | 1810, 1815, | zmm registers (the vector length is |
| that do not include the | 18A; U = 0) | 1825, 1830 | 64 byte) |
| vector length field 1859B | B (FIG. | 1812 | zmm registers (the vector length is |
| | 18B; U = 1) | | 64 byte) |
| Instruction templates | B (FIG. | 1817, 1827 | zmm, ymm, or xmm registers (the |
| that do include the | 18B; U = 1) | | vector length is 64 byte, 32 byte, or |
| vector length field 1859B | | | 16 byte) depending on the vector |
| | | | length field 1859B |

In other words, the vector length field 1859B selects between a maximum length and one or more other shorter lengths, where each such shorter length is half the length of the preceding length; and instructions templates without the vector length field 1859B operate on the maximum vector length. Further, in one embodiment, the class B instruction templates of the specific vector friendly instruction format 1900 operate on packed or scalar single/double-precision floating point data and packed or scalar integer data. Scalar operations are operations performed on the lowest order data element position in an zmm/ymm/xmm register; the higher order data element positions are either left the same as they were prior to the instruction or zeroed depending on the embodiment.

Write mask registers 2015—in the embodiment illustrated, there are 8 write mask registers (k0 through k7), each 64 bits in size. In an alternate embodiment, the write mask registers 2015 are 16 bits in size. As previously described, in one embodiment of the invention, the vector mask register k0 cannot be used as a write mask; when the encoding that would normally indicate k0 is used for a write mask, it selects a hardwired write mask of 0xFFFF, effectively disabling write masking for that instruction.

General-purpose registers 2025—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 2045, on which is aliased the MMX packed integer flat register file 2050—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Alternative embodiments of the invention may use wider or narrower registers. Additionally, alternative embodiments of the invention may use more, less, or different register files and registers.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

### In-Order and Out-of-Order Core Block Diagram

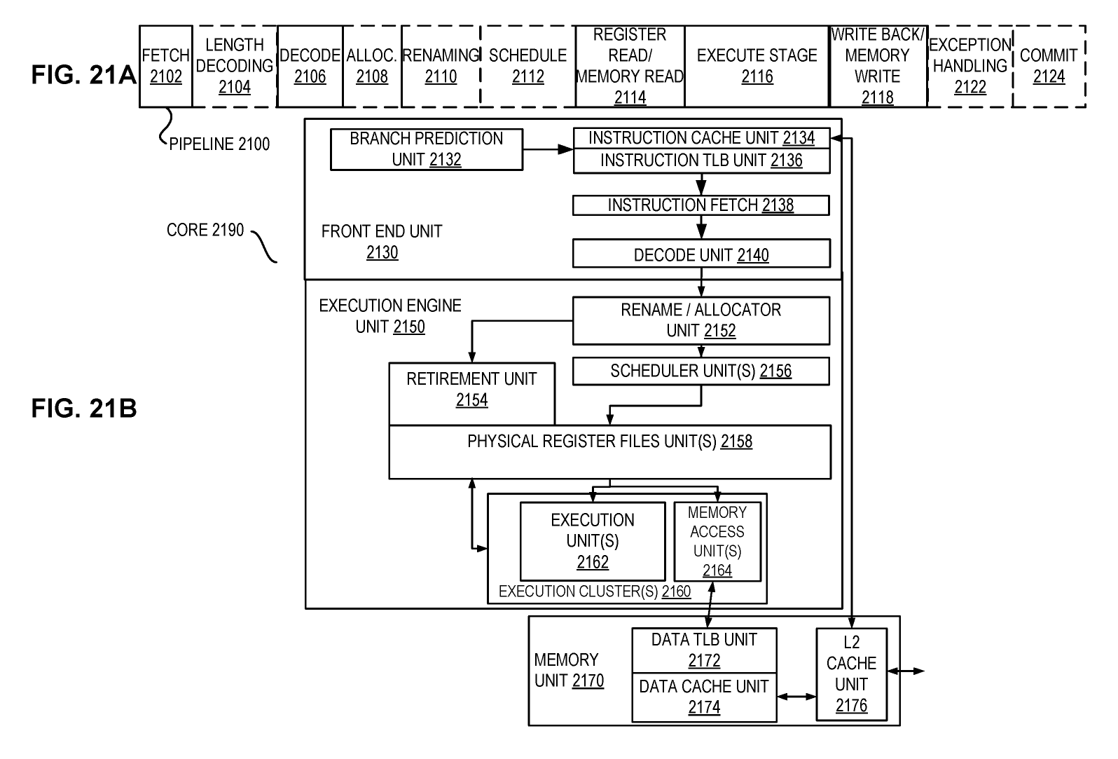

FIG. 21A is a block diagram illustrating both an exemplary in-order pipeline and an exemplary register renaming, out-of-order issue/execution pipeline according to embodiments of the invention. FIG. 21B is a block diagram illustrating both an exemplary embodiment of an in-order architecture core and an exemplary register renaming, out-of-order issue/execution architecture core to be included in a processor according to embodiments of the invention. The solid lined boxes in FIGS. 21A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 21A, a processor pipeline 2100 includes a fetch stage 2102, a length decode stage 2104, a decode stage 2106, an allocation stage 2108, a renaming stage 2110, a scheduling (also known as a dispatch or issue) stage 2112, a register read/memory read stage 2114, an execute stage 2116, a write back/memory write stage 2118, an exception handling stage 2122, and a commit stage 2124.

FIG. 21B shows processor core 2190 including a front end unit 2130 coupled to an execution engine unit 2150, and both are coupled to a memory unit 2170. The core 2190 may be a reduced instruction set computing (RISC) core, a complex instruction set computing (CISC) core, a very long instruction word (VLIW) core, or a hybrid or alternative core type. As yet another option, the core 2190 may be a special-purpose core, such as, for example, a network or communication core, compression engine, coprocessor core, general purpose computing graphics processing unit (GPGPU) core, graphics core, or the like.

The front end unit 2130 includes a branch prediction unit 2132 coupled to an instruction cache unit 2134, which is coupled to an instruction translation lookaside buffer (TLB) 2136, which is coupled to an instruction fetch unit 2138, which is coupled to a decode unit 2140. The decode unit 2140 (or decoder) may decode instructions, and generate as an output one or more micro-operations, micro-code entry points, microinstructions, other instructions, or other control signals, which are decoded from, or which otherwise reflect, or are derived from, the original instructions. The decode unit 2140 may be implemented using various different mechanisms. Examples of suitable mechanisms include, but are not limited to, look-up tables, hardware implementations, programmable logic arrays (PLAs), microcode read only memories (ROMs), etc. In one embodiment, the core 2190 includes a microcode ROM or other medium that stores microcode for certain macroinstructions (e.g., in decode unit 2140 or otherwise within the front end unit 2130). The decode unit 2140 is coupled to a rename/allocator unit 2152 in the execution engine unit 2150.

The execution engine unit 2150 includes the rename/allocator unit 2152 coupled to a retirement unit 2154 and a set of one or more scheduler unit(s) 2156. The scheduler unit(s) 2156 represents any number of different schedulers, including reservations stations, central instruction window, etc. The scheduler unit(s) 2156 is coupled to the physical register file(s) unit(s) 2158. Each of the physical register file(s) units 2158 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 2158 comprises a vector registers unit, a write mask registers unit, and a scalar registers unit. These register units may provide architectural vector registers, vector mask registers, and general purpose registers. The physical register file(s) unit(s) 2158 is overlapped by the retirement unit 2154 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 2154 and the physical register file(s) unit(s) 2158 are coupled to the execution cluster(s) 2160. The execution cluster(s) 2160 includes a set of one or more execution units 2162 and a set of one or more memory access units 2164. The execution units 2162 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 2156, physical register file(s) unit(s) 2158, and execution cluster(s) 2160 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 2164). It should also be understood that where separate pipelines are used, one or more of these pipelines may be out-of-order issue/execution and the rest in-order.

The set of memory access units 2164 is coupled to the memory unit 2170, which includes a data TLB unit 2172 coupled to a data cache unit 2174 coupled to a level 2 (L2) cache unit 2176. In one exemplary embodiment, the memory access units 2164 may include a load unit, a store address unit, and a store data unit, each of which is coupled to the data TLB unit 2172 in the memory unit 2170. The instruction cache unit 2134 is further coupled to a level 2 (L2) cache unit 2176 in the memory unit 2170. The L2 cache unit 2176 is coupled to one or more other levels of cache and eventually to a main memory.

By way of example, the exemplary register renaming, out-of-order issue/execution core architecture may implement the pipeline 2100 as follows: 1) the instruction fetch 2138 performs the fetch and length decoding stages 2102 and 2104; 2) the decode unit 2140 performs the decode stage 2106; 3) the rename/allocator unit 2152 performs the allocation stage 2108 and renaming stage 2110; 4) the scheduler unit(s) 2156 performs the schedule stage 2112; 5) the physical register file(s) unit(s) 2158 and the memory unit 2170 perform the register read/memory read stage 2114; the execution cluster 2160 perform the execute stage 2116; 6) the memory unit 2170 and the physical register file(s) unit(s) 2158 perform the write back/memory write stage 2118; 7) various units may be involved in the exception handling stage 2122; and 8) the retirement unit 2154 and the physical register file(s) unit(s) 2158 perform the commit stage 2124.

The core 2190 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 2190 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 2134/2174 and a shared L2 cache unit 2176, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

### Specific Exemplary In-Order Core Architecture

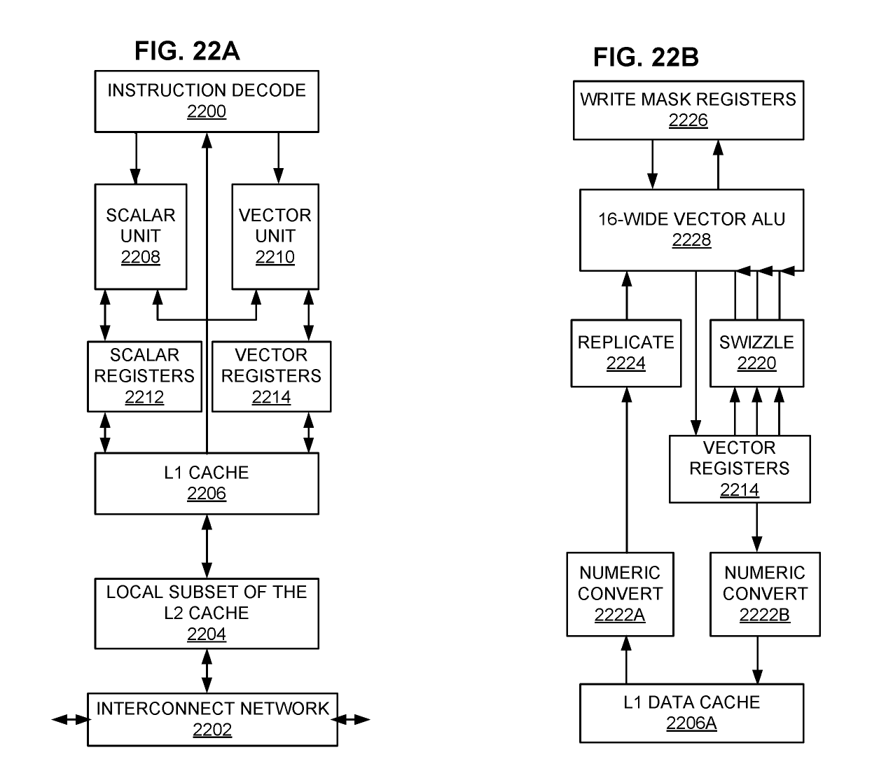

FIGS. 22A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 22A is a block diagram of a single processor core, along with its connection to the on-die interconnect network 2202 and with its local subset of the Level 2 (L2) cache 2204, according to embodiments of the invention. In one embodiment, an instruction decoder 2200 supports the x86 instruction set with a packed data instruction set extension. An L1 cache 2206 allows low-latency accesses to cache memory into the scalar and vector units. While in one embodiment (to simplify the design), a scalar unit 2208 and a vector unit 2210 use separate register sets (respectively, scalar registers 2212 and vector registers 2214) and data transferred between them is written to memory and then read back in from a level 1 (L1) cache 2206, alternative embodiments of the invention may use a different approach (e.g., use a single register set or include a communication path that allow data to be transferred between the two register files without being written and read back).

The local subset of the L2 cache 2204 is part of a global L2 cache that is divided into separate local subsets, one per processor core. Each processor core has a direct access path to its own local subset of the L2 cache 2204. Data read by a processor core is stored in its L2 cache subset 2204 and can be accessed quickly, in parallel with other processor cores accessing their own local L2 cache subsets. Data written by a processor core is stored in its own L2 cache subset 2204 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 22B is an expanded view of part of the processor core in FIG. 22A according to embodiments of the invention. FIG. 22B includes an L1 data cache 2206A part of the L1 cache 2204, as well as more detail regarding the vector unit 2210 and the vector registers 2214.

Specifically, the vector unit 2210 is a 16-wide vector processing unit (VPU) (see the 16-wide ALU 2228), which executes one or more of integer, single-precision float, and double-precision float instructions. The VPU supports swizzling the register inputs with swizzle unit 2220, numeric conversion with numeric convert units 2222A-B, and replication with replication unit 2224 on the memory input. Write mask registers 2226 allow predicating resulting vector writes.

FIG. 23 is a block diagram of a processor 2300 that may have more than one core, may have an integrated memory controller, and may have integrated graphics according to embodiments of the invention. The solid lined boxes in FIG. 23 illustrate a processor 2300 with a single core 2302A, a system agent 2310, a set of one or more bus controller units 2316, while the optional addition of the dashed lined boxes illustrates an alternative processor 2300 with multiple cores 2302A-N, a set of one or more integrated memory controller unit(s) 2314 in the system agent unit 2310, and special purpose logic 2308.

Thus, different implementations of the processor 2300 may include: 1) a CPU with the special purpose logic 2308 being integrated graphics and/or scientific (throughput) logic (which may include one or more cores), and the cores 2302A-N being one or more general purpose cores (e.g., general purpose in-order cores, general purpose out-of-order cores, a combination of the two); 2) a coprocessor with the cores 2302A-N being a large number of special purpose cores intended primarily for graphics and/or scientific (throughput); and 3) a coprocessor with the cores 2302A-N being a large number of general purpose in-order cores. Thus, the processor 2300 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 2300 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 2306, and external memory (not shown) coupled to the set of integrated memory controller units 2314. The set of shared cache units 2306 may include one or more mid-level caches, such as level 2 (L2), level 3 (L3), level 4 (L4), or other levels of cache, a last level cache (LLC), and/or combinations thereof. While in one embodiment a ring based interconnect unit 2312 interconnects the integrated graphics logic 2308 (integrated graphics logic 2308 is an example of and is also referred to herein as special purpose logic), the set of shared cache units 2306, and the system agent unit 2310/integrated memory controller unit(s) 2314, alternative embodiments may use any number of well-known techniques for interconnecting such units. In one embodiment, coherency is maintained between one or more cache units 2306 and cores 2302-A-N.

In some embodiments, one or more of the cores 2302A-N are capable of multi-threading. The system agent 2310 includes those components coordinating and operating cores 2302A-N. The system agent unit 2310 may include for example a power control unit (PCU) and a display unit. The PCU may be or include logic and components needed for regulating the power state of the cores 2302A-N and the integrated graphics logic 2308. The display unit is for driving one or more externally connected displays.

The cores 2302A-N may be homogenous or heterogeneous in terms of architecture instruction set; that is, two or more of the cores 2302A-N may be capable of execution the same instruction set, while others may be capable of executing only a subset of that instruction set or a different instruction set.

### Exemplary Computer Architectures

FIGS. 24-27 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 24, shown is a block diagram of a system 2400 in accordance with one embodiment of the present invention. The system 2400 may include one or more processors 2410, 2415, which are coupled to a controller hub 2420. In one embodiment the controller hub 2420 includes a graphics memory controller hub (GMCH) 2490 and an Input/Output Hub (IOH) 2450 (which may be on separate chips); the GMCH 2490 includes memory and graphics controllers to which are coupled memory 2440 and a coprocessor 2445; the IOH 2450 couples input/output (I/O) devices 2460 to the GMCH 2490. Alternatively, one or both of the memory and graphics controllers are integrated within the processor (as described herein), the memory 2440 and the coprocessor 2445 are coupled directly to the processor 2410, and the controller hub 2420 in a single chip with the IOH 2450.

The optional nature of additional processors 2415 is denoted in FIG. 24 with broken lines. Each processor 2410, 2415 may include one or more of the processing cores described herein and may be some version of the processor 2300.

The memory 2440 may be, for example, dynamic random access memory (DRAM), phase change memory (PCM), or a combination of the two. For at least one embodiment, the controller hub 2420 communicates with the processor(s) 2410, 2415 via a multi-drop bus, such as a frontside bus (FSB), point-to-point interface such as QuickPath Interconnect (QPI), or similar connection 2495.

In one embodiment, the coprocessor 2445 is a special-purpose processor, such as, for example, a high-throughput MIC processor, a network or communication processor, compression engine, graphics processor, GPGPU, embedded processor, or the like. In one embodiment, controller hub 2420 may include an integrated graphics accelerator.

There can be a variety of differences between the physical resources 2410, 2415 in terms of a spectrum of metrics of merit including architectural, microarchitectural, thermal, power consumption characteristics, and the like.

In one embodiment, the processor 2410 executes instructions that control data processing operations of a general type. Embedded within the instructions may be coprocessor instructions. The processor 2410 recognizes these coprocessor instructions as being of a type that should be executed by the attached coprocessor 2445. Accordingly, the processor 2410 issues these coprocessor instructions (or control signals representing coprocessor instructions) on a coprocessor bus or other interconnect, to coprocessor 2445. Coprocessor(s) 2445 accept and execute the received coprocessor instructions.

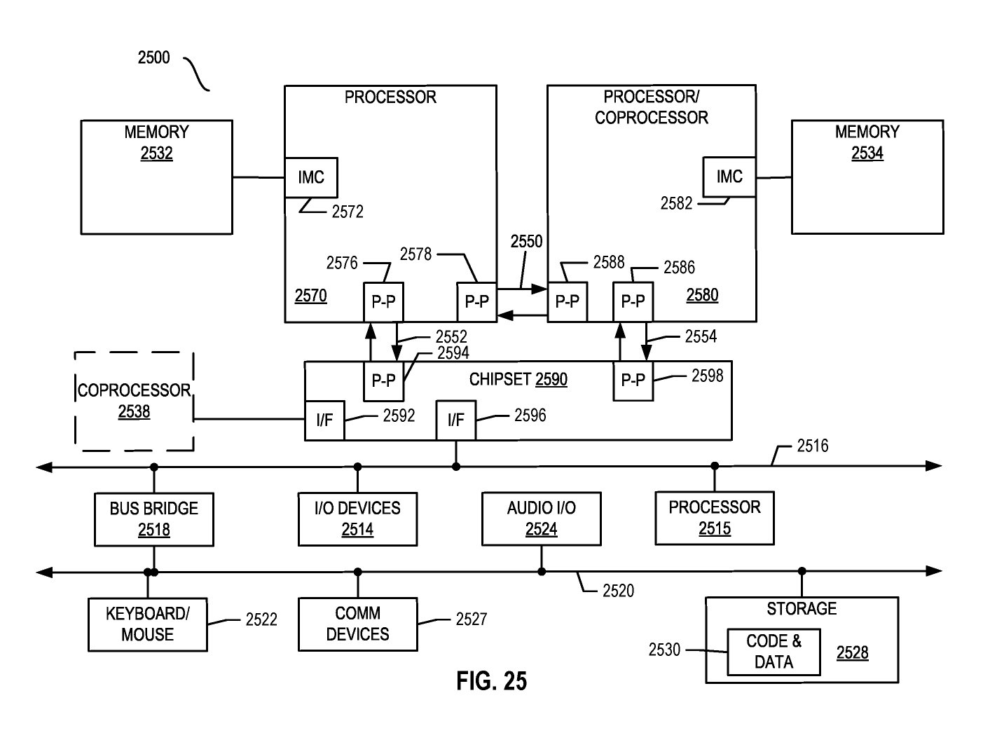

Referring now to FIG. 25, shown is a block diagram of a first more specific exemplary system 2500 in accordance with an embodiment of the present invention. As shown in FIG. 25, multiprocessor system 2500 is a point-to-point interconnect system, and includes a first processor 2570 and a second processor 2580 coupled via a point-to-point interconnect 2550. Each of processors 2570 and 2580 may be some version of the processor 2300. In one embodiment of the invention, processors 2570 and 2580 are respectively processors 2410 and 2415, while coprocessor 2538 is coprocessor 2445. In another embodiment, processors 2570 and 2580 are respectively processor 2410 coprocessor 2445.

Processors 2570 and 2580 are shown including integrated memory controller (IMC) units 2572 and 2582, respectively. Processor 2570 also includes as part of its bus controller units point-to-point (P-P) interfaces 2576 and 2578; similarly, second processor 2580 includes P-P interfaces 2586 and 2588. Processors 2570, 2580 may exchange information via a point-to-point (P-P) interface 2550 using P-P interface circuits 2578, 2588. As shown in FIG. 25, IMCs 2572 and 2582 couple the processors to respective memories, namely a memory 2532 and a memory 2534, which may be portions of main memory locally attached to the respective processors.

Processors 2570, 2580 may each exchange information with a chipset 2590 via individual P-P interfaces 2552, 2554 using point to point interface circuits 2576, 2594, 2586, 2598. Chipset 2590 may optionally exchange information with the coprocessor 2538 via a high-performance interface 2592. In one embodiment, the coprocessor 2538 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 2590 may be coupled to a first bus 2516 via an interface 2596. In one embodiment, first bus 2516 may be a Peripheral Component Interconnect (PCI) bus, or a bus such as a PCI Express bus or another third generation I/O interconnect bus, although the scope of the present invention is not so limited.

As shown in FIG. 25, various I/O devices 2514 may be coupled to first bus 2516, along with a bus bridge 2518 which couples first bus 2516 to a second bus 2520. In one embodiment, one or more additional processor(s) 2515, such as coprocessors, high-throughput MIC processors, GPGPU's, accelerators (such as, e.g., graphics accelerators or digital signal processing (DSP) units), field programmable gate arrays, or any other processor, are coupled to first bus 2516. In one embodiment, second bus 2520 may be a low pin count (LPC) bus. Various devices may be coupled to a second bus 2520 including, for example, a keyboard and/or mouse 2522, communication devices 2527 and a storage unit 2528 such as a disk drive or other mass storage device which may include instructions/code and data 2530, in one embodiment. Further, an audio I/O 2524 may be coupled to the second bus 2520. Note that other architectures are possible. For example, instead of the point-to-point architecture of FIG. 25, a system may implement a multi-drop bus or other such architecture.

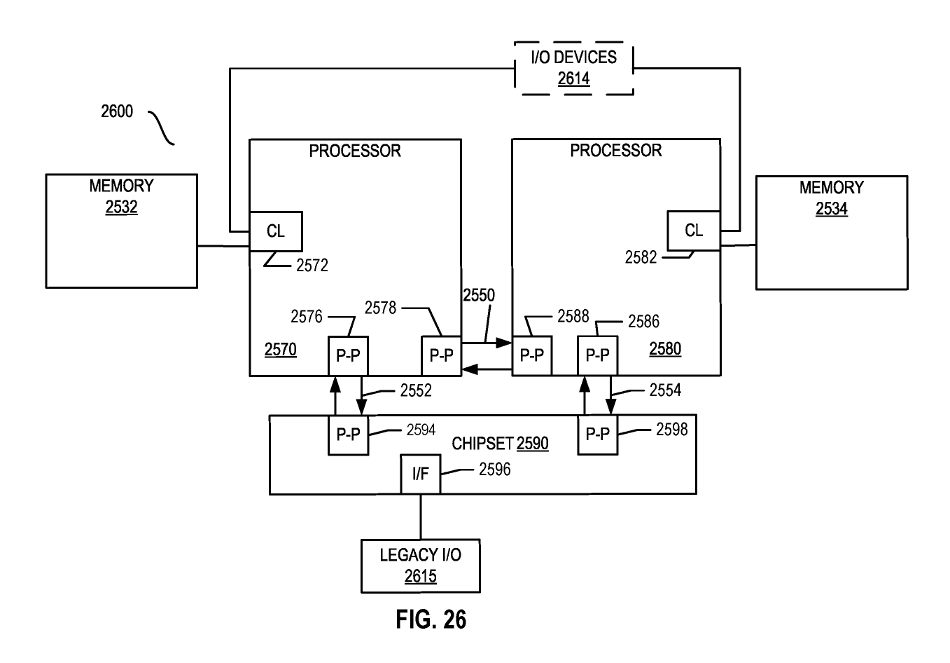

Referring now to FIG. 26, shown is a block diagram of a second more specific exemplary system 2600 in accordance with an embodiment of the present invention. Like elements in FIGS. 25 and 26 bear like reference numerals, and certain aspects of FIG. 25 have been omitted from FIG. 26 in order to avoid obscuring other aspects of FIG. 26.

FIG. 26 illustrates that the processors 2570, 2580 may include integrated memory and I/O control logic (“CL”) 2572 and 2582, respectively. Thus, the CL 2572, 2582 include integrated memory controller units and include I/O control logic. FIG. 26 illustrates that not only are the memories 2532, 2534 coupled to the CL 2572, 2582, but also that I/O devices 2614 are also coupled to the control logic 2572, 2582. Legacy I/O devices 2615 are coupled to the chipset 2590.

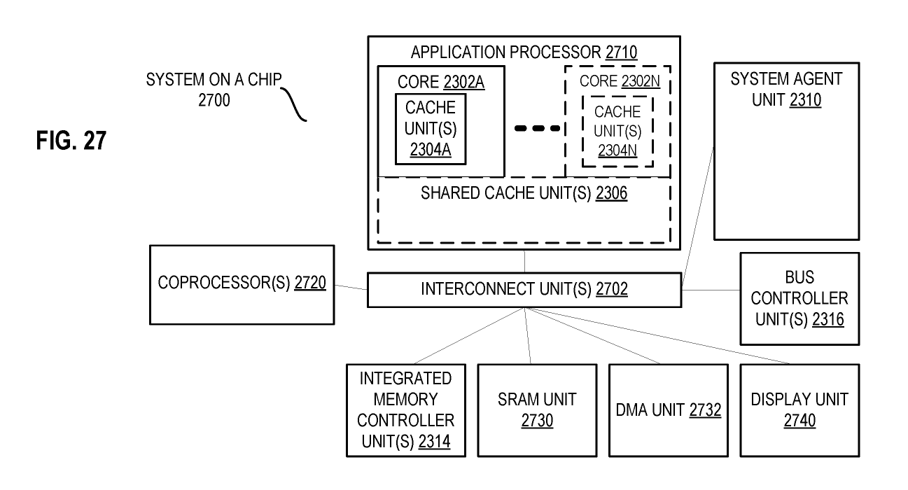

Referring now to FIG. 27, shown is a block diagram of a SoC 2700 in accordance with an embodiment of the present invention. Similar elements in FIG. 23 bear like reference numerals. Also, dashed lined boxes are optional features on more advanced SoCs. In FIG. 27, an interconnect unit(s) 2702 is coupled to: an application processor 2710 which includes a set of one or more cores 2302A-N, which include cache units 2304A-N, and shared cache unit(s) 2306; a system agent unit 2310; a bus controller unit(s) 2316; an integrated memory controller unit(s) 2314; a set or one or more coprocessors 2720 which may include integrated graphics logic, an image processor, an audio processor, and a video processor; an static random access memory (SRAM) unit 2730; a direct memory access (DMA) unit 2732; and a display unit 2740 for coupling to one or more external displays. In one embodiment, the coprocessor(s) 2720 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 2530 illustrated in FIG. 25, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMS) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

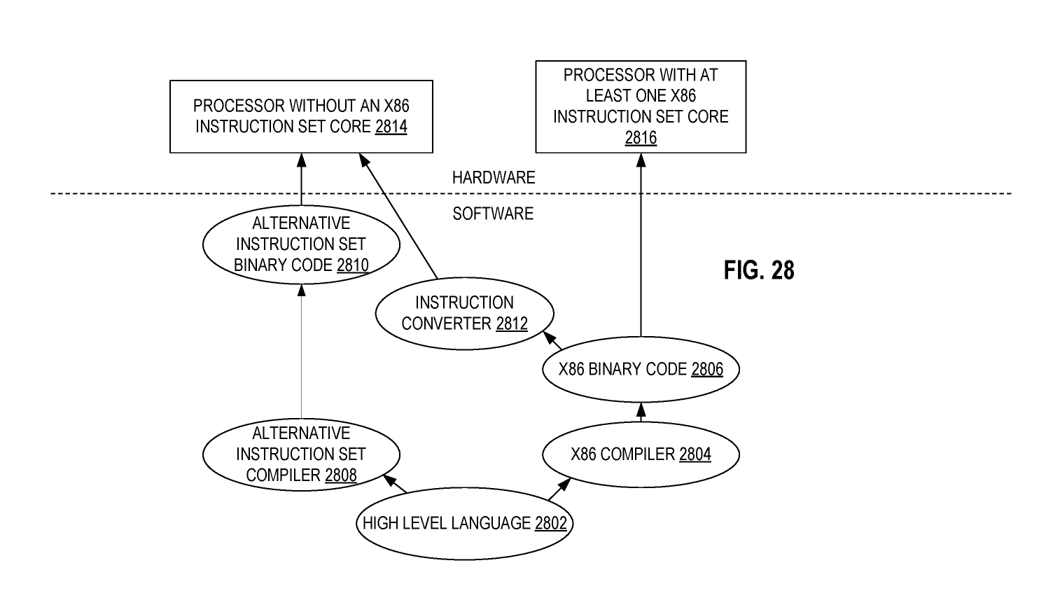

FIG. 28 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 28 shows a program in a high level language 2802 may be compiled using an x86 compiler 2804 to generate x86 binary code 2806 that may be natively executed by a processor with at least one x86 instruction set core 2816. The processor with at least one x86 instruction set core 2816 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 2804 represents a compiler that is operable to generate x86 binary code 2806 (e.g., object code) that can, with or without additional linkage processing, be executed on the processor with at least one x86 instruction set core 2816. Similarly, FIG. 28 shows the program in the high level language 2802 may be compiled using an alternative instruction set compiler 2808 to generate alternative instruction set binary code 2810 that may be natively executed by a processor without at least one x86 instruction set core 2814 (e.g., a processor with cores that execute the MIPS instruction set of MIPS Technologies of Sunnyvale, Calif. and/or that execute the ARM instruction set of ARM Holdings of Sunnyvale, Calif.). The instruction converter 2812 is used to convert the x86 binary code 2806 into code that may be natively executed by the processor without an x86 instruction set core 2814. This converted code is not likely to be the same as the alternative instruction set binary code 2810 because an instruction converter capable of this is difficult to make; however, the converted code will accomplish the general operation and be made up of instructions from the alternative instruction set. Thus, the instruction converter 2812 represents software, firmware, hardware, or a combination thereof that, through emulation, simulation or any other process, allows a processor or other electronic device that does not have an x86 instruction set processor or core to execute the x86 binary code 2806.

### FURTHER EXAMPLES

Example 1 provides an exemplary processor including: a plurality of accelerator cores, each having a corresponding instruction set architecture (ISA), a fetch circuit to fetch one or more instructions specifying one of the accelerator cores, a decode circuit to decode the one or more fetched instructions, and an issue circuit to translate the one or more decoded instructions into the ISA corresponding to the specified accelerator core, collate the one or more translated instructions into an instruction packet, and issue the instruction packet to the specified accelerator core, wherein the plurality of accelerator cores include a memory engine (MENG), a collectives engine (CENG), a queue engine (QENG), and a chain management unit (CMU).

Example 2 includes the substance of the exemplary processor of Example 1, wherein each of the plurality of accelerator cores is memory-mapped to an address range, and wherein the one or more instructions are memory-mapped input/output (MMIO) instructions having an address to specify the one accelerator core.

Example 3 includes the substance of the exemplary processor of Example 1, further including an execution circuit, wherein the fetch circuit further fetches another instruction not specifying any accelerator core, wherein the one or more instructions specifying the one accelerator core are non-blocking, wherein the decode circuit is further to decode the other fetched instruction, and wherein the execution circuit is to execute the decoded other instruction without awaiting completion of execution of the instruction packet.

Example 4 includes the substance of the exemplary processor of any one of Examples 1-3, wherein the ISA corresponding to the MENG includes dual-memory instructions, each of the dual-memory instructions including one of Dual_read_read, Dual_read_write, Dual_write_write, Dual_xchg_read, Dual_xchg_write, Dual_cmpxchg_read, Dual_cmpxchg_write, Dual_compare&read_read, and Dual_compare&read_write.

Example 5 includes the substance of the exemplary processor of any one of Examples 1-3, wherein the ISA corresponding to the MENG includes a direct memory access (DMA) instruction specifying a source, a destination, an arithmetic operation, and a block size, wherein the MENG copies a block of data according to the block size from the specified source to the specified destination, and wherein the MENG further performs the arithmetic operation on each datum of the data block before copying resulting datum to the specified destination.

Example 6 includes the substance of the exemplary processor of any one of Examples 1-3, wherein the ISA corresponding to the CENG includes collective operations, including reductions, all-reductions (reduction-2-all), broadcasts, gathers, scatters, barriers, and parallel prefix operations.

Example 7 includes the substance of the exemplary processor of any one of Examples 1-3, wherein the QENG includes a hardware-managed queue having an arbitrary queue type, and wherein the ISA corresponding to the QENG includes instructions for adding data to the queue and removing data from the queue, and wherein the arbitrary queue type is one of last-in-first-out (LIFO), first-in last-out (FILO) and first-in-first-out (FIFO).

Example 8 includes the substance of the exemplary processor of one of Examples 1-3, wherein a subset of the one or more instructions is part of a chain, and wherein the CMU stalls execution of each chained instruction until completion of a preceding chained instruction, and wherein other instructions of the one or more instructions can execute in parallel.

Example 9 includes the substance of the exemplary processor of any one of Examples 1-3, further including a switched bus fabric to couple the issue circuit and the plurality of accelerator cores, the switched bus fabric including paths having multiple parallel lanes and monitoring a degree of congestion thereon.

Example 10 includes the substance of the exemplary processor of Example 9, further including ingress and egress network interfaces, and a packet hijack circuit to: determine whether to hijack each incoming instruction packet at the ingress network interface by comparing an address contained in the instruction packet to a software-programmable hijack target address, copy an instruction packet determined to be hijacked to a hijack circuit scratchpad memory, and process a stored packet by a hijack circuit execution unit to conduct line-speed in situ analysis, modification, and rejection of packets.

Example 11 provides an exemplary system including: a memory, a plurality of accelerator cores, each having a corresponding instruction set architecture (ISA), means for fetching one or more instructions specifying one of the accelerator cores, means for decoding the one or more fetched instructions, and means for translating the one or more decoded instructions into the ISA corresponding to the specified accelerator core, means for collating the one or more translated instructions into an instruction packet, and means for issuing the instruction packet to the specified accelerator core, wherein the plurality of accelerator cores include a memory engine (MENG), a collectives engine (CENG), a queue engine (QENG), and a chain management unit (CMU).

Example 12 includes the substance of the exemplary system of Example 12, wherein each of the plurality of accelerator cores is memory-mapped to an address range, and wherein the one or more instructions are memory-mapped input/output (MMIO) instructions having an address to specify the one accelerator core.

Example 13 includes the substance of the exemplary system of Example 12, further including an execution circuit, wherein the means for fetching further fetches another instruction not specifying any accelerator core, wherein the one or more instructions specifying the one accelerator core are non-blocking, wherein the means for decoding is further to decode the other fetched instruction, and wherein the execution circuit is to execute the decoded other instruction without awaiting completion of execution of the instruction packet.

Example 14 includes the substance of the exemplary system of any one of Examples 11-13, wherein the ISA corresponding to the MENG includes dual-memory instructions, each of the dual-memory instructions including one of Dual_read_read, Dual_read_write, Dual_write_write, Dual_xchg_read, Dual_xchg_write, Dual_cmpxchg_read, Dual_cmpxchg_write, Dual_compare&read_read, and Dual_compare&read_write.

Example 15 includes the substance of the exemplary system of any one of Examples 11-13, wherein the ISA corresponding to the MENG includes a direct memory access (DMA) instruction specifying a source, a destination, an arithmetic operation, and a block size, wherein the MENG copies a block of data according to the block size from the specified source to the specified destination, and wherein the MENG further performs the arithmetic operation on each datum of the data block before copying resulting datum to the specified destination.

Example 16 includes the substance of the exemplary system of any one of Examples 11-13, wherein the ISA corresponding to the CENG includes collective operations, including reductions, all-reductions (reduction-2-all), broadcasts, gathers, scatters, barriers, and parallel prefix operations.

Example 17 includes the substance of the exemplary system of any one of Examples 11-13, wherein the QENG includes a hardware-managed queue having an arbitrary queue type, and wherein the ISA corresponding to the QENG includes instructions for adding data to the queue and removing data from the queue, and wherein the arbitrary queue type is one of last-in-first-out (LIFO), first-in last-out (FILO) and first-in-first-out (FIFO).

Example 18 includes the substance of the exemplary system of one of Examples 11-13, wherein a subset of the one or more instructions is part of a chain, and wherein the CMU stalls execution of each chained instruction until completion of a preceding chained instruction, and wherein other instructions of the one or more instructions can execute in parallel.

Example 19 includes the substance of the exemplary system of any one of Examples 11-13, further including a switched bus fabric to couple the issue circuit and the plurality of accelerator cores, the switched bus fabric including paths having multiple parallel lanes and monitoring a degree of congestion thereon.

Example 20 includes the substance of the exemplary system of Example 19, further including ingress and egress network interfaces, and a packet hijack circuit to: determine whether to hijack each incoming instruction packet at the ingress network interface by comparing an address contained in the instruction packet to a software-programmable hijack target address, copy an instruction packet determined to be hijacked to a hijack circuit scratchpad memory, and process a stored packet by a hijack circuit execution unit to conduct line-speed in situ analysis, modification, and rejection of packets.

Example 21 provides an exemplary method of executing instructions using an execution circuit and a plurality of accelerator cores each having a corresponding instruction set architecture (ISA), the method including: fetching, by a fetch circuit, one or more instructions specifying one of the accelerator cores, decoding, using a decode circuit, the one or more fetched instructions, translating, using an issue circuit, the one or more decoded instructions into the ISA corresponding to the specified accelerator core, collating, by the issue circuit the one or more translated instructions into an instruction packet, and issuing the instruction packet to the specified accelerator core, wherein the plurality of accelerator cores include a memory engine (MENG), a collectives engine (CENG), a queue engine (QENG), and a chain management unit (CMU).

Example 22 includes the substance of the exemplary method of Example 21, wherein each of the plurality of accelerator cores is memory-mapped to an address range, and wherein the one or more instructions are memory-mapped input/output (MMIO) instructions having an address to specify the one accelerator core.

Example 23 includes the substance of the exemplary method of Example 21, wherein the one or more instructions specifying the one accelerator core are non-blocking, the method further including, fetching, by the fetch circuit, another instruction not specifying any accelerator core, decoding, by the decode circuit, the other fetched instruction, and executing, by the execution circuit, the decoded other instruction without awaiting completion of execution of the instruction packet.

Example 24 includes the substance of the exemplary method of any one of Examples 21-23, wherein the ISA corresponding to the MENG includes dual-memory instructions, each of the dual-memory instructions including one of Dual_read_read, Dual_read_write, Dual_write_write, Dual_xchg_read, Dual_xchg_write, Dual_cmpxchg_read, Dual_cmpxchg_write, Dual_compare&read_read, and Dual_compare&read_write.

Example 25 includes the substance of the exemplary method of any one of Examples 21-23, wherein the ISA corresponding to the MENG includes a direct memory access (DMA) instruction specifying a source, a destination, an arithmetic operation, and a block size, wherein the MENG copies a block of data according to the block size from the specified source to the specified destination, and wherein the MENG further performs the arithmetic operation on each datum of the data block before copying resulting datum to the specified destination.

Example 26 includes the substance of the exemplary method of any one of Examples 21-23, wherein the ISA corresponding to the CENG includes collective operations, including reductions, all-reductions (reduction-2-all), broadcasts, gathers, scatters, barriers, and parallel prefix operations.

Example 27 includes the substance of the exemplary method of any one of Examples 21-23, wherein the QENG includes a hardware-managed queue having an arbitrary queue type, and wherein the ISA corresponding to the QENG includes instructions for adding data to the queue and removing data from the queue, and wherein the arbitrary queue type is one of last-in-first-out (LIFO), first-in last-out (FILO) and first-in-first-out (FIFO).

Example 28 includes the substance of the exemplary method of one of Examples 21-23, wherein a subset of the one or more instructions is part of a chain, and wherein the CMU stalls execution of each chained instruction until completion of a preceding chained instruction, and wherein other instructions of the one or more instructions can execute in parallel.

Example 29 includes the substance of the exemplary method of any one of Examples 21-23, further including using a switched bus fabric to couple the issue circuit and the plurality of accelerator cores, the switched bus fabric including paths having multiple parallel lanes and monitoring a degree of congestion thereon.

Example 30 includes the substance of the exemplary method of Example 29, further including a packet hijack circuit having ingress and egress network interfaces coupled to the switched bus fabric, and, the method further including: monitoring, by the packet hijack circuit, packets flowing into the ingress interface, determining, by the packet hijack circuit referencing a packet hijack table, to hijack a packet, storing the hijacked packet to a packet hijack buffer, processing in-situ, by the packet hijack circuit at line speed, hijacked packets stored in the packet hijack buffer, the processing to generate a resulting data packet, generating a resulting data packet, and issuing the resulting data packet back into a flow of traffic passing through the ingress interface.

Example 31 provides an exemplary non-transitory machine-readable medium containing instructions that, when executed by an execution circuit coupled to a plurality of accelerator cores each having a corresponding instruction set architecture (ISA), cause the execution circuit to: fetch, by a fetch circuit, one or more instructions specifying one of the accelerator cores, decode, using a decode circuit, the one or more fetched instructions, translate, using an issue circuit, the one or more decoded instructions into the ISA corresponding to the specified accelerator core, collate, by the issue circuit, the one or more translated instructions into an instruction packet, and issue the instruction packet to the specified accelerator core, wherein the plurality of accelerator cores include a memory engine (MENG), a collectives engine (CENG), a queue engine (QENG), and a chain management unit (CMU).

Example 32 includes the substance of the exemplary non-transitory machine-readable medium of Example 31, wherein each of the plurality of accelerator cores is memory-mapped to an address range, and wherein the one or more instructions are memory-mapped input/output (MMIO) instructions having an address to specify the one accelerator core.

Example 33 includes the substance of the exemplary non-transitory machine-readable medium of Example 31, wherein the one or more instructions specifying the one accelerator core are non-blocking, the non-transitory machine-readable medium further containing instructions that cause the execution circuit to: fetch, by the fetch circuit, another instruction not specifying any accelerator core, decode, by the decode circuit, the other fetched instruction, and execute, by the execution circuit, the decoded other instruction without awaiting completion of execution of the instruction packet.

Example 34 includes the substance of the exemplary non-transitory machine-readable medium of any one of Examples 31-33, wherein the ISA corresponding to the MENG includes dual-memory instructions, each of the dual-memory instructions including one of Dual_read_read, Dual_read_write, Dual_write_write, Dual_xchg_read, Dual_xchg_write, Dual_cmpxchg_read, Dual_cmpxchg_write, Dual_compare&read_read, and Dual_compare&read_write.

Example 35 includes the substance of the exemplary non-transitory machine-readable medium of any one of Examples 31-33, wherein the ISA corresponding to the MENG includes a direct memory access (DMA) instruction specifying a source, a destination, an arithmetic operation, and a block size, wherein the MENG copies a block of data according to the block size from the specified source to the specified destination, and wherein the MENG further performs the arithmetic operation on each datum of the data block before copying resulting datum to the specified destination.

Example 36 includes the substance of the exemplary non-transitory machine-readable medium of any one of Examples 31-33, wherein the ISA corresponding to the CENG includes collective operations, including reductions, all-reductions (reduction-2-all), broadcasts, gathers, scatters, barriers, and parallel prefix operations.

Example 37 includes the substance of the exemplary non-transitory machine-readable medium of any one of Examples 31-33, wherein the QENG includes a hardware-managed queue having an arbitrary queue type, and wherein the ISA corresponding to the QENG includes instructions for adding data to the queue and removing data from the queue, and wherein the arbitrary queue type is one of last-in-first-out (LIFO), first-in last-out (FILO) and first-in-first-out (FIFO).

Example 38 includes the substance of the exemplary non-transitory machine-readable medium of one of Examples 31-33, wherein a subset of the one or more instructions is part of a chain, and wherein the CMU stalls execution of each chained instruction until completion of a preceding chained instruction, and wherein other instructions of the one or more instructions can execute in parallel.

Example 39 includes the substance of the exemplary non-transitory machine-readable medium of any one of Examples 31-33, wherein the machine readable code further causes the execution circuit to use a switched bus fabric coupling the issue circuit and the plurality of accelerator cores, the switched bus fabric including paths having multiple parallel lanes and monitoring a degree of congestion thereon.

Example 40 includes the substance of the exemplary non-transitory machine-readable medium of Example 39, wherein the machine-readable instructions, when executed by a packet hijack circuit having ingress and egress network interfaces coupled to the switched bus fabric, to: monitor, by the packet hijack circuit, packets flowing into the ingress interface, determine, by the packet hijack circuit referencing a packet hijack table, to hijack a packet, store the hijacked packet to a packet hijack buffer, process in-situ, by the packet hijack circuit at line speed, hijacked packets stored in the packet hijack buffer, the processing to generate a resulting data packet, generate a resulting data packet; and issue the resulting data packet back into a flow of traffic passing through the ingress interface.

Example 41 includes the substance of the exemplary processor of Example 1, wherein the plurality of accelerator cores are disposed in one or more of a plurality of processor cores, each of the processor cores including: a cache controlled according to a Modified-Owned-Exclusive-Shared-Invalid plus Forward (MOESI+F) cache coherency protocol, wherein memory reads to a cache line, when the cache line is valid in at least one of the caches, is always serviced by the at least one of the caches, rather than to be serviced by a memory read, and wherein dirty cache lines are only ever written back to memory when a dirty cache line in a Modified state gets evicted due to a replacement policy.

Example 42 includes the substance of the exemplary processor of Example 41, wherein when a cache line in n Owned state is evicted due to a replacement policy, the cache line transitions to the Owned state in a different cache if more than one cache had a copy of the cache line before the eviction, or to the Modified state if only one cache had a copy of the cache line before the eviction.

Example 43 includes the substance of the exemplary processor of Example 41, wherein when a cache line in n Forward state is evicted due to a replacement policy, the cache line transitions to the Forward state in a different cache if more than one cache had a copy of the cache line before the eviction, or to the Exclusive state if only one cache had a copy of the cache line before the eviction.

Example 44 includes the substance of the exemplary processor of Example 41, further including a cache control circuit to monitor coherency data requests among the plurality of cores and to cause evictions and transitions in cache state, the cache control circuit comprising a cache tag array to store cache states of cache lines in each of the caches of the plurality of cores.

What is claimed is:

1. A processor comprising:
a plurality of accelerator cores, each having a corresponding instruction set architecture (ISA);
a fetch circuit to fetch one or more instructions specifying one of the accelerator cores;
a decode circuit to decode the one or more fetched instructions; and
an issue circuit to translate the one or more decoded instructions into the ISA corresponding to the specified accelerator core, collate the one or more translated instructions into an instruction packet, and issue the instruction packet to the specified accelerator core;
wherein the plurality of accelerator cores comprise a memory engine (MENG), a collectives engine (CENG), a queue engine (QENG), and a chain management unit (CMU).

2. The processor of claim 1, wherein each of the plurality of accelerator cores is memory-mapped to an address range, and wherein the one or more instructions are memory-mapped input/output (MMIO) instructions having an address to specify the one accelerator core.

3. The processor of claim 1, further comprising an execution circuit;
wherein the fetch circuit further fetches another instruction not specifying any accelerator core;
wherein the one or more instructions specifying the one accelerator core are non-blocking;
wherein the decode circuit is further to decode the other fetched instruction; and
wherein the execution circuit is to execute the decoded other instruction without awaiting completion of execution of the instruction packet.

4. The processor of claim 1, wherein the ISA corresponding to the MENG includes dual-memory instructions, each of the dual-memory instructions comprising one of Dual_read_read, Dual_read_write, Dual_write_write, Dual_xchg_read, Dual_xchg_write, Dual_cmpxchg_read, Dual_cmpxchg_write, Dual_compare&read_read, and Dual_compare&read_write.

5. The processor of claim 1, wherein the ISA corresponding to the MENG includes a direct memory access (DMA) instruction specifying a source, a destination, an arithmetic operation, and a block size, wherein the MENG copies a block of data according to the block size from the specified source to the specified destination, and wherein the MENG further performs the arithmetic operation on each datum of the data block before copying resulting datum to the specified destination.

6. The processor of claim 1, wherein the ISA corresponding to the CENG includes collective operations, including reductions, all-reductions (reduction-2-all), broadcasts, gathers, scatters, barriers, and parallel prefix operations.

7. The processor of claim 1, wherein the QENG comprises a hardware-managed queue having an arbitrary queue type, and wherein the ISA corresponding to the QENG includes instructions for adding data to the queue and removing data from the queue, and wherein the arbitrary queue type is one of last-in-first-out (LIFO), first-in last-out (FILO) and first-in-first-out (FIFO).

8. The processor of claim 1, wherein a subset of the one or more instructions is part of a chain, and wherein the CMU stalls execution of each chained instruction until completion of a preceding chained instruction, and wherein other instructions of the one or more instructions can execute in parallel.

9. The processor of claim 1, further comprising a switched bus fabric to couple the issue circuit and the plurality of accelerator cores, the switched bus fabric comprising paths having multiple parallel lanes and monitoring a degree of congestion thereon.

10. The processor of claim 9, further comprising ingress and egress network interfaces, and a packet hijack circuit to:
determine whether to hijack each incoming packet at the ingress network interface by comparing an address contained in the instruction packet to a software-programmable hijack target address;
copy an instruction packet determined to be hijacked to a hijack circuit scratchpad memory; and
process a stored packet by a hijack circuit execution unit to conduct line-speed in situ analysis, modification, and rejection of packets.

11. The processor of claim 1, wherein the plurality of accelerator cores are disposed in one or more of a plurality of processor cores, each of the processor cores comprising:
a cache controlled according to a Modified-Owned-Exclusive-Shared-Invalid plus Forward (MOESI+F) cache coherency protocol;
wherein memory reads to a cache line, when the cache line is valid in at least one of the caches, is always serviced by the at least one of the caches, rather than to be serviced by a memory read; and
wherein dirty cache lines are only ever written back to memory when a dirty cache line in a Modified state gets evicted due to a replacement policy.

12. The processor of claim 11, wherein when a cache line in n Owned state is evicted due to a replacement policy, the cache line transitions to the Owned state in a different cache if more than one cache had a copy of the cache line before the eviction, or to the Modified state if only one cache had a copy of the cache line before the eviction.

13. The processor of claim 11, wherein when a cache line in n Forward state is evicted due to a replacement policy, the cache line transitions to the Forward state in a different cache if more than one cache had a copy of the cache line before the eviction, or to the Exclusive state if only one cache had a copy of the cache line before the eviction.

14. The processor of claim 11, further comprising a cache control circuit to monitor coherency data requests among the plurality of cores and to cause evictions and transitions in cache state, the cache control circuit comprising a cache tag array to store cache states of cache lines in each of the caches of the plurality of cores.

15. A system comprising:
a memory;
a plurality of accelerator cores, each having a corresponding instruction set architecture (ISA);
means for fetching one or more instructions specifying one of the accelerator cores;
means for decoding the one or more fetched instructions;
means for translating the one or more decoded instructions into the ISA corresponding to the specified accelerator core;
means for collating the one or more translated instructions into an instruction packet; and
means for issuing the instruction packet to the specified accelerator core;
wherein the plurality of accelerator cores comprise a memory engine (MENG), a collectives engine (CENG), a queue engine (QENG), and a chain management unit (CMU).

16. The system of claim 15:
wherein each of the plurality of accelerator cores is memory-mapped to an address range, and wherein the one or more instructions are memory-mapped input/output (MMIO) instructions having an address to specify the one accelerator core;
wherein the means for fetching further fetches another instruction not specifying any accelerator core;
wherein the one or more instructions specifying the one accelerator core are non-blocking;
wherein the means for decoding is further to decode the other fetched instruction;
wherein the execution circuit is to execute the decoded other instruction without awaiting completion of execution of the instruction packet;
wherein the ISA corresponding to the MENG includes dual-memory instructions, each of the dual-memory instructions comprising one of Dual_read_read, Dual_read_write, Dual_write_write, Dual_xchg_read, Dual_xchg_write, Dual_cmpxchg_read, Dual_cmpxchg_write, Dual_compare&read_read, and Dual_compare&read_write;
wherein the ISA corresponding to the MENG includes a direct memory access (DMA) instruction specifying a source, a destination, an arithmetic operation, and a block size, wherein the MENG copies a block of data according to the block size from the specified source to the specified destination, and wherein the MENG further performs the arithmetic operation on each datum of the data block before copying resulting datum to the specified destination;
wherein the ISA corresponding to the CENG includes collective operations, including reductions, all-reductions (reduction-2-all), broadcasts, gathers, scatters, barriers, and parallel prefix operations;
wherein the QENG comprises a hardware-managed queue having an arbitrary queue type, and wherein the ISA corresponding to the QENG includes instructions for adding data to the queue and removing data from the queue, and wherein the arbitrary queue type is one of last-in-first-out (LIFO), first-in last-out (FILO) and first-in-first-out (FIFO); and
wherein a subset of the one or more instructions is part of a chain, and wherein the CMU stalls execution of each chained instruction until completion of a preceding chained instruction, and wherein other instructions of the one or more instructions can execute in parallel.

17. The system of claim 15, further comprising:
a switched bus fabric to couple the issue circuit and the plurality of accelerator cores, the switched bus fabric comprising paths having multiple parallel lanes and monitoring a degree of congestion thereon;
ingress and egress network interfaces; and
a packet hijack circuit to:
determine whether to hijack each incoming instruction packet at the ingress network interface by comparing an address contained in the instruction packet to a software-programmable hijack target address;
copy an instruction packet determined to be hijacked to a hijack circuit scratchpad memory; and
process a stored packet by a hijack circuit execution unit to conduct line-speed in situ analysis, modification, and rejection of packets.

18. A method of executing instructions using an execution circuit and a plurality of accelerator cores each having a corresponding instruction set architecture (ISA), the method comprising:
fetching, by a fetch circuit, one or more instructions specifying one of the accelerator cores;
decoding, using a decode circuit, the one or more fetched instructions;
translating, using an issue circuit, the one or more decoded instructions into the ISA corresponding to the specified accelerator core;
collating, by the issue circuit the one or more translated instructions into an instruction packet; and
issuing the instruction packet to the specified accelerator core;
wherein the plurality of accelerator cores comprise a memory engine (MENG), a collectives engine (CENG), a queue engine (QENG), and a chain management unit (CMU).

19. The method of claim 18,
wherein each of the plurality of accelerator cores is memory-mapped to an address range, and wherein the one or more instructions are memory-mapped input/output (MMIO) instructions having an address to specify the one accelerator core;
wherein the means for fetching further fetches another instruction not specifying any accelerator core;
wherein the one or more instructions specifying the one accelerator core are non-blocking;
wherein the means for decoding is further to decode the other fetched instruction;
wherein the execution circuit is to execute the decoded other instruction without awaiting completion of execution of the instruction packet;
wherein the ISA corresponding to the MENG includes dual-memory instructions, each of the dual-memory instructions comprising one of Dual_read_read, Dual_read_write, Dual_write_write, Dual_xchg_read, Dual_xchg_write, Dual_cmpxchg_read, Dual_cmpxchg_write, Dual_compare&read_read, and Dual_compare&read_write;
wherein the ISA corresponding to the MENG includes a direct memory access (DMA) instruction specifying a source, a destination, an arithmetic operation, and a block size, wherein the MENG copies a block of data according to the block size from the specified source to the specified destination, and wherein the MENG further performs the arithmetic operation on each datum of the data block before copying resulting datum to the specified destination;
wherein the ISA corresponding to the CENG includes collective operations, including reductions, all-reductions (reduction-2-all), broadcasts, gathers, scatters, barriers, and parallel prefix operations;
wherein the QENG comprises a hardware-managed queue having an arbitrary queue type, and wherein the ISA corresponding to the QENG includes instructions for adding data to the queue and removing data from the queue, and wherein the arbitrary queue type is one of last-in-first-out (LIFO), first-in last-out (FILO) and first-in-first-out (FIFO); and
wherein a subset of the one or more instructions is part of a chain, and wherein the CMU stalls execution of each chained instruction until completion of a preceding chained instruction, and wherein other instructions of the one or more instructions can execute in parallel.

20. The method of claim 18, further comprising using a switched bus fabric to couple the issue circuit and the plurality of accelerator cores, the switched bus fabric comprising paths having multiple parallel lanes and monitoring a degree of congestion thereon.

21. The method of claim 20, further comprising a packet hijack circuit having ingress and egress network interfaces coupled to the switched bus fabric, and, the method further comprising:
monitoring, by the packet hijack circuit, packets flowing into the ingress interface;
determining, by the packet hijack circuit referencing a packet hijack table, to hijack a packet;
storing the hijacked packet to a packet hijack buffer;
processing in-situ, by the packet hijack circuit at line speed, hijacked packets stored in the packet hijack buffer, the processing to generate a resulting data packet;
generating a resulting data packet; and
issuing the resulting data packet back into a flow of traffic passing through the ingress interface.

22. A non-transitory machine-readable medium containing instructions that, when executed by an execution circuit coupled to a plurality of accelerator cores each having a corresponding instruction set architecture (ISA), cause the execution circuit to:
fetch, by a fetch circuit, one or more instructions specifying one of the accelerator cores;
decode, using a decode circuit, the one or more fetched instructions;
translate, using an issue circuit, the one or more decoded instructions into the ISA corresponding to the specified accelerator core;
collate, by the issue circuit, the one or more translated instructions into an instruction packet; and
issue the instruction packet to the specified accelerator core;
wherein the plurality of accelerator cores comprise a memory engine (MENG), a collectives engine (CENG), a queue engine (QENG), and a chain management unit (CMU).

23. The non-transitory machine-readable medium of claim 22,
wherein each of the plurality of accelerator cores is memory-mapped to an address range, and wherein the one or more instructions are memory-mapped input/output (MMIO) instructions having an address to specify the one accelerator core;
wherein the means for fetching further fetches another instruction not specifying any accelerator core;
wherein the one or more instructions specifying the one accelerator core are non-blocking;
wherein the means for decoding is further to decode the other fetched instruction;
wherein the execution circuit is to execute the decoded other instruction without awaiting completion of execution of the instruction packet;
wherein the ISA corresponding to the MENG includes dual-memory instructions, each of the dual-memory instructions comprising one of Dual_read_read, Dual_read_write, Dual_write_write, Dual_xchg_read, Dual_xchg_write, Dual_cmpxchg_read, Dual_cmpxchg_write, Dual_compare&read_read, and Dual_compare&read_write;
wherein the ISA corresponding to the MENG includes a direct memory access (DMA) instruction specifying a source, a destination, an arithmetic operation, and a block size, wherein the MENG copies a block of data according to the block size from the specified source to the specified destination, and wherein the MENG further performs the arithmetic operation on each datum of the data block before copying resulting datum to the specified destination;
wherein the ISA corresponding to the CENG includes collective operations, including reductions, all-reductions (reduction-2-all), broadcasts, gathers, scatters, barriers, and parallel prefix operations;
wherein the QENG comprises a hardware-managed queue having an arbitrary queue type, and wherein the ISA corresponding to the QENG includes instructions for adding data to the queue and removing data from the queue, and wherein the arbitrary queue type is one of last-in-first-out (LIFO), first-in last-out (FILO) and first-in-first-out (FIFO); and
wherein a subset of the one or more instructions is part of a chain, and wherein the CMU stalls execution of each chained instruction until completion of a preceding chained instruction, and wherein other instructions of the one or more instructions can execute in parallel.

24. The non-transitory machine-readable medium of claim 22, wherein the machine-readable code further causes the execution circuit to use a switched bus fabric coupling the issue circuit and the plurality of accelerator cores, the switched bus fabric comprising paths having multiple parallel lanes and monitoring a degree of congestion thereon.

25. The non-transitory machine-readable medium of claim 24, wherein the machine-readable instructions, when executed by a packet hijack circuit having ingress and egress network interfaces coupled to the switched bus fabric, cause the execution circuit to:
monitor, by the packet hijack circuit, packets flowing into the ingress interface;
determine, by the packet hijack circuit referencing a packet hijack table, to hijack a packet;
store the hijacked packet to a packet hijack buffer;
process in-situ, by the packet hijack circuit at line speed, hijacked packets stored in the packet hijack buffer, the processing to generate a resulting data packet;
generate a resulting data packet; and
issue the resulting data packet back into a flow of traffic passing through the ingress interface.
